(19) United States
(12) Patent Application Publication
(10) Pub. No.: US 2025/0351014 A1
(43) Pub. Date: Nov. 13, 2025

(54) RADIO ACCESS NETWORK TECHNIQUES FOR MULTI-MODAL SERVICES

(71) Applicant: QUALCOMM Incorporated, San Diego, CA (US)

(72) Inventors: Mickael MONDET, Louannec (FR); Prasada Veera Reddy KADIRI, San Diego, CA (US); Diana MAAMARI, San Diego, CA (US); Hyun Yong LEE, San Diego, CA (US); Sitaramanjaneyulu KANAMARLAPUDI, San Diego, CA (US); Prashanth Haridas HANDE, San Diego, CA (US); Peerapol TINNAKORNSRISUPHAP, San Diego, CA (US)

(21) Appl. No.: 18/658,104

(22) Filed: May 8, 2024

(51) Int. Cl. H04W 36/00; H04W 76/20

(52) U.S. Cl. CPC H04W 36/0058; H04W 36/0033; H04W 36/00835; H04W 76/20

(57) ABSTRACT

Methods, systems, and devices for wireless communications are described. In some examples, a network entity may send a capability message indicating support for multi-modal services associated with user equipments (UEs). The network entity may receive a message indicating a configuration for a multi-modal service of the multi-modal services and communicate in accordance with the multi-modal services. In another example, a network entity may transmit an indication of a cell set to a set of UEs for handover procedures. A UE may initiate a handover to a target cell and the network entity may transmit a handover command to the set of UEs. In another example, a network entity may transmit an indication of cell set to a set of UEs for cell switching. A UE may transmit a report of a target cell and the network entity may transmit a cell switch command and a cell switch notification.

### FIELD OF TECHNOLOGY

The following relates to wireless communications, including radio access network (RAN) techniques for multi-modal services.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems, which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first network entity is described. The method may include sending, via a first interface between the first network entity and a second network entity, a first message indicating a capability of the first network entity to support one or more multi-modal services associated with two or more data traffic flows, the one or more multi-modal services being associated with one or more user equipments (UEs), where the one or more multi-modal services support applications enabling input from a set of multiple sources, receiving, via the first interface, a second message indicating a configuration of at least one multi-modal service of the one or more multi-modal services that is associated with at least one data traffic flow of the one or more data traffic flows, the configuration of the at least one multi-modal service including a multi-modal service identifier associated with the at least one multi-modal service, and communicating, with the one or more UEs, in accordance with the one or more multi-modal services.

A first network entity for wireless communications is described. The first network entity may include one or more memories storing processor executable code, and one or more processors coupled with the one or more memories. The one or more processors may individually or collectively be operable to execute the code to cause the first network entity to send, via a first interface between the first network entity and a second network entity, a first message indicating a capability of the first network entity to support one or more multi-modal services associated with two or more data traffic flows, the one or more multi-modal services being associated with one or more UEs, where the one or more multi-modal services support applications enabling input from a set of multiple sources, receive, via the first interface, a second message indicating a configuration of at least one multi-modal service of the one or more multi-modal services that is associated with at least one data traffic flow of the one or more data traffic flows, the configuration of the at least one multi-modal service including a multi-modal service identifier associated with the at least one multi-modal service, and communicate, with the one or more UEs, in accordance with the one or more multi-modal services.

Another first network entity for wireless communications is described. The first network entity may include means for sending, via a first interface between the first network entity and a second network entity, a first message indicating a capability of the first network entity to support one or more multi-modal services associated with two or more data traffic flows, the one or more multi-modal services being associated with one or more UEs, where the one or more multi-modal services support applications enabling input from a set of multiple sources, means for receiving, via the first interface, a second message indicating a configuration of at least one multi-modal service of the one or more multi-modal services that is associated with at least one data traffic flow of the one or more data traffic flows, the configuration of the at least one multi-modal service including a multi-modal service identifier associated with the at least one multi-modal service, and means for communicating, with the one or more UEs, in accordance with the one or more multi-modal services.

A non-transitory computer-readable medium storing code for wireless communications is described. The code may include instructions executable by one or more processors to send, via a first interface between the first network entity and a second network entity, a first message indicating a capability of the first network entity to support one or more multi-modal services associated with two or more data traffic flows, the one or more multi-modal services being associated with one or more UEs, where the one or more multi-modal services support applications enabling input from a set of multiple sources, receive, via the first interface, a second message indicating a configuration of at least one multi-modal service of the one or more multi-modal services that is associated with at least one data traffic flow of the one or more data traffic flows, the configuration of the at least one multi-modal service including a multi-modal service identifier associated with the at least one multi-modal service, and communicate, with the one or more UEs, in accordance with the one or more multi-modal services.

In some examples of the method, first network entities, and non-transitory computer-readable medium described herein, sending the first message may include operations, features, means, or instructions for sending a setup request message via the first interface between the first network entity and the second network entity, the setup request message including an indication of the capability of the first network entity to support the one or more multi-modal services, where the setup request message includes the first message.

In some examples of the method, first network entities, and non-transitory computer-readable medium described herein, sending the first message may include operations, features, means, or instructions for outputting a configuration update message via the first interface between the first network entity and the second network entity, the configuration update message including an indication of the capability of the first network entity to support the one or more multi-modal services, where the configuration update message includes the first message.

In some examples of the method, first network entities, and non-transitory computer-readable medium described herein, sending the first message may include operations, features, means, or instructions for sending, via the first interface between the first network entity and the second network entity, a path switch request message that includes an indication of the capability of the first network entity to support the one or more multi-modal services, where the path switch request message includes the first message.

Some examples of the method, first network entities, and non-transitory computer-readable medium described herein may further include operations, features, means, or instructions for receiving, from the second network entity via the first interface, a first session resource request message, where sending the first message includes and sending, to the second network entity via the first interface, a first session resource response message in response to the first session resource request message, the first session resource response message including an indication of the capability of the first network entity to support the one or more multi-modal services, where the first session resource response message includes the first message.

In some examples of the method, first network entities, and non-transitory computer-readable medium described herein, the first session resource request message may be a session resource setup request message or a session resource modification request message, and the first session resource response message may be a session resource setup response message or a session resource modification response message.

Some examples of the method, first network entities, and non-transitory computer-readable medium described herein may further include operations, features, means, or instructions for receiving, from the second network entity via the first interface, a first UE context request message, where sending the first message includes and sending, to the second network entity via the first interface, a first UE context response message in response to the first UE context request message, the first UE context response message including an indication of the capability of the first network entity to support the one or more multi-modal services, where the first UE context response message includes the first message.

In some examples of the method, first network entities, and non-transitory computer-readable medium described herein, the first UE context request message may be a UE context setup request message or a UE context modification request message, and the first UE context response message may be a UE context setup response message or a UE context modification response message.

Some examples of the method, first network entities, and non-transitory computer-readable medium described herein may further include operations, features, means, or instructions for receiving, from the second network entity via the first interface, a first bearer context request message, where sending the first message includes and sending, to the second network entity via the first interface, a first bearer context response message in response to the first bearer context request message, the first bearer context response message including an indication of the capability of the first network entity to support the one or more multi-modal services, where the first bearer context response message includes the first message.

In some examples of the method, first network entities, and non-transitory computer-readable medium described herein, the first bearer context request message may be a bearer context setup request message or a bearer context modification request message, and the first bearer context response message may be a bearer context setup response message or a bearer context modification response message.

In some examples of the method, first network entities, and non-transitory computer-readable medium described herein, sending the first message may include operations, features, means, or instructions for sending, via the first message, a first indication of a maximum quantity of intra-UE multi-modal services that the first network entity may be capable of supporting, a second indication of a maximum quantity of inter-UE multi-modal services that the first network entity may be capable of supporting, a third indication of a maximum quantity of data traffic flows that the first network entity may be capable of supporting for a respective multi-modal service, a fourth indication of a maximum quantity of data traffic flows that the first network entity may be capable of supporting for the one or more multi-modal services, or a combination thereof.

In some examples of the method, first network entities, and non-transitory computer-readable medium described herein, receiving the second message may include operations, features, means, or instructions for receiving, via the first interface, two or more data traffic flow configuration messages indicating information associated with a respective data traffic flow of the two or more data traffic flows, the configuration of the at least one multi-modal service being associated with the two or more data traffic flow configuration messages, where the two or more data traffic flow configuration messages and the configuration of the at least one multi-modal service may be outputted separately.

In some examples of the method, first network entities, and non-transitory computer-readable medium described herein, receiving the second message may include operations, features, means, or instructions for receiving, via the first interface, two or more traffic flow configuration messages indicating information associated with a respective traffic flow of the two or more data traffic flows, the two or more traffic flow configuration messages including the configuration of the at least one multi-modal service, where the two or more traffic flow configuration messages may be associated with the multi-modal service identifier that may be associated with the at least one multi-modal service.

In some examples of the method, first network entities, and non-transitory computer-readable medium described herein, the second message includes a packet data unit (PDU) session resource setup request message, a PDU session resource modify request message, a handover request message, a path switch request acknowledgment message, a retrieve UE context response message, a secondary node additional request message a secondary node modification request message, a secondary node modification required message, a bearer context setup request message, a bearer context modification request message, or any combination thereof.

Some examples of the method, first network entities, and non-transitory computer-readable medium described herein may further include operations, features, means, or instructions for sending a third message including an indication that one or more parameters associated with the configuration of the at least one multi-modal service may be not applied for the one or more multi-modal services, where the indication may be based on the one or more parameters being incompatible with the capability of the first network entity.

In some examples of the method, first network entities, and non-transitory computer-readable medium described herein, the indication that one or more parameters associated with the configuration may be not applied includes a criticality diagnostics information element.

A method for wireless communications by a source network entity is described. The method may include sending, to a group of UEs that are associated with one or more data traffic flows of a multi-modal service, an indication of a set of candidate cells for handover evaluation, receiving, from a first UE of the group of UEs, a message indicating that the first UE has initiated a handover from the source network entity to a target network entity associated with a target candidate cell, where the set of candidate cells includes the target candidate cell, and sending, to the group of UEs, a handover command message corresponding to the indication of the message from the first UE, the handover command message indicating for one or more UEs of the group of UEs to initiate a handover from the source network entity to the target network entity associated with the target candidate cell.

A source network entity for wireless communications is described. The source network entity may include one or more memories storing processor executable code, and one or more processors coupled with the one or more memories. The one or more processors may individually or collectively be operable to execute the code to cause the source network entity to send, to a group of UEs that are associated with one or more data traffic flows of a multi-modal service, an indication of a set of candidate cells for handover evaluation, receive, from a first UE of the group of UEs, a message indicating that the first UE has initiated a handover from the source network entity to a target network entity associated with a target candidate cell, where the set of candidate cells includes the target candidate cell, and send, to the group of UEs, a handover command message corresponding to the indication of the message from the first UE, the handover command message indicating for one or more UEs of the group of UEs to initiate a handover from the source network entity to the target network entity associated with the target candidate cell.

Another source network entity for wireless communications is described. The source network entity may include means for sending, to a group of UEs that are associated with one or more data traffic flows of a multi-modal service, an indication of a set of candidate cells for handover evaluation, means for receiving, from a first UE of the group of UEs, a message indicating that the first UE has initiated a handover from the source network entity to a target network entity associated with a target candidate cell, where the set of candidate cells includes the target candidate cell, and means for sending, to the group of UEs, a handover command message corresponding to the indication of the message from the first UE, the handover command message indicating for one or more UEs of the group of UEs to initiate a handover from the source network entity to the target network entity associated with the target candidate cell.

A non-transitory computer-readable medium storing code for wireless communications is described. The code may include instructions executable by one or more processors to send, to a group of UEs that are associated with one or more data traffic flows of a multi-modal service, an indication of a set of candidate cells for handover evaluation, receive, from a first UE of the group of UEs, a message indicating that the first UE has initiated a handover from the source network entity to a target network entity associated with a target candidate cell, where the set of candidate cells includes the target candidate cell, and send, to the group of UEs, a handover command message corresponding to the indication of the message from the first UE, the handover command message indicating for one or more UEs of the group of UEs to initiate a handover from the source network entity to the target network entity associated with the target candidate cell.

Some examples of the method, source network entities, and non-transitory computer-readable medium described herein may further include operations, features, means, or instructions for receiving, from the first UE of the group of UEs, a measurement report associated with the target candidate cell, where the message indicating that the first UE may have initiated the handover from the source network entity to the target network entity associated with the target candidate cell may be based on the measurement report.

Some examples of the method, source network entities, and non-transitory computer-readable medium described herein may further include operations, features, means, or instructions for sending, to the target network entity associated with the target candidate cell, one or more early status transfer messages associated with the group of UEs, where the one or more early status transfer messages may be outputted prior to receiving the message indicating that the first UE may have initiated the handover.

In some examples of the method, source network entities, and non-transitory computer-readable medium described herein, at least one of the one or more early status transfer messages may be a common early status transfer message that may be common to at least two or more UEs of the group of UEs.

Some examples of the method, source network entities, and non-transitory computer-readable medium described herein may further include operations, features, means, or instructions for receiving, from the target network entity associated with the target candidate cell, one or more handover success messages indicating that the one or more UEs of the group of UEs may have successfully performed the handover from the source network entity to the target network entity associated with the target candidate cell, where the one or more handover success messages may be associated with the one or more UEs indicated to handover to the target network entity via the handover command message.

In some examples of the method, source network entities, and non-transitory computer-readable medium described herein, at least one of the one or more handover success messages may be a common handover success transfer message that may be common to at least two or more UEs of the group of UEs.

In some examples of the method, source network entities, and non-transitory computer-readable medium described herein, the message indicating that the first UE may have initiated the handover from the source network entity to the target network entity, the handover command message, or both include a cell identifier associated with the target candidate cell.

A method for wireless communications by a source network entity is described. The method may include sending, to a group of UEs that are associated with two or more data traffic flows of a multi-modal service, an indication of a set of candidate cells for cell switching, receiving, from a first UE of the group of UEs, a measurement report of a target candidate cell from the set of candidate cells, sending, to one or more UEs of the group of UEs, a cell switch command indicating that the one or more UEs switch from a source cell associated with the source network entity to the target candidate cell associated with a target network entity, the cell switch command being based on the measurement report of the target candidate cell, and sending, to the target network entity, a cell switch notification message, the cell switch notification message including one or more UE identifiers associated with the group of UEs that received the cell switch command, where the cell switch notification message is outputted based on obtaining the measurement report of the target candidate cell.

A source network entity for wireless communications is described. The source network entity may include one or more memories storing processor executable code, and one or more processors coupled with the one or more memories. The one or more processors may individually or collectively be operable to execute the code to cause the source network entity to send, to a group of UEs that are associated with two or more data traffic flows of a multi-modal service, an indication of a set of candidate cells for cell switching, receive, from a first UE of the group of UEs, a measurement report of a target candidate cell from the set of candidate cells, send, to one or more UEs of the group of UEs, a cell switch command indicating that the one or more UEs switch from a source cell associated with the source network entity to the target candidate cell associated with a target network entity, the cell switch command being based on the measurement report of the target candidate cell, and send, to the target network entity, a cell switch notification message, the cell switch notification message including one or more UE identifiers associated with the group of UEs that received the cell switch command, where the cell switch notification message is outputted based on obtaining the measurement report of the target candidate cell.

Another source network entity for wireless communications is described. The source network entity may include means for sending, to a group of UEs that are associated with two or more data traffic flows of a multi-modal service, an indication of a set of candidate cells for cell switching, means for receiving, from a first UE of the group of UEs, a measurement report of a target candidate cell from the set of candidate cells, means for sending, to one or more UEs of the group of UEs, a cell switch command indicating that the one or more UEs switch from a source cell associated with the source network entity to the target candidate cell associated with a target network entity, the cell switch command being based on the measurement report of the target candidate cell, and means for sending, to the target network entity, a cell switch notification message, the cell switch notification message including one or more UE identifiers associated with the group of UEs that received the cell switch command, where the cell switch notification message is outputted based on obtaining the measurement report of the target candidate cell.

A non-transitory computer-readable medium storing code for wireless communications is described. The code may include instructions executable by one or more processors to send, to a group of UEs that are associated with two or more data traffic flows of a multi-modal service, an indication of a set of candidate cells for cell switching, receive, from a first UE of the group of UEs, a measurement report of a target candidate cell from the set of candidate cells, send, to one or more UEs of the group of UEs, a cell switch command indicating that the one or more UEs switch from a source cell associated with the source network entity to the target candidate cell associated with a target network entity, the cell switch command being based on the measurement report of the target candidate cell, and send, to the target network entity, a cell switch notification message, the cell switch notification message including one or more UE identifiers associated with the group of UEs that received the cell switch command, where the cell switch notification message is outputted based on obtaining the measurement report of the target candidate cell.

Some examples of the method, source network entities, and non-transitory computer-readable medium described herein may further include operations, features, means, or instructions for receiving one or more UE context modification request messages that may be associated with the group of UEs, where the indication of the set of candidate cells for the cell switching may be sent to the group of UEs based on receiving the one or more UE context modification request messages.

In some examples of the method, source network entities, and non-transitory computer-readable medium described herein, receiving the one or more UE context modification request messages may include operations, features, means, or instructions for receiving a common UE context modification request message that may be associated with at least two or more UEs of the group of UEs, where the indication of the set of candidate cells for the cell switching may be sent to the group of UEs based on receiving the common UE context modification request message.

In some examples of the method, source network entities, and non-transitory computer-readable medium described herein, sending the cell switch notification message may include operations, features, means, or instructions for sending, to the target network entity, a common cell switch notification message that may be associated with two or more UEs of the group of UEs.

In some examples of the method, source network entities, and non-transitory computer-readable medium described herein, sending the cell switch notification message may include operations, features, means, or instructions for sending, to the target network entity, one or more cell switch notification messages that each include a first parameter that indicates the one or more UE identifiers associated with the one or more UEs of the group of UEs that received the cell switch command based on the one or more UEs being associated with the multi-modal service.

Some examples of the method, source network entities, and non-transitory computer-readable medium described herein may further include operations, features, means, or instructions for receiving one or more messages that indicates information associated with the set of candidate cells, where the indication of the set of candidate cells for the cell switching may be sent to the group of UEs based on receiving the information associated with the set of candidate cells.

In some examples of the method, source network entities, and non-transitory computer-readable medium described herein, a completion of a cell switch for the group of UEs from the source cell to the target candidate cell may be based on one or more access success messages.

In some examples of the method, source network entities, and non-transitory computer-readable medium described herein, at least one of the one or more access success messages includes a common access success message that may be common to at least two or more UEs of the group of UEs.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports radio access network (RAN) techniques for multi-modal services in accordance with one or more aspects of the present disclosure.

FIG. 2 shows an example of a network architecture that supports RAN techniques for multi-modal services in accordance with one or more aspects of the present disclosure.

FIG. 3 shows an example of a wireless communications system that supports RAN techniques for multi-modal services in accordance with one or more aspects of the present disclosure.

FIGS. 4 through 6 show examples of process flows that support RAN techniques for multi-modal services in accordance with one or more aspects of the present disclosure.

FIGS. 7 and 8 show examples of a configuration diagram that supports RAN techniques for multi-modal services in accordance with one or more aspects of the present disclosure.

FIGS. 9A, 9B, 10A, and 10B show examples of process flows that support RAN techniques for multi-modal services in accordance with one or more aspects of the present disclosure.

FIGS. 11 and 12 show block diagrams of devices that support RAN techniques for multi-modal services in accordance with one or more aspects of the present disclosure.

FIG. 13 shows a block diagram of a communications manager that supports RAN techniques for multi-modal services in accordance with one or more aspects of the present disclosure.

FIG. 14 shows a diagram of a system including a device that supports RAN techniques for multi-modal services in accordance with one or more aspects of the present disclosure.

FIGS. 15 and 16 show block diagrams of devices that support RAN techniques for multi-modal services in accordance with one or more aspects of the present disclosure.

FIG. 17 shows a block diagram of a communications manager that supports RAN techniques for multi-modal services in accordance with one or more aspects of the present disclosure.

FIG. 18 shows a diagram of a system including a device that supports RAN techniques for multi-modal services in accordance with one or more aspects of the present disclosure.

FIGS. 19 through 21 show flowcharts illustrating methods that support RAN techniques for multi-modal services in accordance with one or more aspects of the present disclosure.

### DETAILED DESCRIPTION

In some wireless communication systems, one or more user equipments (UEs) may be associated with a multi-modal service. A multi-modal service (e.g., a multi-modal communication service) may refer to a service that supports applications enabling input from more than one source, enabling output to more than one destination, or both to convey information more effectively. For example, a multi-modal service may provide a relatively more immersive experience for extended reality (XR) applications (such as virtual reality (VR) applications, augmented reality (AR) applications, mixed reality (MR) applications, or the like) using a combination of audio data, visual data, tactile data, or any combination thereof, that is communicated between one or more UEs and a network. As one example, multiple UEs may be associated with a multi-modal service, where a first UE is associated with visual data and a second UE is associated with tactile data, and so forth. In other examples, a single UE may be associated with multiple types of data, such as audio data and visual data, or the like. In any case, the one or more UEs (e.g., VR glasses, gloves for VR, among other examples) may communicate the data associated with one or more service flows (e.g., audio flows, video flows, tactile flows) to the network in a synchronized manner (e.g., within some threshold timing parameters).

To ensure that the data associated with the one or more service flows is communicated within a wireless communications system effectively, the techniques of the present disclosure enable one or more signaling procedures to enhance the multi-modal service communications. For example, to support enhanced synchronization between multi-modal wireless devices, network entities may transmit indications of supporting one or more multi-modal services via one or more interfaces (e.g., NG interfaces, E1 interfaces, Xn interfaces, F1 interfaces, or any combination thereof). The network entities may receive a configuration of a supported multi-modal service via an interface and communicate with one or more UEs in accordance with the configuration of the multi-modal services. In some examples, the multi-modal service configurations may be indicated within information elements (IEs) used to indicate the configuration of the one or more service flows associated with a multi-modal service. In some other examples, the multi-modal service configurations may be indicated within additional IEs that are linked to the one or more service flow configurations.

In some cases, multiple UEs communicating with a network entity in accordance with a multi-modal service may move within a wireless communications system. However, if one of the multiple UEs are located within different cells supported by network entities, there may be an increase in latency associated with multi-modal communications, which may result in decreased synchronization, efficiency, and reliability for supporting multi-modal communications (e.g., that may otherwise require relatively decreased latencies). Thus, to decrease the latency associated with UEs being supported by different network entities (e.g., for mobility purposes), the techniques of the present disclosure may enable a group of UEs associated with a multi-modal service to receive an indication to handover to a common network entity or to switch to a common cell to ensure that the group of UEs are within the same cell and/or are supported by the same network entity. In some examples, a source network entity may configure each UE within a group of UEs with a common set of candidate cells. In some cases, when a UE initiates a handover (e.g., a conditional handover) to a target cell, the network entity may transmit a handover command to each UE of the group of UEs to initiate a handover to the same target cell.

Additionally, or alternatively, for triggered mobility scenarios (e.g., layer 1 (L1)/layer 2 (L2) triggered mobility), a distributed unit (DU) of a source network entity may receive a measurement report from a UE of a target cell. Based on receiving the measurement report, the source network entity may transmit one or more cell switch commands to the group of UEs such that the group of UEs may switch from a source cell to a target cell together. The source network entity may further transmit a cell switch command to a target network entity associated with the target cell such that data may be forwarded to the target network entity for downlink data transmissions to the group of UEs. Therefore, the techniques of the present disclosure may enable the configuration of network entities with multi-modal service configurations based on multi-modal service capabilities to ensure synchronous data transmissions and may further enable network entities ensuring common support for a group of UEs to decrease the latency of communications within a wireless communications system.

Aspects of the disclosure are initially described in the context of wireless communications systems. Additional aspects of the disclosure are described with reference to wireless communications systems, a configuration diagrams, and process flows. Aspects of the disclosure are further illustrated by and described with reference to apparatus diagrams, system diagrams, and flowcharts that relate to RAN techniques for multi-modal services.

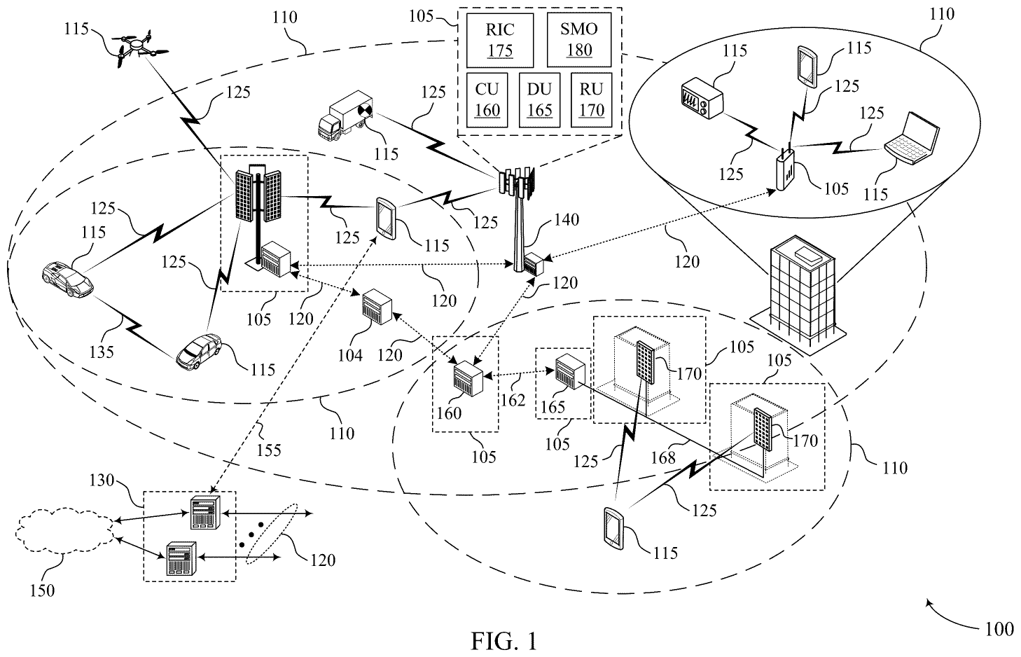

FIG. 1 shows an example of a wireless communications system 100 that supports RAN techniques for multi-modal services in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit, which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one CP entity that manages access and mobility (e.g., a mobility management entity (MME), an access and mobility management function (AMF)) and at least one UP entity that routes packets or interconnects to external networks (e.g., a serving gateway (S-GW), a Packet Data Network (PDN) gateway (P-GW), or a UP function (UPF)). The CP entity may manage non-access stratum (NAS) functions such as mobility, authentication, and bearer management for the UEs 115 served by the network entities 105 (e.g., base stations 140) associated with the core network 130. User IP packets may be transferred through the UP entity, which may provide IP address allocation as well as other functions. The UP entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

To ensure that the data associated with the one or more service flows is communicated effectively within the wireless communications system 100, the techniques of the present disclosure may describe one or more signaling procedures to enhance multi-modal service communications. For example, to enable synchronization between wireless devices, network entities 105 may transmit indications of supporting one or more multi-modal services via one or more interfaces (e.g., NG interfaces, E1 interfaces, Xn interfaces, F1 interfaces, or any combination thereof). The network entities 105 may receive a configuration of a supported multi-modal service via an interface and communicate with one or more UEs 115 in accordance with the configuration of the multi-modal services. In some examples, the multi-modal service configurations may be indicated within IEs used to indicate the configuration of the one or more service flows associated with a multi-modal service. In some other examples, the multi-modal service configurations may be indicated within additional IEs that are linked to the one or more service flow configurations.

UEs 115 communicating with a network entity 105 in accordance with a multi-modal service may move within the wireless communications system 100. However, if one or more UEs 115 (e.g., at least one UE 115 of a group of UEs 115 that are associated with multi-modal communications) are within different cells and/or supported by different network entities 105, there may be an increase in latency associated with communications, which may result in decreased synchronization, efficiency, and reliability of the wireless communications system 100 to support multi-modal communications, which may expect relatively low latencies. To decrease the latency associated with a group of UEs 115 associated with a multi-modal service and that is supported by different network entities 105 and/or cells (e.g., due to mobility of at least one UE 115 of the group of UEs 115), the techniques of the present disclosure may describe a group of UEs 115 being indicated to handover to a common network entity 105 and/or to switch to a common cell to ensure that the group of UEs 115 are within the same cell and/or are supported by the same network entity 105. In some examples, a source network entity 105 may configure each UE 115 within a group of UEs 115 with a common set of candidate cells. In some cases, when a UE 115 initiates a conditional handover procedure for handover to a target network entity 105, the network entity 105 may transmit a handover command to each UE 115 of the group of UEs 115 to initiate a handover to the same target network entity 105.

For triggered mobility scenarios (e.g., L1/L2 triggered mobility (LTM)), a DU of a source network entity 105 may receive a measurement report from a UE 115 of a target cell. Based on receiving the measurement report, the source network entity 105 may transmit one or more cell switch commands to the group of UEs 115 such that the group of UEs 115 may switch from a source cell to a target cell together. The source network entity 105 may further transmit a cell switch command to a target network entity 105 associated with the target cell such that data may be forwarded to the target network entity 105 for downlink data transmissions to the group of UEs 115. Therefore, the techniques of the present disclosure may enable network entities 105 to be configured with multi-modal service configurations based on multi-modal service capabilities to ensure synchronous data transmissions and may further enable network entities 105 ensuring common support for a group of UEs 115 to decrease the latency of communications within the wireless communications system 100.

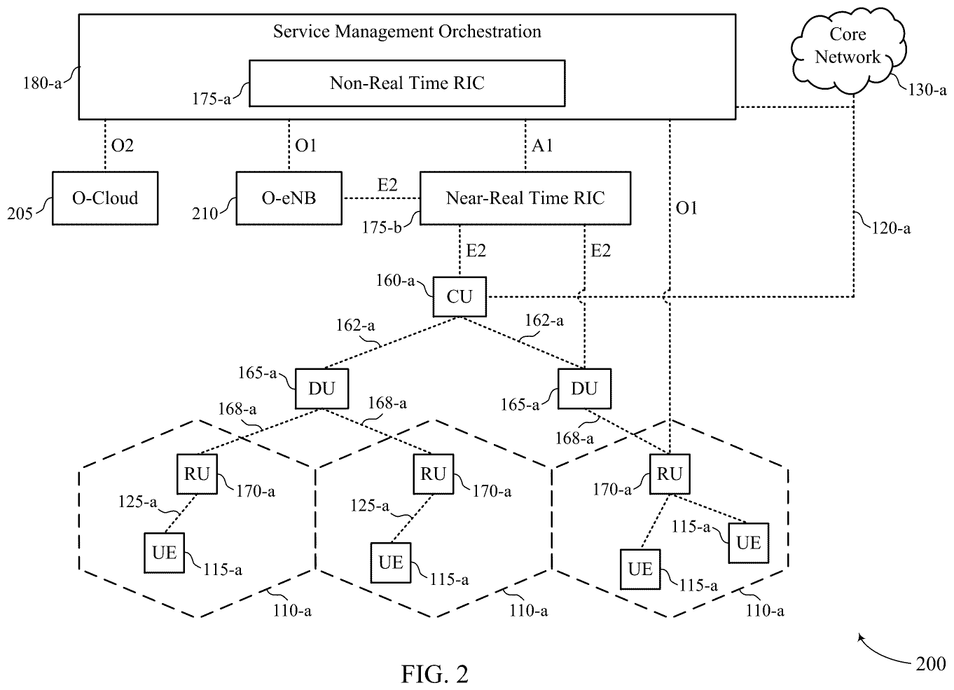

FIG. 2 shows an example of a network architecture 200 (e.g., a disaggregated base station architecture, a disaggregated RAN architecture) that supports RAN techniques for multi-modal services in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with one or more UEs 115-a via one or more communication links 125-a. In some implementations, a respective UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle UP functionality (e.g., CU-UP), CP functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and UP communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements that may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

To ensure that the data associated with the one or more service flows is communicated within the network architecture 200 effectively, the techniques of the present disclosure may describe one or more signaling procedures to enhance the multi-modal service communications. For example, in order to enable synchronization between wireless devices, network entities 105 may transmit indications of supporting one or more multi-modal services via one or more interfaces (e.g., NG interfaces, E1 interfaces, Xn interfaces, F1 interfaces, or any combination thereof). In some examples, in accordance with the techniques of the present disclosure, the indication of a network entity 105 supporting a multi-modal service may be transmitted from an NG-RAN node to an AMF, from a DU 165 of a network entity 105 to a CU 160 of a network entity 105, from a UP CU 160 of a network entity 105 to a CP CU 160 of a network entity 105, or any combination thereof.

Further, the network entities 105 may receive a configuration of a supported multi-modal service via an interface and communicate with one or more UEs 115-a in accordance with the configuration of the multi-modal services. In some examples, the multi-modal service configurations may be indicated within IEs used to indicate the configuration of the one or more service flows associated with a multi-modal service. In some other examples, the multi-modal service configurations may be indicated within additional IEs that are linked to the one or more service flow configurations. Such indications of a multi-modal configuration may be transmitted to a CP CU 160, a UP CU 160, a DU 165, or any combination thereof via an NG-AP protocol, an Xn-AP protocol, an E1-AP protocol, a F1-AP protocol, or any combination thereof.

Moreover, in some cases, UEs 115-a communicating with a network entity 105 in accordance with a multi-modal service may move within a wireless communications system. However, if one or more UEs 115-a are within different cells supported by network entities 105, there may be an increase in latency associated with communications, which can result in a decrease in synchronization, efficiency, and reliability of the wireless communications system to support multi-modal communications, which may expect relatively low latencies. To decrease the latency associated with UEs being supported by different network entities, the techniques of the present disclosure may describe a group of UEs being indicated to handover to a common network entity or to switch to a common cell to ensure that a group of UEs associated with a multi-modal service are within the same cell and are supported by the same network entity. In some examples, a source network entity may configure each UE within a group of UEs with a common set of candidate cells. In some cases, when a UE initiates a conditional handover to a target cell, the network entity may transmit a handover command to each UE of the group of UEs to initiate a handover to the same target cell. In some examples, in accordance with the techniques of the present disclosure, communications for conditional handovers may be between a source network entity 105, a target network entity 105, and the core network 130 (e.g., the core network 130-a).

In some examples, such as for triggered mobility scenarios (e.g., LTM), a DU 165 of a source network entity 105 may receive a measurement report from a UE 115-a of a target cell (e.g., a coverage area 110). Based on receiving the measurement report, the source network entity 105 may transmit one or more cell switch commands to the group of UEs 115-a such that the group of UEs 115-a may switch from a source cell to a target cell together. The source network entity 105 may further transmit a cell switch command to a target network entity 105 associated with the target cell such that data may be forwarded to the target network entity 105 for downlink data transmissions to the group of UEs 115-a. Such communications for the LTM cell switching may include communications between a DU 165 of a source network entity 105 and a CU 160 of a target network entity 105, between the CU 160 of the target network entity and a DU 165 of the target network entity 105, between the source network entity 105, the target network entity 105, and the core network 130, or any combination thereof. Therefore, the techniques of the present disclosure may enable that network entities 105 being configured with multi-modal service configurations based on multi-modal service capabilities to ensure synchronous data transmissions and may enable network entities 105 ensuring common support for a group of UEs 115-a to decrease the latency of communications within a wireless communications system.

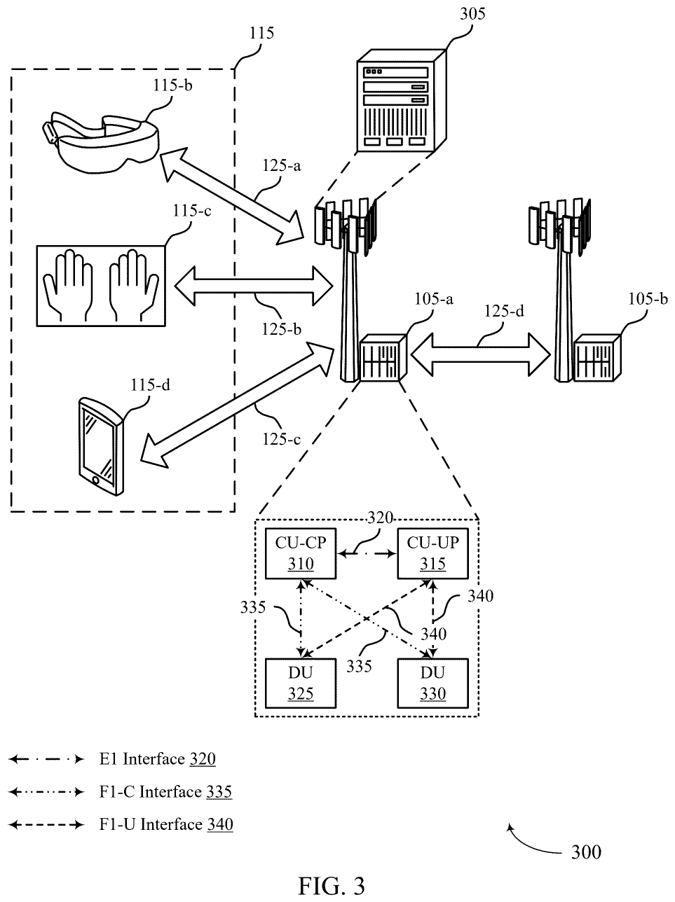

FIG. 3 shows an example of a wireless communications system 300 that supports RAN techniques for multi-modal services in accordance with one or more aspects of the present disclosure. In some examples, the wireless communications system 300 may implement or be implemented by the wireless communications system 100. For example, the wireless communications system 300 may include a network entity 105-a associated with an application server 305, a network entity 105-b, and a group of UEs 115 that includes a UE 115-b, a UE 115-c, and a UE 115-d, which may be examples of devices described herein with reference to FIG. 1. In some examples, the group of UEs 115 may communicate with the network entity 105-a via a communication link 125-a, a communication link 125-b, and a communication link 125-c and the network entity 105-a may communicate with the network entity 105-b via a communication link 125-d, which may be examples of a communication link 125 described herein with reference to FIG. 1. For example, the communication links 125 may be examples of a Uu link, a sidelink, a backhaul link, a D2D link or some other type of communication link 125 described herein with reference to FIG. 1.

In some examples, the wireless communications system 300 may provide high-speed, low-latency, and high-reliability wireless connectivity to UEs 115 to enable latency-sensitive services (e.g., XR devices, multimedia communications, cloud computing). For example, the group of UEs 115 may include the UE 115-b, which may be an example of an set of augmented reality (AR) glasses, VR glasses, or a VR head-mounted display (HMD), the UE 115-c, which may be an example of gloves used of XR and VR applications, and the UE 115-d, which may be used for cloud computing, cloud gaming, cloud AI services, or any combination thereof, where each UE 115 may expect relatively low latency and relatively high speed and high reliability communications. Such applications may be expected to meet relatively stringent system requirements that include data rate, latency, and power consumption. For example, to support the low-latency and high-reliability of XR applications, approximately 99% of XR data traffic packets should be delivered (e.g., sent from a network entity 105 to a UE 115) within a packet delay budget (PDB) expectation (e.g., ˜10 ms). However, as mobile wireless devices (e.g., UEs 115) are expected to operate within cellular networks, mobility procedures may result in relatively significant increases to the packet delay of real-time multimedia traffic.

In some examples, multimedia traffic may be transmitted in accordance with a multi-modal service. For example, the UE 115-b may receive visual data from the application server 305 of the network entity 105-a via the one or more communication links 125-a in accordance with a first service data flow associated with visual data and the UE 115-c may receive tactile data from the application server 305 via the communication link 125-b in accordance with a second service data flow associated with tactile data. In some cases, tactile and multi-modal communication services may enable multi-modal interactions to combine ultra-low latency with extremely high availability, reliability, and security. Further, the UE 115-b and the UE 115-c may be used to support immersive multi-modal VR applications. In some cases, to support a relatively good immersive experience for a user, UEs 115 may expect to receive data from various multi-modal service data flows in accordance with respective synchronization thresholds. For example, for an audio-tactile service flow, the network entity 105-a may configure a UE 115 with a synchronization threshold for audio delay (e.g., 50 ms) and for tactile delay (e.g., 25 ms). Moreover, for a visual-tactile service flow, the network entity 105-a may configure a UEs 115 with synchronization threshold for visual delay (e.g., 15 ms) and for tactile delay (e.g., 50 ms). The delay for each respective media component may refer to a comparison of delay between media devices (e.g., the delay refers to the case where a first media component is delayed compared to the delay of a second media component).

In some cases, the wireless communications system 300 may support multi-modal service applications for both single UE 115 and multiple UEs 115. For single UE 115 multi-modal applications, all the application data for a single UE 115 (e.g., each service data flow associated with the UE 115) may be transmitted in a single packet data unit (PDU) session. Moreover, the application data may include a multi-modal service identifier (ID) to link different data service flows to the same multi-modal service. Policy control function (PCF) may also utilize the multi-modal service ID to derive the policy and charging control (PCC) rules. For multiple UEs 115, a same data network name (DNN) or single network slice selection assistance information (S-NSSAI) combination may be used for the multi-modal services. In some cases, a same multi-modal service ID may be allocated to all the PDU sessions of a respective UE used by a multi-modal service. The PCF may use the multi-modal service ID to derive the PCC rules. Thus, the wireless communications system 300 may provide a relatively strong traction for awareness of the multi-modality of the group of UEs 115 at a RAN.

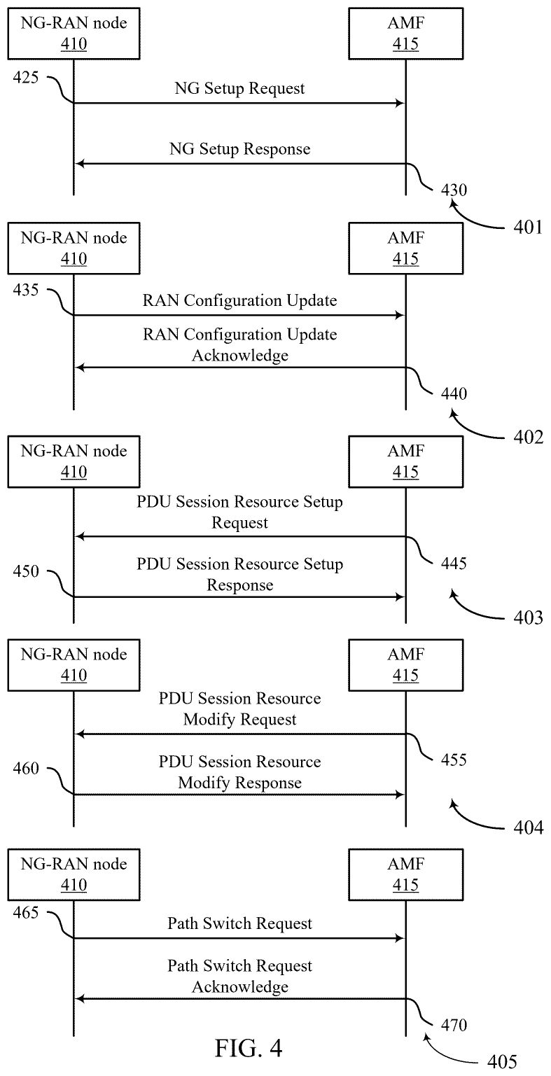

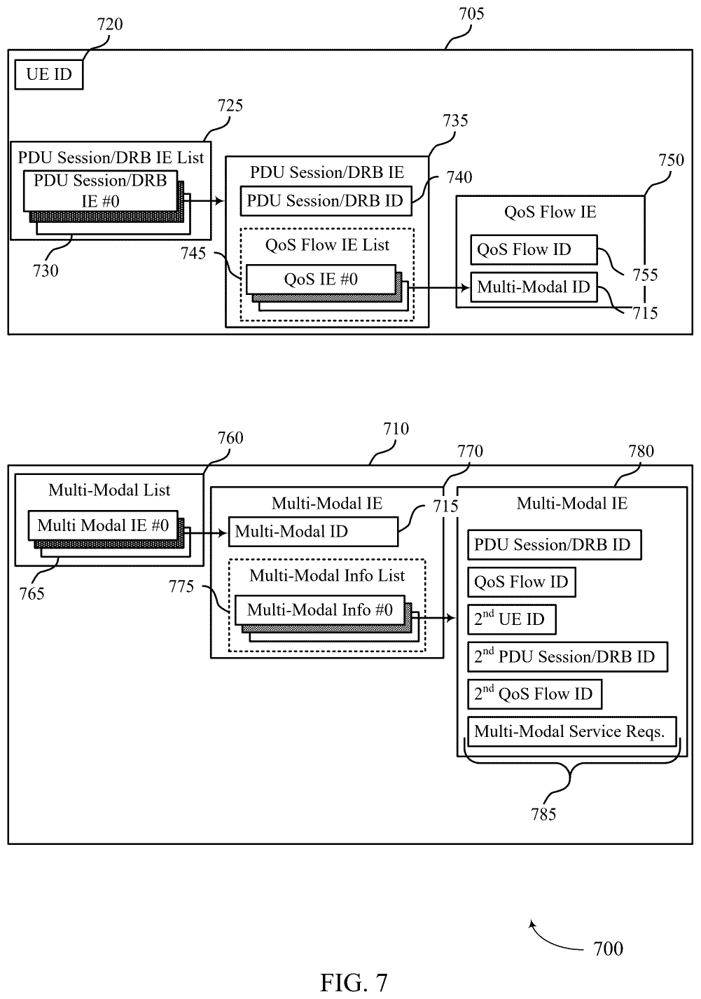

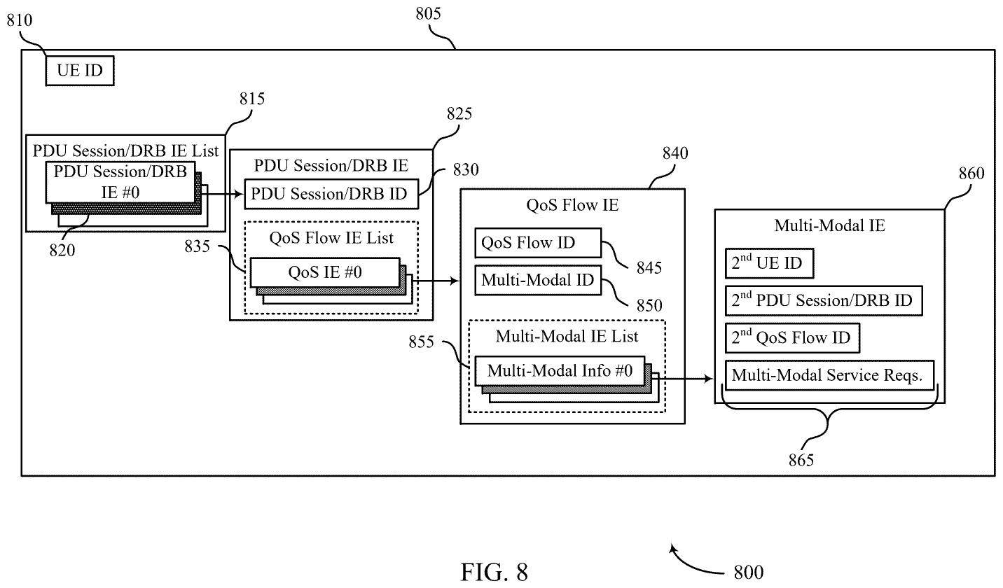

In some examples, to support the multi-modality services, the network entities may communicate via a CP to indicate the support of one or more multi-modal services. For example, the network entity 105-a may transmit an indication of a support for a multi-modality feature and may receive a configuration of the multi-modality feature via the CP. In the UP, information may be added to a general packet radio services (GPRS) tunneling protocol (GTP) for the UP (GTP-U) header of PDUs or PDU sets such that a network entity 105 is capable of identifying which PDUs or PDU sets are tied together. Further descriptions of the control-plane aspects of the techniques of the present disclosure may be described elsewhere herein, such as with reference to FIGS. 4 through 8. For example, the techniques of the present disclosure may describe network entities 105 or RAN nodes reporting a capability of supporting a multi-modal service or multi-modality feature and network entities 105 or RAN nodes being configured with a respective multi-modality service or feature elsewhere herein, such as with reference to FIGS. 4 through 6. Moreover, the techniques of the present disclosure may describe one or more interfaces and messages that may be used to transmit such capability messages and configuration indications, and the structure and use of IEs to indicate the configurations of multi-modal services elsewhere herein, such as with reference to FIGS. 7 and 8. Such messaging of capabilities and configurations may ensure coordination between the network entity 105-a and the network entity 105-b to thus improve the reliability of the wireless communications system 300 that is expected to provide relatively high-reliability services.

In some cases, the indication of the support of a multi-modal service and the indication of a configuration of a multi-modal service may be transmitted between network entities 105. For example, in accordance with the techniques of the present disclosure, such indications may be transmitted between the network entity 105-a and the network entity 105-b via the communication link 125-d, which may be an example of an Xn interface. In some cases, the indications of supporting a multi-modal service and the configuration of the multi-modal service may be transmitted between a CU-CP 310 to a CU-UP 315 of the network entity 105-a via an E1 interface 320. In some other cases, the indications of supporting a multi-modal service and the configuration of the multi-modal service may be transmitted between the CU-CP 310 and the DU 325, the DU 330, or both via an F1-C interface 335 that establishes a connection between the CU-CP 310 and the DU 325, the DU 330, or both. In another case, the indications of supporting a multi-modal service and the configuration of the multi-modal service may be transmitted between the CU-CP 310 and the DU 325, the DU 330, or both via an F1-U interface 340 that is used for the transfer of application data.

Therefore, the techniques of the present disclosure may describe the network entity 105-a (e.g., a first network entity 105) sending a first message to the network entity 105-b (e.g., a second network entity 105) via a first interface. The first message indicating a capability of the network entity 105-a to support one or more multi-modal services associated with two or more data traffic flows. Moreover, the one or more multi-modal services may be associated with one or more UEs 115 (e.g., the UE 115-b, the UE 115-c, and the UE 115-d) where the one or more multi-modal services are capable of supporting applications enabling input from a set of different sources. In accordance with the techniques of the present disclosure, the network entity 105-a may receive a second message via the first interface indicating a configuration of at least one multi-modal service that is associated with at least one data traffic flow. The configuration of the multi-modal service may include a multi-modal service ID associated with the multi-modal service. Thus, the network entity 105-a may communicate with the one or more UEs 115 in accordance with the multi-modal services.

In some examples, the core network of the wireless communications system 300 (e.g., the core network 130 described with reference to FIGS. 1 and 2) may expect to receive an indication of whether a RAN node (e.g., the network entity 105-a or the network entity 105-b) supports one or more multi-modality features or services. Based on the core network 130 receiving an indication of a RAN node supporting at least multi-modality service, the core network 130 may configure the RAN node with the configuration of the multi-modality service. The core network 130 may further add any relevant multi-modality information to the UP (e.g., a GTP-U header) and may ensure that the capacity and capability of the RAN node will not be exceeded. As such, the techniques of the present disclosure may describe adding an indication to the NG, F1, and E1 interfaces of a network entity 105 supporting a multi-modality feature or service. In some examples, a capability message indicating that a network entity supports a multi-modality feature or service may include one or more components. For example, the capability message may include an indication of a threshold quantity (e.g., a maximum quantity) of intra-UE multi-modal services (e.g., multi-modality services within a single UE 115) that can be supported by the network entity 105. In some cases, an indication of 0 may indicate that the network entity 105 is unable to support multi-modal services. Moreover, the capability message may indicate a threshold quantity (e.g., a maximum quantity) of inter-UE multi-modal services that the network entity 105 can support where a lack of such indication may be representative that the network entity 105 is unable support multi-modal services. Further, for a network entity 105 to be capable of supporting inter-UE multi-modal services, the network entity 105 may be expected to also support intra-UE multi-modal services. Additionally, or alternatively, the capability message may indicate a threshold quantity (e.g., a maximum quantity) of QoS flows (e.g., data traffic flows) per multi-modal service that the network entity 105 is capable of supporting and a threshold quantity (e.g., a maximum quantity) of QoS flows across all the multi-modal services that the network entity 105 is capable of supporting.

Such capability message indications may be transmitted by a network entity via a multi-modality support indicator IE that may be set by an NG-RAN node to indicate the support of multi-modality. The IE may include one or more IEs or groups as described herein and shown with reference to Table 1. In some examples, the presence of an IE and/or group may be mandatory (M) or optional (O), such as shown in Table 1, but the examples provided herein should not be considered limiting to the scope of the claims or the disclosure.

TABLE 1

| | | | | |
|---|---|---|---|---|
| | | | IE Type | |
| IE/Group | | | and | |
| Name | Presence | Range | reference | Semantics description |

| | | | |
|---|---|---|---|
| Maximum | M | 0. | 0 means that Intra-UE |
| Number | | <maxNumIntraUE | Multi-Modal Services are |
| of Intra- | | MultiModalServices> | not supported |
| UE Multi- | | | |
| Modal | | | |
| Services | | | |
| Maximum | O | 0. | This IE may be present if |
| Number | | <maxNumInterUE | the IE ‘Maximum |
| of Inter- | | MultiModalServices> | Number of Intra-UE |
| UE Multi- | | | Multi-Modal Services' is |
| Modal | | | set to any value other than |
| Services | | | 0 |
| Maximum | O | 0. | This IE may be present if |
| Number | | <maxNumQoSFlows | the IE ‘Maximum |
| of QoS | | Per | Number of Intra-UE |
| Flows per | | MultiModalService> | Multi-Modal Services' |
| Multi- | | | may be set to any value |
| Modal | | | other than 0 |
| Service | | | |
| Maximum | O | 0. | This IE may be present if |
| Number | | <maxNumQoSFlows | the IE ‘Maximum |
| of QoS | | AcrossAllMultiModalService> | Number of Intra-UE |
| Flows | | | Multi-Modal Services' is |
| across all | | | set to any value other than |
| Multi- | | | 0 |
| Modal | | | |
| Services | | | |

In some examples, ULs 115 may also experience one or more inter-cell mobility issues due to the synchronization thresholds between multi-modal services and the corresponding service data flows. For example, if a first UL 115 (e.g., the UL 115-b) has to be moved to a neighboring cell (e.g., due to degrading radio conditions), each UL 115 in the group of ULs 115 (e.g., the UL 115-b, the UL 115-c, and the UL 115-d) that are involved in or associated with a respective multi-modal service should be moved at the same time. By moving each UL 115 of a multi-modal service at the time, the synchronization of the ULs 115 may be relatively simpler as each multi-modal quality of service (QoS) flow may be managed by the same scheduler. Moreover, the group of ULs 115 may be moved together to ensure that synchronized packets are transmitted and received via the same path within the wireless communications system 300 (e.g., to avoid delays due to forwarding of data packets). Additionally, or alternatively, moving the group of UEs 115 together (e.g., performing a handover procedure for each UE 115 of the group) may ensure that the UE 115-b refrains from moving to a target cell which is unable to accept the other UEs 115 due to a lack of resources.

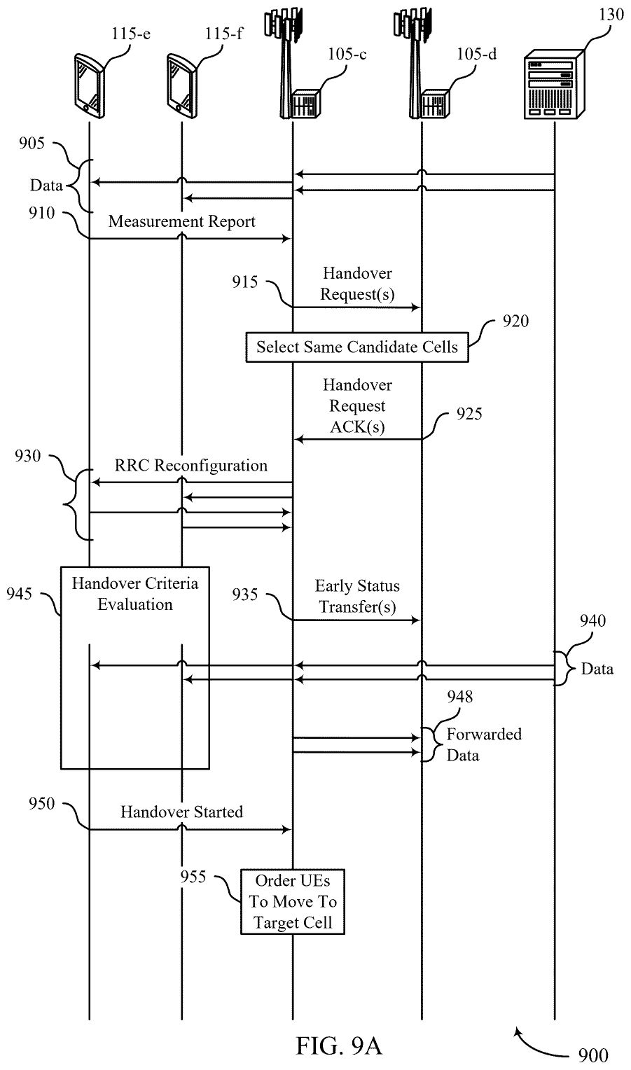

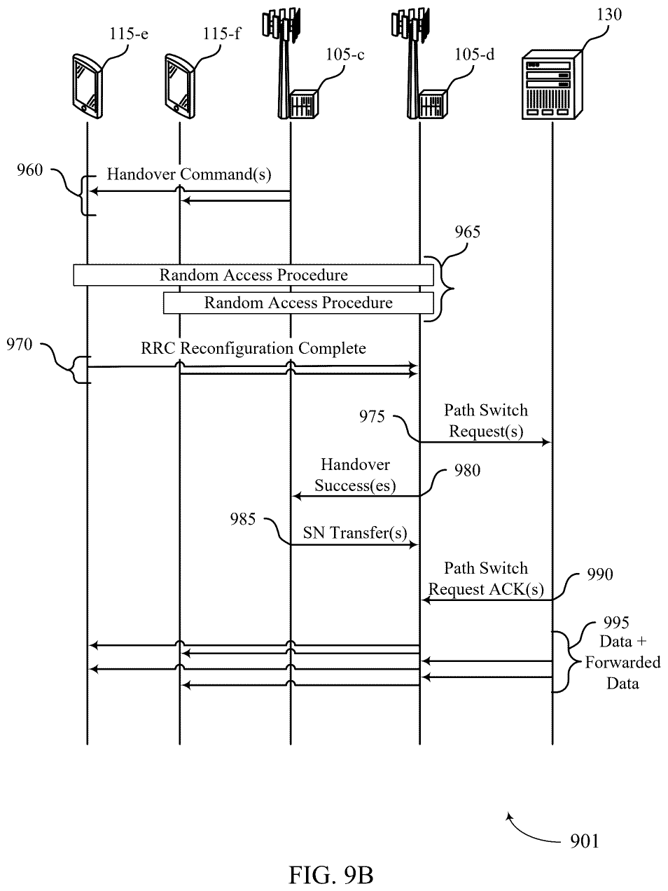

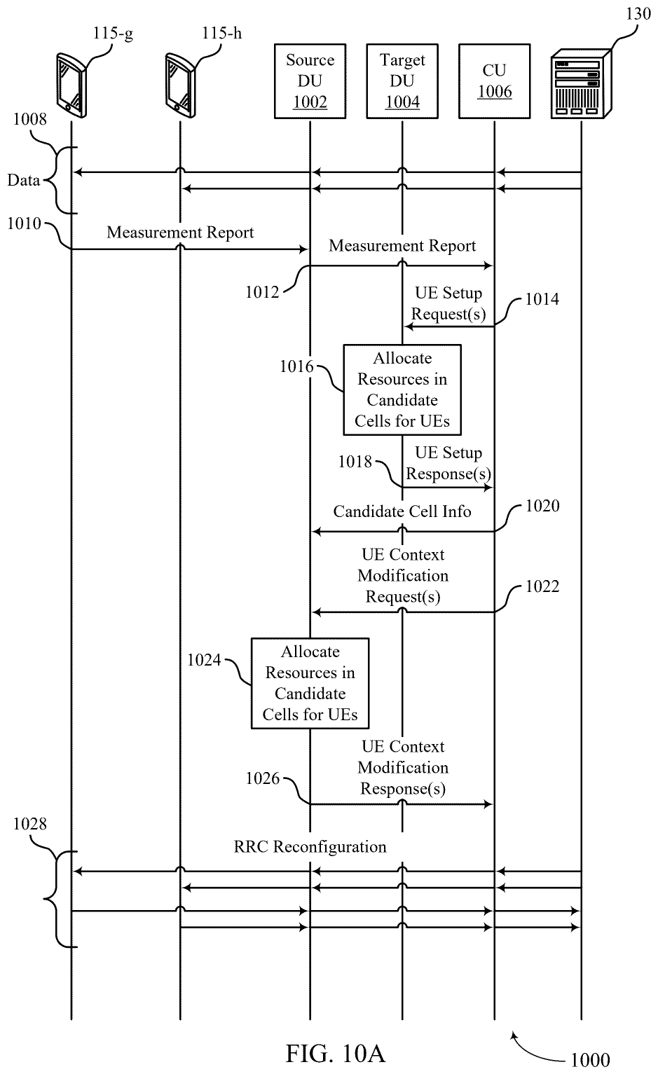

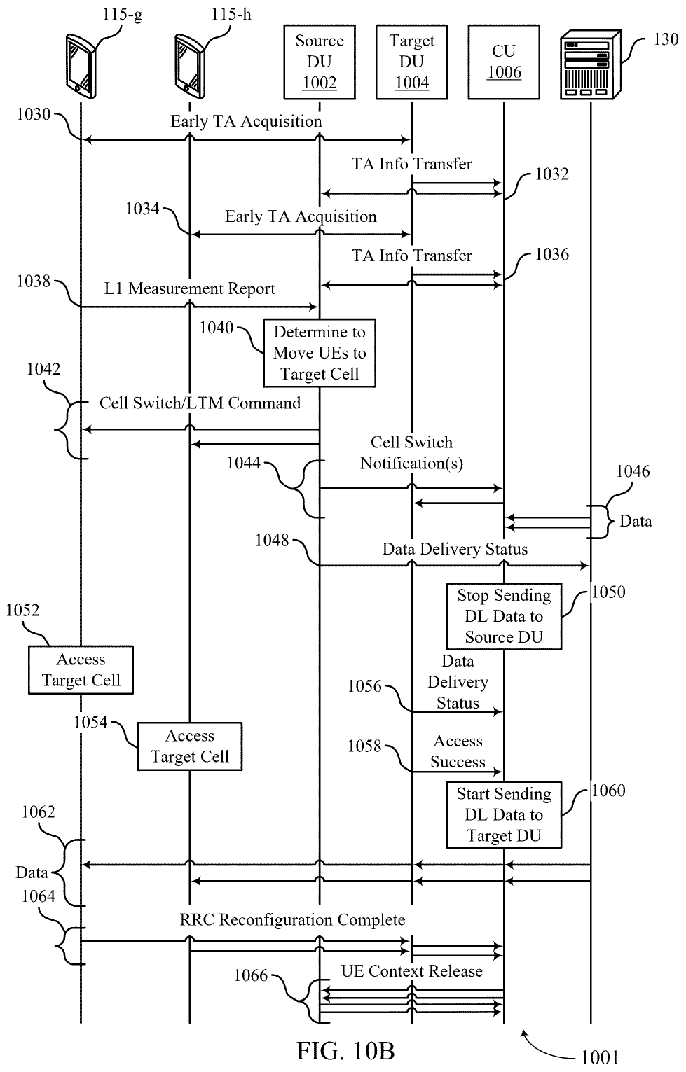

In some examples, to ensure the group of UEs 115 move together (e.g., are associated with the same cell and/or network entity 105 when handover is performed), network entities 105 may transmit common messages that are for each UE 115 in a group of UEs 115 that are involved in the same multi-modal service. In some other examples, messages may be enhanced to indicate the IDs of the other UEs 115 in the group of UEs 115 involved in the same multi-modal service. Further descriptions of the present disclosure related to moving the group of UEs 115 for conditional handovers may be described elsewhere herein, such as with reference to FIGS. 9A and 9B. Moreover, further descriptions of the present disclosure related to LTM cell switching may be described elsewhere herein, such as with reference to FIGS. 10A and 10B.

For example, in accordance with the techniques of the present disclosure, the network entity 105-a may send a group of UEs 115 (e.g., the UE 115-b, the UE 115-c, and the UE 115-d) an indication of a set of candidate cells for handover evaluation, cell switching, or both. In some cases, for conditional handovers, the network entity 105-a may receive a message from the UE 115-b (e.g., a first UE 115 of the group of UEs 115) indicating that the UE 115-b has initiated a handover from the network entity 105-a to the network entity 105-b (e.g., a target network entity 105 associated with a target cell from the set of candidate cells). The network entity 105-a may send a handover command message to the group of UEs 115 to indicate for each UE 115 of the group of UEs 115 to initiate a handover to the network entity 105-b. In some other cases, for LTM, the network entity 105-a may receive a measurement report from the UE 115-b of a target candidate cell (e.g., the candidate cell from the set of candidate cells that is associated with the network entity 105-b).

Based on receiving the measurement report, the network entity 105-a may send a cell switch command to the group of UEs 115 such that each UE 115 of the group of UEs 115 performs a cell switch. Moreover, the network entity 105-a may transmit a cell switch notification message to the network entity 105-b (e.g., the target network entity 105 associated with the target candidate cell) that includes the UE IDs of each UE 115 that received the cell switch command from the network entity 105-a. Thus, in accordance with the techniques of the present disclosure, the network entity 105-a may ensure that each UE 115 of the group of UEs 115 can handover to a different network entity 105 or can switch to a different cell together. Therefore, the techniques of the present disclosure may ensure that communications may remain synchronous to support the relatively low latency and high reliability expectations of the group of UEs 115.

FIG. 4 shows an example of a process flow 401, a process flow 402, a process flow 403, a process flow 404, and a process flow 405 that supports RAN techniques for multi-modal services in accordance with one or more aspects of the present disclosure. In some examples, the process flow 401, the process flow 402, the process flow 403, the process flow 404, and the process flow 405 may implement or be implemented by the wireless communications system 100, the network architecture 200, the wireless communications system 300, or any combination thereof. For example, the process flow 401, the process flow 402, the process flow 403, the process flow 404, and the process flow 405 may include an NG-RAN node 410 and an AMF 415, which may be examples of devices described herein with reference to FIGS. 1 and 2.

In the following description of the process flow 401, the process flow 402, the process flow 403, the process flow 404, and the process flow 405, the operations between the NG-RAN node 410 and the AMF 415 may be performed in different orders or at different times. Some operations may also be left out of the process flow 401, the process flow 402, the process flow 403, the process flow 404, and the process flow 405, or other operations may be added. Although the NG-RAN node 410 and the AMF 415 are shown performing the operations of the process flow 401, the process flow 402, the process flow 403, the process flow 404, and the process flow 405, some aspects of some operations may also be performed by one or more other wireless devices.

In some examples, as illustrated in the process flow 401 and the process flow 402, the NG-RAN node 410 may report an indication of multi-modality support to the AMF 415 during interface management procedures. For example, at 425, the NG-RAN node 410 may transmit (e.g., send), to the AMF 415, a setup request message to establish an NG interface between the NG-RAN node 410 and the AMF 415. In some examples, the NG-RAN node 410 may indicate the support for the multi-modality feature via the setup request message. Thus, at 430, the NG-RAN node 410 may receive, from the AMF 415, a setup response message indicating a successful or unsuccessful establishment of the NG interface. Therefore, as shown in Table 2 below, the NG-RAN node 410 may indicate an additional IC (e.g., a multi-modality support indicator) within an NG setup request message that is sent from the NG-RAN node 410 to transfer application layer information for an NG-control (NG-C) interface instance. In some cases, an NG-C instance may refer to a respective session where application layer information is transferred over the NG interface. In some examples, an instance or a session may be an example of an amount of time (e.g., in slots, symbols, periods, and the like) for the transfer of data between two or more wireless nodes.

TABLE 2

| IE/Group | | | IE Type and | Semantics | | Assigned |
|---|---|---|---|---|---|---|
| Name | Presence | Range | reference | Desc. | Criticality | Criticality |
| Message | M | | 9.3.1.1 | | YES | reject |
| Type | | | | | | |
| Global | M | | 9.3.1.5 | | YES | reject |
| RAN Node | | | | | | |
| ID | | | | | | |
| RAN Node | O | | PrintableString | | YES | ignore |
| Name | | | (Size(1.150, . . . )) | | | |
| Supported | | 1 | | Supported | YES | reject |
| TA List | | | | TAs in the | | |
| | | | | NG-RAN | | |
| | | | | node | | |
| >Supported | | 1.<maxnoofTACs> | | | — | |
| TA Item | | | | | | |

. . .

| | | | | |
|---|---|---|---|---|
| Default | M | Paging DRX | YES | ignore |
| Paging | | 9.3.1.90 | | |
| DRX | | | | |

. . .

| | | | | | |
|---|---|---|---|---|---|
| Extended | O | 9.3.1.193 | | YES | Ignore |
| RAN Node | | | | | |
| Name | | | | | |
| Multi- | O | 9.3.1.xxx | Indication | | |
| Modal | | | of Multi- | | |
| Support | | | Modality | | |
| Indicator | | | Support | | |

In the process flow 402, at 435, the NG-RAN node 410 may transmit, to the AMF 415, a configuration update message to update the AMF 415 of the configuration and the capabilities of the NG-RAN node 410. For example, the NG-RAN node 410 may indicate the support for the multi-modality feature via the configuration update message. Thus, at 440, the NG-RAN node 410 may receive, from the AMF 415, a configuration update acknowledgment message indicating whether the AMF 415 successfully received the configuration update message. Therefore, as shown in Table 3 below, the NG-RAN node 410 may indicate an additional E (e.g., a multi-modality support indicator) within an RAN configuration update message that is sent from the NG-RAN node 410 to transfer updated application layer information for an NG-control (NG-C) interface instance to the AMF 415.

TABLE 3

| IE/Group | | | IE Type and | Semantics | | Assigned |
|---|---|---|---|---|---|---|
| Name | Presence | Range | reference | Desc. | Criticality | Criticality |
| Message | M | | 9.3.1.1 | | YES | reject |
| Type | | | | | | |
| RAN Node | O | | PrintableString | | YES | ignore |
| Name | | | (Size(1.150, . . . )) | | | |
| Supported | | 0 . . . 1 | | Supported | YES | reject |
| TA List | | | | TAs in the | | |
| | | | | NG-RAN | | |
| | | | | node | | |
| >Supported | | 1.<maxnoofTACs> | | | — | |
| TA Item | | | | | | |

. . .

| | | | | | |
|---|---|---|---|---|---|
| Default | O | | Paging DRX | YES | ignore |
| Paging | | | 9.3.1.90 | | |
| DRX | | | | | |
| Global | O | | 9.3.1.5 | YES | ignore |
| RAN Node | | | | | |
| ID | | | | | |
| NG-RAN | | 0 . . . 1 | | YES | reject |
| TNL | | | | | |
| Association | | | | | |
| to Remove | | | | | |
| List | | | | | |

. . .

| | | | | | |
|---|---|---|---|---|---|
| Extended | O | 9.3.1.193 | | YES | ignore |
| RAN Node | | | | | |
| Name | | | | | |
| Multi- | O | 9.3.1.xxx | Indication | | |
| Modal | | | of Multi- | | |
| Support | | | Modality | | |
| Indicator | | | Support | | |

In some other examples, as illustrated in the process flow 403, the process PG-5T, flow 404, and the process flow 405, the NG-RAN node 410 may report an indication of multi-modality support to the AMF 415 during UE 115 specific procedures. For example, in the process flow 403, at 445, the NG-RAN node 410 may receive, from the AMF 415, a session resource setup request to establish a session (e.g., a PDU session) for transmitting and receiving data packets between the NG-RAN node 410 and the AMF 415. At 450, the NG-RAN node 410 may transmit, session resource setup response message that includes an indication of whether the NG-RAN node 410 supports for the multi-modality feature. Therefore, as shown in Table 4 below, the NG-RAN node 410 may indicate an additional IE (e.g., a multi-modality support indicator) within an PDU session resource setup response message that is sent from the NG-RAN node 410 to the AMF 415 as a response to assign resources on the Uu link and the NG-UP (NG-U) interface for one or more PDU session resources.

TABLE 4

| | | | | | | |
|---|---|---|---|---|---|---|
| IE/Group | | | IE Type and | Semantics | | Assigned |
| Name | Presence | Range | reference | Desc. | Criticality | Criticality |

| | | | | |
|---|---|---|---|---|
| Message | M | 9.3.1.1 | YES | reject |
| Type | | | | |
| AMF UE | M | 9.3.3.1 | YES | ignore |
| NGAP ID | | | | |
| RAN UE | M | 9.3.3.2 | YES | ignore |
| NGAP ID | | | | |

. . .

| | | | | | |
|---|---|---|---|---|---|
| User | O | 9.3.1.16 | | YES | ignore |
| Location | | | | | |
| Information | | | | | |
| Multi- | O | 9.3.1.xxx | Indication | | |
| Modal | | | of Multi- | | |
| Support | | | Modality | | |
| Indicator | | | Support | | |

At 455 of process flow 404, the NG-RAN node 410 may receive, from the AMF 415, a session resource modification request message to modify the data packet transmission and reception session. At 460, the NG-RAN node 410 may transmit, to the AMF 415, a session resource modification response message to accept or deny the modification. Moreover, the session resource modification response message may include an indication of whether the NG-RAN node 410 supports for the multi-modality feature. Therefore, as shown in Table 5 below, the NG-RAN node 410 may indicate an additional IE (e.g., a multi-modality support indicator) within an PDU session resource modification response message that is sent from the NG-RAN node 410 to the AMF 415 as to report the outcome of the request from the PDU session resource modification request message from the AMF 415.

TABLE 5

| | | | | | | |
|---|---|---|---|---|---|---|
| IE/Group | | | IE Type and | Semantics | | Assigned |
| Name | Presence | Range | reference | Desc. | Criticality | Criticality |

| | | | | |
|---|---|---|---|---|
| Message | M | 9.3.1.1 | YES | reject |
| Type | | | | |
| AMF UE | M | 9.3.3.1 | YES | ignore |
| NGAP ID | | | | |
| RAN UE | M | 9.3.3.2 | YES | ignore |
| NGAP ID | | | | |

. . .

| | | | | | |
|---|---|---|---|---|---|
| Criticality | O | 9.3.1.3 | | YES | ignore |
| Diagnostics | | | | | |
| Multi- | O | 9.3.1.xxx | Indication | | |
| Modal | | | of Multi- | | |
| Support | | | Modality | | |
| Indicator | | | Support | | |

At 465 of process flow 405, the NG-RAN node 410 may transmit, to the AMF 415, a path switch request message to inform the AMF 415 of an updated service NG-RAN node and to transfer NG-U downlink termination points to a session management function (SMF) via the AMP for one or more PDU session resources. The SMF may be used to collect information related to PDU session management to aid in controlling PDU sessions via the AMF 415. Moreover, the path switch request may include an indication of whether the NG-RAN node 410 supports for the multi-modality feature. In response, at 470, the NG-RAN node 410 may receive, from the AMF 415, a path switch request acknowledgment message to acknowledge the receipt of the path switch request message. Therefore, as shown in Table 6 below, the NG-RAN node 410 may indicate an additional IE (e.g., a multi-modality support indicator) within an path switch request message that is sent from the NG-RAN node 410 to the AMF 415 to indicate that the NG-RAN node 410 supports the multi-modality feature.

TABLE 6

| IE/Group | Pre- | | IE Type and | Semantics | Criti- | Assigned |
|---|---|---|---|---|---|---|
| Name | sence | Range | reference | Desc. | cality | Criticality |
| Message | M | | 9.3.1.1 | | YES | reject |
| Type | | | | | | |
| AMF UE | M | | 9.3.3.1 | | YES | ignore |
| NGAP ID | | | | | | |

. . .

| | | | | | |
|---|---|---|---|---|---|
| RedCap | O | 9.3.1.228 | | YES | ignore |
| Information | | | | | |
| Multi- | O | 9.3.1.xxx | Indication | | |
| Modal | | | of Multi- | | |
| Support | | | Modality | | |
| Indicator | | | Support | | |

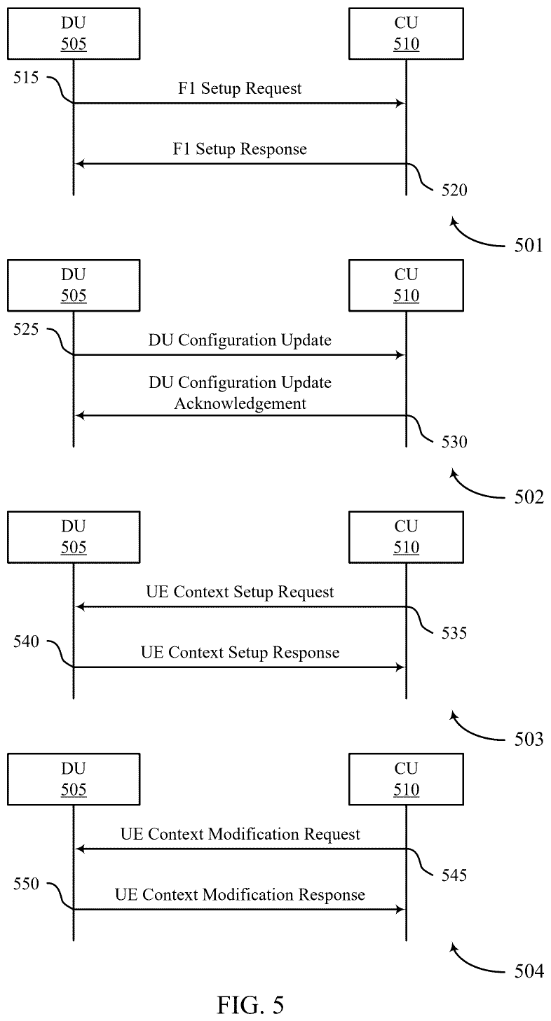

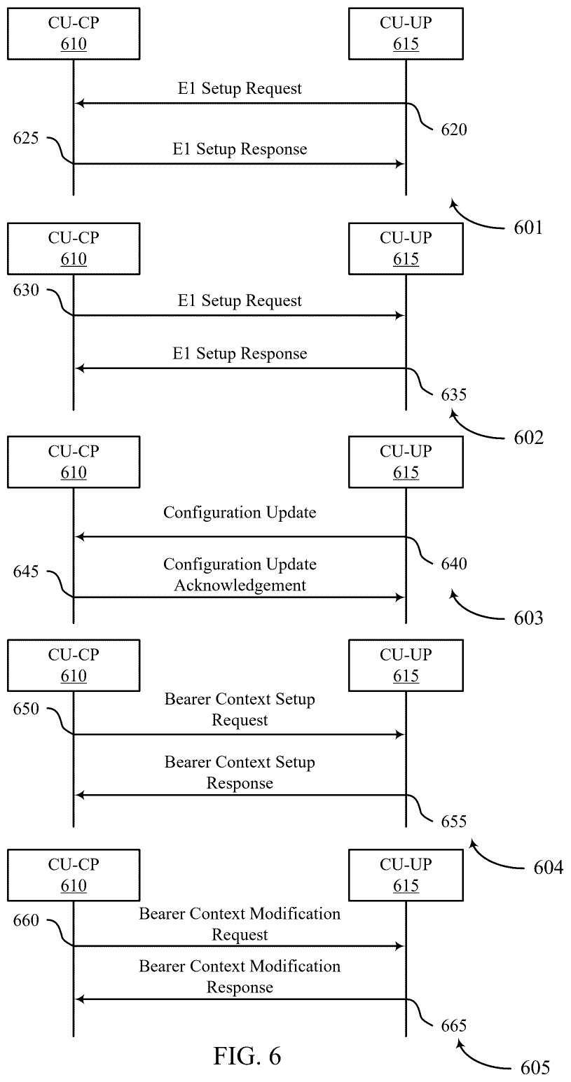

Therefore, in accordance with the present disclosure, the NG-RAN node 410 may be capable of transmitting, to the AMF 415, an indication of whether the NG-RAN node 410 is capable of supporting one or more multi-modal services for communicating with UEs 115. Moreover, enabling the NG-RAN node 410 to transmit an indication of being able to support one or more multi-modal services, in accordance with the techniques of the present disclosure, may increase the reliability of communications as the AMF 415 may be aware of the capabilities of the NG-RAN node 410 for scheduling subsequent communications. Further descriptions of a DU transmitting the support indication to a CU and may be a CU-UP transmitting the support indication to a CU-CP may be described elsewhere herein, such as with reference to FIGS. 5 and 6 accordingly.

FIG. 5 shows an example of a process flow 501, a process flow 502, a process flow 503, and a process flow 504 that supports RAN techniques for multi-modal services in accordance with one or more aspects of the present disclosure. In some examples, the process flow 501, the process flow 502, the process flow 503, and the process flow 504 may implement or be implemented by the wireless communications system 100, the network architecture 200, the wireless communications system 300, or any combination thereof. For example, the process flow 501, the process flow 502, the process flow 503, and the process flow 504 may include an DU 505 and an CU 510 of a network entity 105, which may be examples of devices described herein with reference to FIGS. 1 and 2.

In the following description of the process flow 501, the process flow 502, the process flow 503, and the process flow 504, the operations between the DU 505 and the CU 510 may be performed in different orders or at different times. Some operations may also be left out of the process flow 501, the process flow 502, the process flow 503, and the process flow 504, or other operations may be added. Although the DU 505 and the CU 510 are shown performing the operations of the process flow 501, the process flow 502, the process flow 503, and the process flow 504, some aspects of some operations may also be performed by one or more other wireless devices.

In some examples, as illustrated in the process flow 501 and the process flow 502, the DU 505 may report an indication of multi-modality support to the CU 510 during interface management procedures. For example, as illustrated in process flow 501, at 515, the DU 505 may transmit, to the CU 510, an interface setup request message to establish an F1 interface between the DU 505 and the CU 510 of a respective network entity 105. In some examples, an F1 interface may be the interface to connect the DU 505 and the CU 510 of a network entity 105. Additionally, or alternatively, the F1 interface may support CP and UP separation. For example, the F1-C may allow CP signaling between the DU 505 and the CU 510 and the F1-U may allow the transfer of application data between the DU 505 and the CU 510. Moreover, the interface setup request message may include an indication of whether the DU 505 can support the multi-modality feature. Thus, at 520, the DU 505 may receive, from the CU 510, an interface setup response message to complete the establishment of the F1 interface. Therefore, as shown in Table 7 below, the DU 505 may indicate an additional IE (e.g., a multi-modality support indicator) within an F1 interface setup request message that is sent from the DU 505 to the CU 510 to transfer information associated with an F1-C interface instance. Additionally, or alternatively, if a transport network layer (TNL) association is shared among multiple F1-C interface instances, multiple F1 setup procedures may be performed via the same TNL association after the TNL association becomes operational. In some cases, a TNL association may be an association between two nodes for the transport of data packets within a wireless communications system.

TABLE 7

| | | | | | | As- |
|---|---|---|---|---|---|---|
| | | | | | | signed |
| IE/Group | Pre- | | IE Type and | Semantics | Criti- | Criti- |
| Name | sence | Range | reference | Desc. | cality | cality |
| Message | M | | 9.3.1.1 | | YES | reject |
| Type | | | | | | |
| Transaction | M | | 9.3.1.23 | | YES | ignore |
| ID | | | | | | |
| gNB-DU ID | M | | 9.3.1.9 | | YES | |
| gNB-DU | O | | PrintableString | | YES | |
| Name | | | (Size(1.150, | | | |
| | | | . . . )) | | | |
| gNB-DU | | 0 . . . 1 | | List of | YES | reject |
| Served | | | | cells | | |
| Cells List | | | | configured | | |
| | | | | in the | | |
| | | | | gNB-DU | | |

. . .

| | | | | |
|---|---|---|---|---|
| gNB-DU | M | RRC version | YES | reject |
| RRC | | 9.3.1.70 | | |
| version | | | | |

. . .

| | | | | | |
|---|---|---|---|---|---|
| Extended | O | 9.3.1.205 | | YES | ignore |
| gNB-DU | | | | | |
| Name | | | | | |
| Multi- | O | 9.3.1.xxx | Indication | | |
| Modal | | | of Multi- | | |
| Support | | | Modality | | |
| Indicator | | | Support | | |

In the process flow 502, at 525, the DU 505 may transmit, to the CU 510, a configuration update message to indicate an update to the configuration of the DU 505. At 530, the DU 505 may receive, from the CU 510, a configuration update acknowledgment message in response to the configuration update message, to indicate whether the CU 510 successfully received the configuration update message. In some examples, the DU 505 may use the configuration update message to transfer update information associated with an F1-C interface instance. Moreover, if the F1-C signaling transport is shared among multiple F1-C instances, the configuration update message may transfer the updated information to the multiple associated F1-C instances. Further, as shown in Table 8 below, the DU 505 may indicate an additional IE (e.g., a multi-modality support indicator) within an DU configuration update message that is sent from the DU 505 to the CU 510.

TABLE 8

| | | | | | | As- |
|---|---|---|---|---|---|---|
| | | | IE Type | Seman- | | signed |
| IE/Group | Pre- | | and | tics | Criti- | Criti- |
| Name | sence | Range | reference | Desc. | cality | cality |
| Message | M | | 9.3.1.1 | | YES | reject |
| Type | | | | | | |
| Transaction | M | | 9.3.1.23 | | YES | reject |
| ID | | | | | | |
| Serving | | | 0 . . . 1 | | List of | |
| Cells To | | | | | added | |
| Add List | | | | | cells | |
| | | | | | served by | |
| | | | | | the gNB- | |
| | | | | | DU | |

. . .

| | | | |
|---|---|---|---|
| gNB-DU | 0 . . . 1 | YES | reject |
| TNL | | | |
| Association | | | |
| To Remove | | | |
| List | | | |

. . .

| | | | | | |
|---|---|---|---|---|---|
| Transport | O | 9.3.2.5 | | YES | ignore |
| Layer | | | | | |
| Address | | | | | |
| Info | | | | | |
| Multi- | O | 9.3.1.xxx | Indication | | |
| Modal | | | of Multi- | | |
| Support | | | Modality | | |
| Indicator | | | Support | | |

In some other examples, as illustrated in the process flow 503 and the process flow 504, the DU 505 may report, to the CU 510 an indication of multi-modality support during UE 115 specific procedures. For example, as illustrated in process flow 503, at 535, the DU 505 may receive, from the CU 510, a UE 115 context setup request to establish the UE 115 context of a respective UE 115 between the DU 505 and the CU 510. In response, if the DU 505 succeeds in establishing the UE 115 context, at 540, the DU 505 may send, to the CU 510, a UE 115 context setup response to confirm the setup of a UE 115 context. In some cases, the UE context of a respective UE 115 may include information about the UE 115 such as identification information, connection status, security parameters, location information, QoS parameters, network slicing information, session management information, or any combination thereof. The UE context information may aid a network entity 105 in managing the interactions between the UE 115 and the network entity 105. Moreover, in accordance with the techniques of the present disclosure, the DU 505 may include an additional IE (e.g., a multi-modality support indicator) within the UE context setup response message that is sent from the DU 505 to the CU 510 at 540. Such parameters of the UE context setup response message that includes the multi-modality support indicator may be shown in Table 9 below. In some examples, such information may be included in the UE context setup response message based on the UE 115 being a multi-modal UE 115 or being associated with a multi-modal service. Thus, to reduce the signaling overhead, opposed to transmitting a separate indication of the capability of the DU 505, the DU 505 may report the capability to support multi-modal services, or lack thereof, within the response to the UE context setup message (e.g., within the UE context setup response message).

TABLE 9

| | | | | | | As- |
|---|---|---|---|---|---|---|
| | | | IE Type | | | signed |
| IE/Group | Pre- | | and | Semantics | Criti- | Criti- |
| Name | sence | Range | reference | Desc. | cality | cality |
| Message | M | | 9.3.1.1 | | YES | reject |
| Type | | | | | | |
| gNB-CU | M | | 9.3.1.4 | | YES | reject |
| UE FIAP | | | | | | |
| ID | | | | | | |
| gNB-DU | M | | 9.3.1.5 | | YES | reject |
| UE F1AP | | | | | | |
| ID | | | | | | |

. . .

| | | | | | |
|---|---|---|---|---|---|
| Requested | O | NR CGI | Special Cell | YES | reject |
| Target Cell | | 9.3.1.12 | indicated in the | | |
| ID | | | UE CONTEXT | | |
| | | | SETUO | | |
| | | | REQUEST | | |
| | | | message | | |
| Multi- | O | 9.3.1.xxx | Indication of | | |
| Modal | | | Multi-Modality | | |
| Support | | | Support | | |
| Indicator | | | | | |

In some examples, the UE 115 context may be modified. For example, the context of a UE 115 may change due to a UE 115 being used for an intra-UE 115 multi-modal service, an inter-UE 115 multi-modal service, or both. Thus, as illustrated in process flow 504, at 545, the DU 505 may receive, from the CU 510, a UE 115 context modification request message. In response, at 550, the DU 505 may send, to the CU 510, a UE 115 context modification response message to confirm the modification of the UE 115 context. In some examples, in accordance with the techniques of the present disclosure, similar to the UE 115 context setup response message, to reduce the signaling overhead the DU 505 may include an additional CE (e.g., a multi-modality support indicator) within the UE 115 context modification response message that is sent from the DU 505 to the CU 510 at 550 opposed to sending a separate capability message. Such parameters of the UE 115 context modification message that includes the multi-modal support indicator may be shown via Table 10 below.

TABLE 10

| | | | | | | As- |
|---|---|---|---|---|---|---|
| | | | IE Type | | | signed |
| IE/Group | Pre- | | and | Semantics | Criti- | Criti- |
| Name | sence | Range | reference | Desc. | cality | cality |
| Message | M | | 9.3.1.1 | | YES | reject |
| Type | | | | | | |
| gNB-CU | M | | 9.3.1.4 | | YES | reject |
| UE F1AP | | | | | | |
| ID | | | | | | |
| gNB-DU | M | | 9.3.1.5 | | YES | reject |
| UE F1AP | | | | | | |
| ID | | | | | | |

. . .

| | | | | | |
|---|---|---|---|---|---|
| Requested | O | NR CGI | Special Cell | YES | reject |
| Target | | 9.3.1.12 | indicated in the | | |
| Cell ID | | | UE CONTEXT | | |
| | | | MODIFICATION | | |
| | | | REQUEST | | |
| | | | message | | |
| Multi- | O | 9.3.1.xxx | Indication of | | |
| Modal | | | Multi-Modality | | |
| Support | | | Support | | |
| Indicator | | | | | |

Therefore, in accordance with the techniques of the present disclosure, the DU 505 may be capable of indicating a multi-modal support indicator within F1 interface messages to save overhead associated within indicating the multi-modal support capabilities of the DU 505 to the CU 510. In some examples, the CU 510 may indicate a multi-modal support capability from a CU-UP to a CU-CP within one or more messages to reduce overhead associated with indicating the capability. Further descriptions of the techniques of the present disclosure associated with a CU-UP indicating a multi-modal support capability to a CU-CP may be described elsewhere herein, such as with reference to FIG. 6.

FIG. 6 shows an example of a process flow 601, a process flow 602, a process flow 603, a process flow 604, and a process flow 605 that supports RAN techniques for multi-modal services in accordance with one or more aspects of the present disclosure. In some examples, the process flow 601, the process flow 602, the process flow 603, the process flow 604, and the process flow 605 may implement or be implemented by the wireless communications system 100, the network architecture 200, the wireless communications system 300, or any combination thereof. For example, the process flow 601, the process flow 602, the process flow 603, the process flow 604, and the process flow 605 may include an CU-CP 610 and an CU-UP 615 of a network entity 105, which may be examples of devices described herein with reference to FIGS. 1 and 2.

In the following description of the process flow 601, the process flow 602, the process flow 603, the process flow 604, and the process flow 605, the operations between the CU-CP 610 and the CU-UP 615 may be performed in different orders or at different times. Some operations may also be left out of the process flow 601, the process flow 602, the process flow 603, the process flow 604, and the process flow 605, or other operations may be added. Although the CU-CP 610 and the CU-UP 615 are shown performing the operations of the process flow 601, the process flow 602, the process flow 603, the process flow 604, and the process flow 605, some aspects of some operations may also be performed by one or more other wireless devices.

In some examples, as illustrated in the process flow 601, the process flow 602, and the process flow 603, the CU-UP 615 may report an indication of multi-modality support to the CU-CP 610 during interface management procedures associated with an E1 interface. For example, in process flow 601, at 620, the CU-UP 615 may send, to the CU-CP 610, an interface setup request message to establish an E1 interface. In some cases, the E1 interface may be used and established to connect the CU-CP 610 and the CU-UP 615 for communications between the CP and the UP. In response, at 625, the CU-CP 610 may send, to the CU-UP 615, an interface setup response message. In some cases, to reduce the signaling overhead associated with indicating a capability of supporting a multi-modal service, the CU-UP 615 may include an additional IE (e.g., a multi-modality support indicator) within the E1 interface setup request message that is sent from the CU-UP 615 to the CU-CP 610 to transfer information for a TNL association. The parameters of the E1 interface setup request message that includes the multi-modality support indicator may be shown in Table 11 below.

TABLE 11

| | | | | | | As- |
|---|---|---|---|---|---|---|
| | | | | | | signed |
| IE/Group | Pre- | | IE Type and | Semantics | Criti- | Criti- |
| Name | sence | Range | reference | Desc. | cality | cality |
| Message | M | | 9.3.1.1 | | YES | reject |
| Type | | | | | | |
| Transaction | M | | 9.1.1.53 | | YES | reject |
| ID | | | | | | |
| gNB-CU- | M | | 9.3.1.15 | | YES | reject |
| UP ID | | | | | | |
| gNB-CU- | O | | PrintableString | Name of | YES | ignore |
| UP Name | | | (Size(1.150, | the gNB- | | |
| | | | . . . )) | CU-UP | | |
| CN Support | M | | ENUMER- | | YES | reject |
| | | | ATED (EPC, | | | |
| | | | 5GC, both, .) | | | |
| Supported | | 1.<maxn | | Supported | YES | reject |
| PLMNs | | oofSPL | | PLMNs | | |
| | | MNs> | | | | |

. . .

| | | | | | |
|---|---|---|---|---|---|
| Extended | O | 9.3.1.95 | | YES | ignore |
| gNB-CU- | | | | | |
| UP Name | | | | | |
| Multi- | O | 9.3.1.xxx | Indication | | |
| Modal | | | of Multi- | | |
| Support | | | Modality | | |
| Indicator | | | Support | | |

In some other examples, as illustrated in the process flow 602, at 630, the CU-CP 610 may send, to the CU-UP 615, an interface setup request message (e.g., a gNB-CU-CP E1 setup request) to establish the E1 interface between the CU-CP 610 and the CU-UP 615. Thus, in response, at 635, the CU-UP 615 may send, to the CU-CP 610, an interface setup response message to transfer information for a TNL association. In some cases, similar to when the CU-UP 615 sends the E1 interface setup request message, to reduce the overhead associated with indicating the capabilities of the CU-UP 615 to support multi-modal services, the CU-UP 615 may include an additional IE (e.g., a multi-modality support indicator) within the E1 interface setup response message in accordance with the techniques of the present disclosure. The parameters of the E1 interface setup response message that includes the multi-modality support indicator may be similar to the parameters of the E1 interface setup request message shown with reference to Table 11.

In some cases, as illustrated in the process flow 603, at 640, the CU-UP 615 may send, to the CU-CP 610, a configuration update message to transfer updated information for a TNL association to indicate an update to the configuration of the CU-UP 615. In response, at 645, the CU-CP 610, may send, to the CU-UP 615, a configuration update acknowledgment message to confirm receipt of the configuration update message. Moreover, in accordance with the techniques of the present disclosure, to reduce overhead, the CU-UP 615 may include an additional IE (e.g., a multi-modality support indicator) within the configuration update message to indicate the capability of the CU-UP 615 to support multi-modal services. The parameters of the configuration update message that include the multi-modality support indicator may be shown below with reference to Table 12.

TABLE 12

| | | | | | | As- |
|---|---|---|---|---|---|---|
| | | | | | | signed |
| | | | | Seman- | | IE/ |
| IE/Group | Pre- | | IE Type and | tics | Criti- | Group |
| Name | sence | Range | reference | Desc. | cality | Name |
| Message | M | | 9.3.1.1 | | YES | reject |
| Type | | | | | | |
| Transaction | M | | 9.1.1.53 | | YES | reject |
| ID | | | | | | |
| gNB-CU- | O | | 9.3.1.15 | | YES | reject |
| UP ID | | | | | | |
| gNB-CU- | O | | PrintableString | Name of | YES | ignore |
| UP Name | | | (Size(1.150, | the gNB- | | |
| | | | . . . )) | CU-UP | | |
| Supported | | 1.<maxn | | Supported | YES | reject |
| PLMNs | | oofSPL | | PLMNs | | |
| | | MNs> | | | | |

. . .

| | | | | | |
|---|---|---|---|---|---|
| Extended | O | 9.3.1.96 | | YES | ignore |
| gNB-CU- | | | | | |
| UP Name | | | | | |
| Multi- | O | 9.3.1.xxx | Indication | | |
| Modal | | | of Multi- | | |
| Support | | | Modality | | |
| Indicator | | | Support | | |

In some examples, as illustrated in the process flow 604 and the process flow 605 the CU-UP 615 may report an indication of multi-modality support to the CU-CP 610 during UE 115 specific procedures associated with an E1 interface. For example, in the process flow 604, at 650, the CU-CP 610 may send, to the CU-UP 615, a bearer context setup request message to establish the parameters for one or more bearers. In response, at 655, the CU-UP 615, may send, to the CU-CP 610, a bearer context setup response message. In some cases, a bearer may refer to a technique of delivering data packets from a source to a destination. For example, a default bearer may be established based on a device connecting to a network for a first time (e.g., a UE 115 establishing an initial connection to a network entity 105). Moreover, some wireless devices may utilize dedicated bearers for specific data flow with QoS expectations, such as for multi-modal data traffic flows that expect relatively low latency and high reliability (e.g., low PDB expectations) for data transmissions. For example, a UE 115 may establish a bearer for real-time video data traffic to ensure a level of priority, bandwidth, a PDB, a packet error loss rate, or any combination thereof for the video data. Therefore, the bearer context may indicate the parameters for a bearer which may include one or more QoS parameters or data traffic flow parameters for a type of data to be transmitted via a respective bearer. Additionally, or alternatively, a bearer may also be referred to as a PDU session that establishes a path of data transmission to meet one or more QoS expectations for a type of data. Further, in some cases, the type of data for a bearer may be multi-modal data. Thus, in accordance with the techniques of the present disclosure, the CU-UP 615 may include an additional IE (e.g., a multi-modality support indicator) within the bearer context setup response message to indicate the capability of the CU-UP 615 to support multi-modal services. In some examples, the CU-UP 615 may indicate the capability within the bearer context setup response message to reduce signaling overhead. Moreover, in some cases, the CU-UP 615 may indicate the capability within the bearer context setup response message based on whether the bearer being established or setup is associated with multi-modal data. The parameters of the bearer context setup response message that includes the multi-modality support indicator may be further shown with reference to Table 13 below.

TABLE 13

| IE/Group | Pre- | | IE Type and | Semantics | Criti- | Assigned |
|---|---|---|---|---|---|---|
| Name | sence | Range | reference | Desc. | cality | Criticality |
| Message | M | | 9.3.1.1 | | YES | reject |
| Type | | | | | | |
| gNB-CU- | O | | 9.3.1.4 | | YES | reject |
| CP UE | | | | | | |
| E1AP ID | | | | | | |
| gNB-CU- | O | | 9.3.1.5 | | YES | reject |
| UP UE | | | | | | |
| E1AP ID | | | | | | |

. . .

| | | | | | |
|---|---|---|---|---|---|
| >>PDU | O | 9.3.3.6 | | YES | reject |
| Session | | | | | |
| Resource | | | | | |
| Failed List | | | | | |
| Multi- | O | 9.3.1.xxx | Indication | | |
| Modal | | | of Multi- | | |
| Support | | | Modality | | |
| Indicator | | | Support | | |

In some examples, as illustrated in the process flow 605, at 660, the CU-CP 610 may send, to the CU-UP 615, a bearer context modification request message. For example, the CU-CP 610 may indicate that a respective bearer is being modified or updated to be used for multi-modal data. In response, at 665, the CU-UP 615 may send, to the CU-CP 610, a bearer context modification response message to confirm the modification of the requested bearer context. In some examples, if the bearer modification is related to multi-modal data or service, in accordance with the techniques of the present disclosure, the CU-UP 615 may include an additional IE (e.g., a multi-modality support indicator) within the bearer context modification response message to indicate the capability of the CU-UP 615 to support multi-modal services, in order to reduce signaling overhead. The parameters of such bearer context modification response message from the CU-UP 615 to the CU-CP 610 may be shown via Table 14 below.

TABLE 14

| | | | | | | As- |
|---|---|---|---|---|---|---|
| | | | | | | signed |
| | | | IE Type | | | IE/ |
| IE/Group | Pre- | | and | Semantics | Criti- | Group |
| Name | sence | Range | reference | Desc. | cality | Name |
| Message Type | M | | 9.3.1.1 | | YES | reject |
| gNB-CU-CP | O | | 9.3.1.4 | | YES | reject |
| UE E1AP ID | | | | | | |
| gNB-CU-UP | O | | 9.3.1.5 | | YES | reject |
| UE E1AP ID | | | | | | |

. . .

| | | | | | |
|---|---|---|---|---|---|
| >> | O | 9.3.3.6 | Provides | YES | ignore |
| Retainability | | | information | | |
| Measurements | | | on the | | |
| Information | | | removed | | |
| | | | DRB(s), used | | |
| | | | for | | |
| | | | retainability | | |
| | | | measurements | | |
| | | | in the gNB- | | |
| | | | CU-CP | | |
| Multi-Modal | O | 9.3.1.xxx | Indication of | | |
| Support | | | Multi- | | |
| Indicator | | | Modality | | |
| | | | Support | | |

Therefore, in accordance with the techniques of the present disclosure, the CU-UP 615 may be capable of indicating, to the CU-CP 610, a capability to support multi-modal services within one or more messages associated with the E1 interface between the CU-CP 610 and the CU-UP 615. Thus, the CU-UP 615 may be capable of reducing the overhead associated with indicating the capability to support multi-modal services which can enable the CU-UP 615 to more dynamically indicate such capability information, resulting in a more reliable and efficient communication system. Further description of the techniques of the present disclosure related to the multi-modal service configurations being indicated within the NG, Xn, E1, and F1 interfaces may be described elsewhere herein, such as with reference to FIGS. 7 and 8.

FIG. 7 shows an example of a configuration diagram 700 that supports RAN techniques for multi-modal services in accordance with one or more aspects of the present disclosure. In some examples, the configuration diagram 700 may implement or be implemented by the wireless communications system 100, the wireless communications system 300, or both. For example, the configuration diagram 700 may illustrate a configuration that is transmitted between network entities 105 or components of a network entity 105 via an NG interface, XN interface, E1 interface, F1 interface, or any combination thereof. Moreover, in some cases, the configuration illustrated by the configuration diagram 700 may include a data traffic flow configuration 705 and a multi-modal configuration 710. In some examples, the data traffic flow configuration 705 may also be referred to as a QoS flow configuration as a data traffic flow may be referred to as QoS flow elsewhere herein. For example, a QoS flow may be an example of a type of data traffic flow where stringent QoS expectations are present.

In some examples, all RAN nodes (e.g., network entities 105) in a network may be configured with multi-modality information. In some cases, the multi-modality information may be indicated via a multi-modality configuration that is provided to the CU-CP, the CU-UP, and the CU-DU. For example, in accordance with techniques of the present disclosure, based on a first network entity 105 sending a first message to a second network entity 105 via a first wireless interface indicating a capability of supporting one or more multi-modal services, the first network entity 105 may receive, via the first interface, a second message indicating a configuration for a multi-modal service associated with a data traffic flow. In some cases, the multi-modal configuration may also be added to an NG-AP, an NX-AP, and an E1-AP, where the information related to specific data traffic flows may be embedded within respective PDU session structures. In some other cases, the multi-modal configuration may also be added to the F1-AP protocol; where information related to the data traffic flows or QoS flows may be embedded in radio bearer specific structures (e.g., within DRB structures). Moreover, the multi-modal information (e.g., a synchronization threshold) included in the multi-modal configuration may be specific to a respective data traffic flow.

In some cases, the multi-modal configuration may be an intra-UE 115 multi-modal configuration where each QoS flow or each data traffic flow that is involved in the same multi-modal service are associated with the same UE 115. In some examples, the QoS flows may also be associated with different PDU sessions. Moreover, the multi-modal information of a multi-modal service included in the multi-modal configuration may include a multi-modal ID, a list of PDU sessions, QoS flows, data traffic flows, or any combination thereof involved in the respective multi-modal service, the synchronization expectations between QoS flows, or any combination thereof. In some other cases, the multi-modal configuration may be an inter-UE 115 multi-modal configuration where each QoS flow that is involved in the same multi-modal service are associated with different UEs 115. The multi-modal information included in the inter-UE 115 multi-modal configuration may be similar to the multi-modal information included in the intra-UE 115 multi-modal configuration, however, due to different UEs 115 being involved, the inter-UE 115 multi-modal configuration may include a UE ID (e.g., an ID of a UE 115) for each PDU session, QoS flow, or data traffic clow involved in the respective multi-modal service. Additionally, or alternatively, the multi-modal ID included in the multi-modal configuration may be a unique ID that identifies a respective multi-modal service. Moreover, in some cases, as multiple UEs 115 may be involved in the same multi-modal service, the multi-modal ID may be unique across the one or more UEs 115 involved in a multi-modal service. Further, the multi-modal IDs may be managed by the SMF of a network. Therefore, the SMF may allocate a multi-modal ID to a respective multi-modal service and the SMF may send the multi-modal ID to an AMF via a message transfer function used to transfer messages between the network and UEs 115 (e.g., via a Namf_Communication_N1N2MessageTransfer function).

In some examples, the multi-modal information of a multi-modal configuration may be configured via IEs inside the configuration of each respective QoS or data traffic flow, as described elsewhere herein, such as with reference to FIG. 8. For example, the techniques of the present disclosure may enable the configuration of a QoS or data traffic flow (e.g., a data traffic flow configuration 705) to further include the synchronization expectations of the respective data traffic flow and other data traffic flows. Therefore, while decoding the respective data traffic flow configuration may be relatively more complex with the addition of the multi-modal configuration information associated with the respective data traffic flow, the techniques of the present disclosure may save signaling overhead by preventing the use of an external structure or message to indicate the multi-modal configuration. In some other examples, a network entity 105 may indicate a multi-modal configuration 710 via a structure (e.g., IEs) outside of the configuration of a respective QoS or data traffic flows (e.g., external to the data traffic flow configuration 705), as described and illustrated herein with reference to FIG. 7.

For example, the multi-modal configuration 710 may include a multi-modal ID 715, the synchronization expectations of the data traffic flow configuration 705, the synchronization expectations of other data traffic flow configurations 705, or any combination thereof. Therefore, while indicating the multi-modal configuration 710 external to the data traffic flow configuration 705 may result in an increase in signaling overhead, network entities 105 may use transmit the multi-modal configuration 710 external to the associated data traffic flow configuration 705 reduce the complexity of the data traffic flow configuration 705. Moreover, in some cases, the synchronization expectations of the multi-modal configuration 710 may be signaled within the multi-modal configuration 710 or may be indicated via an ID that can be used to determine the synchronization expectations. For example, the ID may be used to determine an index of a table or database of predefined synchronization values, the ID may be used as an input to a hash function to determine a location of a respective synchronization value, or a combination thereof.

In some examples, as illustrated herein, the data traffic flow configuration 705 may include a UE ID 720 indicating the UE 115 that the data traffic flow configuration 705 is associated with. Moreover, the data traffic flow configuration 705 may include an IE list 725 of PDU sessions or data radio bearers (DRBs). In some cases, the IE list 725 may be associated with PDU sessions when the data traffic flow configuration 705 is associated with the NG-AP protocol, the Xn-AP protocol, the E1-AP protocol, or any combination thereof. In some other cases, the IE list 725 may be associated with DRBs used to carry data associated with an evolved packet system (EPS) bearer when the data traffic flow configuration 705 is associated with the F1-AP protocol. Moreover, the IE list 725 may include one or more IE indications 730 (e.g., PDU session IE indication or DRB IE indication) to indicate respective IEs 735 (e.g., PDU session IEs or DRB IEs). In some examples, a respective IE 735 may be associated with an ID 740 (e.g., a PDU session ID or a DRB ID) and a QoS flow IE list 745. For example, for a PDU session IE 735, the IE 735 may include a PDU session ID 740 to identify the corresponding PDU session and a QoS flow IE list 745 indicating the QoS flow IEs 750 associated with the corresponding PDU session. In some examples, a QoS flow may be referred to as a data traffic flow elsewhere herein. For example, a QoS flow may be an example of a video traffic flow, an audio traffic flow, a tactile traffic flow, and the like. Moreover, a respective QoS flow IE 750 may include a QoS flow ID 755 and the multi-modal ID 715 associated with the respective QoS flow that corresponds to the QoS flow ID 755. Based on the multi-modal ID 715 the data traffic flow configuration 705 may be associated with a respective multi-modal configuration 710 that corresponds to the multi-modal ID 715.

As illustrated, the multi-modal configuration 710 may be transmitted externally to the data traffic flow configuration 705 to reduce the complexity of decoding the respective configurations. Thus, in accordance with the techniques of the present disclosure, a network entity 105 may transmit an indication of the multi-modal configuration 710 in accordance with the multi-modal ID 715 being associated with at least one QoS flow IEs 750 of the data traffic flow configuration 705. In some examples, the multi-modal configuration 710 may be associated with a respective multi-modal service that is associated with one or more UEs 115 and one or more different types of QoS flows. For example, a multi-modal service may be associated with a video-conferencing platform that uses a first data traffic flow for video data and a second data traffic flow for audio data. In another example, the multi-modal service may be associated with cloud-based gaming that has a data traffic flow for gameplay data, a data traffic flow for voice for in-game communications, and a data traffic flow for video streaming. Moreover, the multi-modal configuration 710 may include multi-modal IE list 760 that includes one or more multi-modal IE indications 765. For example, the multi-modal IE list 760 may include a set of identifiers for the one or more multi-modal IE indications 765. In some examples, a respective multi-modal IE indication 765 may be associated with a respective multi-modal IE 770 that corresponds to the multi-modal ID 715 of the multi-modal configuration 710. The respective multi-modal IE 770 may also include a list of multi-info identifiers 775 associated multi-modal information IEs 780 of a respective QoS flow for a respective UE 115.

The multi-modal information IE 780 may further indicate a set of parameters 785 such as a PDU session or DRB ID, a QoS flow ID, a 2nd UE ID, a second QoS flow ID, and an indication of one or more multi-modal service requirements. For example, the multi-modal information IE 780 may indicate the set of parameters 785 for a respective multi-modal IE 770 associated with a set of VR glasses (e.g., a VR HMD UE 115) used for video streaming. Thus, the PDU session/DRB ID may be associated with a video data traffic flow, the QoS flow ID may be associated with the video data traffic flow, the 2nd UE ID may be associated with another UE 115 (e.g., a pair of VR enabled gloves) associated with the multi-modal service, the 2nd QoS flow ID may be associated with an tactile data traffic flow, and the multi-modal service requirements may be associated with the video data traffic flow with respect to the tactile data traffic flow. In some examples, the multi-modal service requirements may include an indication of a synchronization threshold. For example, for the VR glasses, the synchronization threshold may be 25 ms such that the latency or delay between the tactile data of the VR gloves and the video data should be less than 25 ms. Thus, in an example of cloud-based gaming, if a user moves a something using the VR gloves, the user should see the movement within the video stream of the VR glasses within 25 ms or less. Such parameters and IEs used to indicate the multi-modal configuration 710 may be further described with reference to Table 15 below.

TABLE 15

| Information | | |
|---|---|---|
| Element | Parent IE | Description |
| Multi Modal ID | QoS Flow | Unique Identifier across all UEs and QoS flows |
| | Multi Modal | involved in the same Multi-Modal service (Multi- |
| | | Modal Service ID, as described in SA2 TR 23.700- |
| | | 060) |
| Multi Modal List | Message | List of Multi Modal IEs. |
| Multi Modal | Multi Modal List | Contains multi modal information related to the |
| | | service identified by Multi Modal ID |
| Multi Model Info | Multi Modal | List of Multi Modal Info IEs related to the service |
| List | | identified by Multi Modal ID |
| Multi Modal Info | | Contains the multi modal information related to two |
| | | flows tied together in the service identified by Multi |
| | | Modal ID |
| PDU | Multi Modal Info | PDU Session/DRB ID of the 1^{st} QoS Flow |
| Session/DRB ID | | |
| QoS Flow ID | Multi Modal Info | 1^{st} QoS Flow ID |
| 2^{nd} UE ID | Multi Modal Info | UE ID of the 2^{nd} QoS Flow |
| | | Note: This IE may not be used if intra-UE multi- |
| | | modal services only |
| 2^{nd} PDU | Multi Modal Info | PDU Session/DRB ID of the 2^{nd} QoS Flow |
| Session/DRB ID | | |
| 2^{nd} QoS Flow ID | Multi Modal Info | 2^{nd} QoS Flow ID |
| Multi Modal | Multi Modal Info | QoS requirement, as described in SA2 TR 23.700-060 |
| Service | | An example is the synchronization threshold when |
| Requirements | | the media component carried by the 2^{nd} QoS Flow |
| | | is delayed compared to the media component |
| | | carried by the 1^{st} QoS Flow |

Further, in some examples, as the multi-modal configuration 710 may be transmitted external to the data traffic flow configuration 705, with respect to the NG-AP protocol, the Xn-AP protocol, and the E1-AP protocol, a network entity 105 may indicate a respective multi-modal ID 715 as an additional IE in a message. For example, as shown below in Table 16, the multi-modal ID 715 associated with the data traffic flow configuration 705 may be indicated within a PDU session resource setup request transfer message that is transparent to an AMF. Moreover, the AMF may transmit the aspects of the multi-modal configuration 710 may as addition IEs within a PDU session setup request message as shown below in Table 17.

TABLE 16

| | | | IE Type | | | Assigned |
|---|---|---|---|---|---|---|
| IE/Group | Pre- | | and | Semantics | Criti- | IE/Group |
| Name | sence | Range | reference | Desc. | cality | Name |
| QoS Flow | | 1 | | | YES | reject |
| Setup | | | | | | |
| Request | | | | | | |
| List | | | | | | |
| >QoS Flow | | 1 . . . | | | — | |
| Setup | | <maxnoo | | | | |
| Request | | fQoSFlo | | | | |
| Item | | ws> | | | | |
| >>QoS | M | | 9.3.1.51 | | — | |
| Flow | | | | | | |
| Identifier | | | | | | |

. . .

| | | | |
|---|---|---|---|
| >> | O | 9.3.3.6 | This IE |
| Multi- | | | carries the |
| Modal | | | ID of the |
| ID | | | Multi- |
| | | | Modal |
| | | | service |
| | | | that |
| | | | this QoS |
| | | | flow |
| | | | belongs to |

TABLE 17

| | | | | | | As |
|---|---|---|---|---|---|---|
| | | | | | | signed |
| | | | IE Type | | | IE/ |
| IE/Group | Pre- | | and | Semantics | Criti- | Group |
| Name | sence | Range | reference | Desc. | cality | Name |
| Message | M | | 9.3.1.1 | | YES | reject |
| Type | | | | | | |
| AMF UE | M | | 9.3.3.1 | | YES | reject |
| NGAP ID | | | | | | |

. . .

| | | | | | | |
|---|---|---|---|---|---|---|
| UE Slice | O | | 9.3.1.231 | | YES | ignore |
| Maximum | | | | | | |
| Bit Rate List | | | | | | |
| Multi-Modal | | 1 | | | | |
| List | | | | | | |
| > | | 1.<maxn | | | | |
| Multi-Modal | | oof | | | | |
| Item | | Multi | | | | |
| | | Modal> | | | | |
| >> | M | | | This IE | | |
| Multi-Modal | | | | carries the ID | | |
| ID | | | | of the Multi- | | |
| | | | | Modal service | | |
| | | | | that this QoS | | |
| | | | | flow belongs | | |
| | | | | to | | |
| >> | | 1 | | | | |
| Multi-Modal | | | | | | |
| Info List | | | | | | |
| >>> | | 1.<maxn | | | | |
| Multi-Modal | | oof | | | | |
| Info Item | | Multi | | | | |
| | | Modal | | | | |
| | | Infos> | | | | |
| >>>> | M | | 9.3.1.50 | PDU Session | | |
| PDU Session | | | | ID of the 1st | | |
| ID | | | | QoS flow | | |
| >>>> | M | | 9.3.1.51 | 1st QoS Flow | | |
| QoS Flow | | | | ID | | |
| Identifier | | | | | | |
| >>>> | O | | 9.3.3.1 | AMF UE ID | | |
| 2nd AMF | | | | of the 2nd | | |
| UE NGAP | | | | QoS Flow | | |
| ID | | | | | | |
| >>>> | O | | 9.3.3.2 | RAN UE ID | | |
| 2nd RAN UE | | | | of the 2nd | | |
| NGAP ID | | | | QoS Flow | | |
| >>>> | M | | 9.3.1.50 | PDU Session | | |
| 2nd PDU | | | | of the 2nd | | |
| Session ID | | | | QoS Flow | | |
| >>>> | M | | 9.3.1.51 | 2nd QoS | | |
| 2nd QoS | | | | Flow | | |
| Flow | | | | ID | | |
| Identifier | | | | | | |
| >>>>> | M | | | Multi-Modal | | |
| Multi-Modal | | | | service | | |
| Service | | | | requirements | | |
| Reqs. | | | | of 1st and 2nd | | |
| | | | | Flows | | |

In some other examples, as the multi-modal configuration 710 may be transmitted external to the data traffic flow configuration 705, with respect to the F1-AP, a network entity 105 may indicate a respective multi-modal ID 715 as an additional IE in a message. For example, as shown below in Table 18, the network entity 105 may indicate the multi-modal ID 715 associated with the data traffic flow configuration 705 within a UE 115 context setup request message that is sent from the CU to the DU of the network entity 105. Moreover, the network entity 105 may use the UE 115 contest setup request, as described elsewhere herein such as with reference to FIG. 5, for the CU to request, from the DU, the setup of a UE 115 context.

TABLE 18

| | | | IE Type | | | As- |
|---|---|---|---|---|---|---|
| | | | and | | | signed |
| IE/Group | Pre- | | refer- | Semantics | Criti- | Criti- |
| Name | sence | Range | ence | Desc. | cality | cality |
| Message | M | | 9.3.1.1 | | YES | reject |
| Type | | | | | | |

. . .

| | | | | | |
|---|---|---|---|---|---|
| DRB to be | | 0 . . . 1 | | YES | reject |
| Setup List | | | | | |
| > DRB to be | | 1.< | | EACH | reject |
| Setup List | | maxnoo | | | |
| Item | | f | | | |
| IEs | | DRBs | | | |
| >> DRB ID | M | | 9.3.1.8 | — | |

. . .

| | | | | | | |
|---|---|---|---|---|---|---|
| >>> | | 1 | | Shall be used | YES | ignore |
| DRB | | | | for NG-RAN | | |
| Information | | | | cases | | |
| >>>> | M | | 9.3.1.45 | | — | |
| DRB QoS | | | | | | |

. . .

| | | | |
|---|---|---|---|
| >>>> | | 1.< | |
| Flows | | maxnoo | |
| Mapped | | f | |
| to DRB | | QoS | |
| Item | | Flows | |
| >>>>> | M | | 9.3.1.63 |
| QoS Flow | | | |
| Identifier | | | |

. . .

| | | | | | |
|---|---|---|---|---|---|
| >>>>> | O | 9.3.1.141 | Traffic | YES | ignore |
| TSC Traffic | | | pattern | | |
| Charac- | | | information | | |
| teristics | | | associated | | |
| | | | with the QFI. | | |
| | | | Details in TS | | |
| | | | 23.501 [21]. | | |
| >>>>> | O | | This IE | | |
| Multi-Modal | | | carries the ID | | |
| ID | | | of the Multi- | | |
| | | | Modal | | |
| | | | service that | | |
| | | | this QoS | | |
| | | | flow belongs | | |
| | | | to | | |

. . .

| | | | | | | |
|---|---|---|---|---|---|---|
| F1-C | O | | 9.3.1.207 | | YES | reject |
| Transfer | | | | | | |
| Path | | | | | | |
| Multi-Modal | | 1 | | | | |
| List | | | | | | |
| >Multi- | | 1.< | | | | |
| Modal | | maxnoo | | | | |
| Item | | f | | | | |
| | | MultiM | | | | |
| | | odal> | | | | |
| >>Multi- | M | | | This IE | | |
| Modal ID | | | | carries the ID | | |
| | | | | of the Multi- | | |
| | | | | Modal | | |
| | | | | service that | | |
| | | | | this QoS | | |
| | | | | flow belongs | | |
| | | | | to | | |
| >>Multi- | | 1 | | | | |
| Modal Info | | | | | | |
| List | | | | | | |
| >>>Multi- | | 1.< | | | | |
| Modal Info | | max | | | | |
| Item | | noof | | | | |
| | | Multi | | | | |
| | | Modal | | | | |
| | | Infos> | | | | |
| >>>> | M | | 9.3.1.51 | 1st QoS | | |
| QoS Flow | | | | Flow | | |
| Identifier | | | | Identifier | | |
| >>>> | M | | 9.3.1.4 | gNB-CU UE | | |
| 2nd gNB-CU | | | | ID of the 2nd | | |
| UE F1AP ID | | | | QoS Flow | | |
| >>>> | M | | 9.3.1.5 | gNB-DU UE | | |
| 2nd | | | | ID of the 2nd | | |
| gNB-DU | | | | QoS Flow | | |
| UE | | | | | | |
| F1AP ID | | | | | | |
| >>>> | M | | 9.3.1.51 | 2nd QoS | | |
| 2nd QoS | | | | Flow | | |
| Flow | | | | Identifier | | |
| Identifier | | | | | | |
| >>>>> | M | | | Multi-Modal | | |
| Multi- | | | | service | | |
| Modal | | | | requirements | | |
| Service | | | | of 1st and | | |
| Reqs. | | | | 2nd Flows | | |

Therefore, in accordance with the techniques of the present disclosure, to reduce the complexity of a QoS flow configuration (e.g., the data traffic flow configuration 705), a respective network entity may send (e.g., transmit) the multi-modal configuration 710 within a separate message via a set of additional IEs as shown via Table 17 and 18. Thus, the network entities 105 may increase the efficiency and reliability of a wireless communication system by ensuring capabilities of network entities 105 are known and respective multi-modal configurations 710 for respective multi-modal services are shared between network entities 105. However, in some examples, based on a performance level of a decoder, a network entity 105 may be capable of receiving and decoding relatively more complex messages. Thus, in accordance with the techniques of the present disclosure, a network entity 105 may transmit the multi-modal configuration 710 within the data traffic flow configuration 705 to reduce signaling overhead and power consumption. Further descriptions of a network entity 105 indicating the multi-modal configuration 710 within the data traffic flow configuration 705 may be described elsewhere herein, such as with reference to FIG. 8.

FIG. 8 shows an example of a configuration diagram 800 that supports RAN techniques for multi-modal services in accordance with one or more aspects of the present disclosure. In some examples, the configuration diagram 800 may implement or be implemented by the wireless communications system 100, the wireless communications system 300, or both. For example, the configuration diagram 800 may illustrate a configuration that is transmitted between network entities 105 or components of a network entity 105 via an NG interface, XN interface, E1 interface, F1 interface, or any combination thereof. Moreover, in some cases, the configuration illustrated by the configuration diagram 800 may include a data traffic flow configuration 805 that includes a respective multi-modal configuration for a respective multi-modal service. In some examples, the data traffic flow configuration 805 may also be referred to as a QoS flow configuration as a data traffic flow may be referred to as QoS flow elsewhere herein. For example, a QoS flow may be an example of a type of data traffic flow where stringent QoS expectations are present.

In some examples, as described elsewhere herein, to reduce signaling overhead, a network entity 105 (e.g., or a component of a network entity 105) may transmit multi-modality information related to respective multi-modal services within the data traffic flow configuration 805 of a respective data traffic flow (e.g., inside a QoS flow configuration). In some cases, as described elsewhere herein, the data traffic flow configuration 805 may include a UE ID 810 to indicate a respective UE 115 that the data traffic flow configuration 805 is associated with. Moreover, the data traffic flow configuration 805 may include an IE list 815 for a set of PDU session or DRB IE indications 820. For example, the data traffic flow configuration 805 may be associated with multiple PDU sessions or DRBs and thus the IE indications 820 may indicate a respective IE 825 for a PDU session or DRB (e.g., a PDU session IE or a DRB IE).

In some cases, a respective IE 825 for a PDU session or DRB may include an ID 830 to indicate which PDU session or DRB the respective IE 825 is associated with. For example, as described there may be multiple PDU sessions or DRBs associated with a respective UE 115 that corresponds to the ID 810, thus the ID 830 may enable a network entity to identify and determine the PDU session or DRB that corresponds to the ID 830 of the respective IE 825. Moreover, the respective IE 825 may also include a QoS flow IE list 835 that includes indications of one or more QoS IEs 840. As described herein, a QoS flow may be an example of a type of data flow. For example, a first QoS flow may be representative of an audio data flow and a second QoS flow may be representative of a video data flow. In some examples, to indicate the type of data flow associated with a respective QoS flow IE 840, the respective QoS flow IE 840 may include a QoS flow ID 845 and a multi-modal ID 850. In some cases, a network entity 105 may use the multi-modal ID 850 to indicate a multi-modal service that a respective QoS flow IE 840 is associated with. Moreover, the respective QoS flow IE 840 may also include a multi-modal IE list 855 that to indicate one or more multi-modal IEs 860 that each include a set of parameters 865 to indicate one or more other UEs 115 and one or more other QoS flow associated with the multi-modal service indicated by the multi-modal ID 850. For example, a respective QoS flow IE 840 may indicate, via the QoS flow ID 845, that the respective QoS flow IE 840 is associated with a video data traffic flow that is a part of a video-conferencing multi-modal service indicated by the multi-modal ID 850. In such examples, the multi-modal IE list 855 may include an indication of a one or more multi-modal IEs 860 that are associated with the multi-modal service indicated by the multi-modal ID 850.

For example, the UE 115 that corresponds to the UE ID 810 of the data traffic flow configuration 805 may be VR glasses that are associated with a video data traffic flow and an audio data flow of a respective multi-modal service. Therefore, the QoS flow IE list 835 may indicate both a first QoS flow IE 840 and a second QoS flow IE 840 where the QoS flow ID 845 of the first QoS flow IE 840 may correspond to the video data traffic flow and the QoS flow ID 845 of the second QoS flow IE 840 may correspond to the audio data traffic flow. Moreover, as both the video data traffic flow and the audio data traffic flow may be associated with the same multi-modal service, the multi-modal ID 850 of the first QoS flow IE 840 and the second QoS flow IE 840 may be the same. Further, the multi-modal IE list 855 of the first QoS flow IE 840 and the multi-modal IE list 855 of the second QoS flow IE 840 may include one or more multi-modal IEs 860 with a set of parameters 865 that are associated with the respective QoS flow of the respective QoS flow IE 840. For example, the multi-modal service indicated by the multi-modal ID 850 may include a second UE 115 that is a pair of gloves for VR applications and services. Thus, the multi-modal IE list 855 of include an indicate of a multi-modal IE 860 for the VR gloves.

Moreover, the set of parameters 865 may include items such as a UE ID for the second UE 115, a PDU session or DRB ID associated with the second UE 115, a QoS flow ID associated with the second UE 115, and a set of multi-modal service expectations (e.g., multi-modal service requirements). In some cases, the second UE 115 (e.g., the VR gloves) may be associated with tactile data traffic and such association may be indicated via the second QoS flow ID in the set of parameters 865 of the respective multi-modal IE 860. Moreover, the set of multi-modal service expectations in the set of parameters 865 may include a synchronization threshold between two QoS flows. For example, the QoS flow ID 845 of the respective QoS flow IE 840 may indicate a video data traffic flow and the second QoS flow ID in the set of parameters 865 of the respective multi-modal IE 860 may indicate a tactile data traffic flow. Therefore, the synchronization threshold indicated within the multi-modal service expectations may be a synchronization threshold between the video data traffic flow and the tactile data traffic flow. For example, the synchronization threshold may indicate a maximum quantity of time that the VR glasses may display a movement of the gloves within the video stream of the VR glasses.

To indicate such multi-modality information, a network entity may use one or more addition IEs within NG-AP protocol messaging, Xn-AP protocol messaging, E1-AP protocol messaging, or any combination thereof. Such additional IEs and descriptions may be shown below in Table 19.

TABLE 19

| Information | | |
|---|---|---|
| Element | Parent IE | Description |
| Multi Modal ID | QoS Flow | Unique Identifier across all UEs and QoS flows |
| | | involved in the same Multi-Modal service (Multi- |
| | | Modal Service ID, as described in SA2 TR 23.700-060) |
| Multi Modal List | QoS Flow | List of Multi Modal IEs. |
| Multi Modal | Multi Modal | Contains all multi modal information related to the |
| | | service identified by Multi Modal ID |
| 2^{nd} UE ID | Multi Modal | UE ID of the 2^{nd} QoS Flow |
| | | Note: This IE may not be needed if intra-UE multi- |
| | | modal services only |
| 2^{nd} PDU | Multi Modal | PDU Session/DRB ID of the 2^{nd} QoS Flow |
| Session/DRB ID | | |
| 2^{nd} QoS Flow ID | Multi Modal | 2^{nd} QoS Flow ID |
| Multi Modal | Multi Modal | QoS requirement, as described in SA2 TR 23.700-060 |
| Service | | An example is the synchronization threshold when |
| Requirements | | the media component carried by the 2^{nd} QoS Flow |
| | | is delayed compared to the media component |
| | | carried by the 1^{st} QoS Flow |

In some examples, as the data traffic flow configuration 805 may include the multi-modal configuration, a network entity 105 may indicate the one or more addition IEs indicated in Table 19 within a message. For example, in accordance with the techniques of the present disclosure and with respect to the NG-AP protocol, the Xn-AP protocol, and the E1-AP protocol, a network entity 105 may include the additional Its within a PDU session resource setup request transfer message. The IEs of the PDU session resource setup request transfer message may thus be updated to include the IEs shown in Table 19, as shown in Table 20.

TABLE 20

| | | | | | | As- |
|---|---|---|---|---|---|---|
| | | | IE Type | | | signed |
| IE/Group | Pre- | | and | Semantics | Criti- | Criti- |
| Name | sence | Range | reference | Desc. | cality | cality |
| QoS Flow | | 1 | | | YES | reject |
| Setup | | | | | | |
| Request | | | | | | |
| List | | | | | | |
| >QoS Flow | | 1.< | | | — | |
| Setup | | maxno | | | | |
| Request | | ofQoS | | | | |
| Item | | Flows | | | | |
| | | > | | | | |
| >>QoS Flow | M | | 9.3.1.51 | | — | |
| Identifier | | | | | | |

. . .

| | | | | |
|---|---|---|---|---|
| >>Multi- | O | | | This IE |
| Modal ID | | | | carries the ID |
| | | | | of the Multi- |
| | | | | Modal service |
| | | | | that the QoS |
| | | | | flow belongs |
| | | | | to |
| >>Multi- | | 1 | | |
| Modal List | | | | |
| >>> | | 1.< | | |
| Multi-Modal | | maxno | | |
| Item | | of | | |
| | | Multi | | |
| | | Modal | | |
| | | > | | |
| >>>> | M | | 9.3.3.1 | AMF UE ID |
| 2nd AMF | | | | of the 2nd |
| UE | | | | QoS Flow |
| NGAP ID | | | | |
| >>>> | M | | 9.3.3.2 | RAN UE ID |
| 2nd RAN | | | | of the 2nd |
| UE | | | | QoS Flow |
| NGAP ID | | | | |
| >>>> | M | | 9.3.1.50 | PDU Session |
| 2nd PDU | | | | ID of the 2nd |
| Session ID | | | | QoS Flow |
| >>>> | M | | 9.3.1.51 | 2nd QoS Flow |
| 2nd QoS | | | | ID |
| Flow | | | | |
| Identifier | | | | |
| >>>>> | | | | |
| Multi- | M | | | Multi-Modal |
| Modal | | | | service |
| Service | | | | requirements |
| Reqs. | | | | of 1st and 2nd |
| | | | | Flows |

In some other examples, a network entity 105 may indicate the one or more addition IEs indicated in Table 19 within a message of the F1-AP protocol. For example, in accordance with the techniques of the present disclosure and with respect to the F1-AP protocol, a network entity 105 may include the addition IEs in Table 19 within a UE 115 context setup request message. The IEs of the UE context message, shown below in Table 21, that is sent from the CU to the DU of the network entity 105 to request the setup of a UE 115 context may thus include the additional IEs shown in Table 19 to indicate a respective multi-modal service configuration.

TABLE 21

| | | | | | | As- |
|---|---|---|---|---|---|---|
| | | | IE Type | | | signed |
| IE/Group | Pre- | | and | Semantics | Criti- | Criti- |
| Name | sence | Range | reference | Desc. | cality | cality |
| Message | M | | 9.3.1.1 | | YES | reject |
| Type | | | | | | |

. . .

| | | | | | |
|---|---|---|---|---|---|
| DRB to be | | 0 . . . 1 | | YES | reject |
| Setup List | | | | | |
| > DRB to be | | 1.< | | EACH | reject |
| Setup | | maxnoo | | | |
| List Item | | f | | | |
| IEs | | DRBs | | | |
| >> DRB ID | M | | 9.3.1.8 | — | |

. . .

| | | | | | | |
|---|---|---|---|---|---|---|
| >>> | | 1 | | Used for | YES | ignore |
| DRB | | | | NG-RAN | | |
| Information | | | | cases | | |
| >>>> | M | | 9.3.1.45 | | — | |
| DRB QoS | | | | | | |

. . .

| | | | |
|---|---|---|---|
| >>>> | | 1.< | |
| Flows | | Max | |
| Mapped | | noof | |
| to DRB Item | | QoS | |
| | | Flows> | |
| >>>>> | M | | 9.3.1.63 |
| QoS Flow | | | |
| Identifier | | | |

. . .

| | | | | | | |
|---|---|---|---|---|---|---|
| >>>>> | O | | 9.3.1.141 | Traffic | YES | ignore |
| TSC Traffic | | | | pattern | | |
| Charac- | | | | information | | |
| teristics | | | | associated | | |
| | | | | with the QFI. | | |
| | | | | Details in TS | | |
| | | | | 23.501 [21]. | | |
| >>>>> | O | | | This IE | | |
| Multi-Modal | | | | carries the ID | | |
| ID | | | | of the Multi- | | |
| | | | | Modal | | |
| | | | | service that | | |
| | | | | this QoS | | |
| | | | | flow belongs | | |
| | | | | to | | |
| >>>>> | M | | | This IE | | |
| Multi-Modal | | | | carries the ID | | |
| ID | | | | of the Multi- | | |
| | | | | Modal | | |
| | | | | service that | | |
| | | | | this QoS | | |
| | | | | flow belongs | | |
| | | | | to | | |
| >>>>> | | 1 | | | | |
| Multi-Modal | | | | | | |
| List | | | | | | |
| >>>>>> | | 1.< | | | | |
| Multi-Modal | | max | | | | |
| Item | | noof | | | | |
| | | Multi | | | | |
| | | Modal | | | | |
| | | > | | | | |
| >>>>>>> | M | | 9.3.1.4 | gNB-CU UE | | |
| 2nd | | | | ID of the 2nd | | |
| gNB-CU | | | | QoS Flow | | |
| UE F1AP ID | | | | | | |
| >>>>>>> | M | | 9.3.1.5 | gNB-DU UE | | |
| 2nd gNB-DU | | | | ID of the 2nd | | |
| UE F1AP ID | | | | QoS Flow | | |
| >>>>>>> | M | | 9.3.1.51 | 2nd QoS | | |
| 2nd QoS | | | | Flow | | |
| Flow | | | | Identifier | | |
| Identifier | | | | | | |
| >>>>>>> | M | | | Multi-Modal | | |
| Multi-Modal | | | | service | | |
| Service | | | | requirements | | |
| Reqs. | | | | of 1st and | | |
| | | | | 2nd Flows | | |

Therefore, in accordance with the techniques of the present disclosure, a network entity 105 may add the additional multi-modality IEs (e.g., the IEs in Table 15 or in Table 19) to one or more messages for each protocol, as shown below in Table 22. For example, the network entity 105 may update a respective message for a respective protocol as shown below in Table 22 to include the additional multi-modality IEs to enable the network entity 105 to indicate a multi-modal configuration within the respective message.

TABLE 22

| Protocol | Message |
|---|---|
| NG-AP | PDU Session Resource Setup Request |
| | PDU Session Resource Modify Request |
| | Handover Request |
| | Path Switch Request |
| Xn-AP | Handover Request |
| | Retrieve UE Context Response |
| | S-Node Addition Request |
| | S-Node Modification Request |
| | S-Node Modification Required |
| E1-AP | Bearer Context Setup Request |
| | Bearer Context Modification Request |
| F1-AP | UE Context Setup Request |
| | UE Context Modify Request |

As described elsewhere herein, a wireless device (e.g., a network entity 105) may have one or more multi-modality capabilities. Thus, in some examples, a wireless device that receives a message indicating the multi-modality information of a multi-modal service (e.g., one of the messages from Table 22) may exceed the multi-modality capabilities of the wireless device if accepted. For example, a network entity 105 may have the capability to support two QoS flows per multi-modal service, and the network entity 105 may receive a message indicating multi-modality information of a multi-modal service configuration that has three QoS flows, which would exceed the capabilities of the network entity 105. Therefore, the network entity 105 may reject the message or accept the message and send (e.g., transmit) a response indicating that the network entity 105 may refrain from handling the multi-modal service. For example, the network entity 105 may transmit a response message to one of the messages indicated in Table 22. Such corresponding response messages may be shown below in Table 23. Moreover, in some cases, the network entity 105 may also update a critical diagnostics IE of a message to include an indicator that the network entity 105 is refraining from handling the multi-modal service. Additionally, or alternatively, with respect to the F-AP protocol, the messages indicated within Table 22 above may be from a CU-CU of a DU of a network entity and the DU may send the message to reject or accept and indicate a refrain from handling the multi-modal service, as indicated below in Table 23.

TABLE 23

| Protocol | Message |
|---|---|
| NG-AP | PDU Session Resource Setup Response |
| | PDU Session Resource Modify Response |
| | Handover Request Acknowledge |
| Xn-AP | Handover Request Acknowledge |
| | Handover Failure |
| | S-Node Addition Request Acknowledge |
| | S-Node Addition Request Reject |
| | S-Node Modification Request Acknowledge |
| | S-Node Modification Request Reject |
| E1-AP | Bearer Context Setup Failure |
| | Bearer Context Modification Failure |
| F1-AP | UE Context Setup Response |
| | UE Context Setup Failure |
| | UE Context Modify Request |
| | UE Context Modify Failure |

Therefore, in accordance with the techniques of the present disclosure, network entities 105 may be capable of indicating multi-modal configurations within one or more messages according to the wireless protocol being used (e.g., NG-AP, Xn-AP, E1-AP, F1-AP, or any combination thereof). In some examples, UEs 115 involved in a multi-modal service indicated via a multi-modal configuration may move between cells and network entities 105. To enable low-latency and high-reliability communications, a serving network entity 105 may indicate for each UE 115 of a multi-modal service to handover to a target network entity 105 or to move to a target cell such that each UE 115 of the multi-modal service is within a common cell and supported by a common network entity. Further descriptions of such handover or cell switch procedures may be described elsewhere herein, such as with reference to FIGS. 9A and 9B which relate to conditional handover procedures and FIGS. 10A and 10B which relate to LTM cell switching.

FIG. 9A shows an example of a process flow 900 that supports RAN techniques for multi-modal services in accordance with one or more aspects of the present disclosure. In some examples, the process flow 900 may implement or be implemented by the wireless communications system 100, the network architecture 200, the wireless communications system 300, or any combination thereof. For example, the process flow 900 may include a UE 115-e, a UE 115-f, a network entity 105-c, a network entity 105-d, and a core network 130, which may be examples of devices described herein with reference to FIGS. 1 and 2.

In the following description of the process flow 900, the operations between the UE 115-e, the UE 115-f, the network entity 105-c, the network entity 105-d, and the core network 130 may be performed in different orders or at different times. Some operations may also be left out of the process flow 900, or other operations may be added. Although the UE 115-e, the UE 115-f, the network entity 105-c, the network entity 105-d, and the core network 130 are shown performing the operations of the process flow 900, some aspects of some operations may also be performed by one or more other wireless devices.

In some examples, the process flow 900 may illustrate a conditional handover procedure. A conditional handover may be a form of handover that a UE 115 may execute based on one or more handover conditions being satisfied. For example, a UE 115 may receive, from a network entity 105, a set of conditional handover conditions and the UE 115 may begin to evaluate the handover conditions to detect when one or more respective handover conditions are satisfied. In some cases, the conditional handover conditions may also include configurations for one or more conditional handover candidate cells. Additionally, or alternatively, the core network 130 may apply early forwarding or late forwarding of downlink data when initiating conditional handovers. For example, the core network 130 may initiate early data forwarding such that a source network entity 105 of a source cell (e.g., the network entity 105-c) may forward downlink data to a target network entity 105 of a target cell of a set of candidate cells (e.g., the network entity 105-d) before the handover procedure is completed. In another example, the core network 130 may configure the network entity 105-c to perform late data forwarding where the network entity 105-c forwards the downlink data to the network entity 105-d after the handover has been fully completed (e.g., as indicated by the network entity 105-c receiving a handover success message from the network entity 105-d). In some examples, the early forwarding may result in a reduction in latency due to the downlink data being forwarded from the network entity 105-c to the network entity 105-d based on a UE 115 determining a conditional handover condition has been satisfied, however, if the handover fails or is terminated before completion, early forwarding may result in unnecessary data transmission which can increase the consumption of communication resources. Moreover, late forwarding may refrain from consuming communication resources unnecessarily, but the late forwarding may result in an increase in latency due to the data being forwarded once the handover is completed.

In some cases, for multi-modal UEs 115, inter-UE 115 multi-modal services may expect that each UE 115 involved in the multi-modal service should be moved to the same target cell together in cases of conditional handover. However, in some cases, the source network entity 105 of the source cell (e.g., the network entity 105-c) may configure different sets of candidate cells for different UEs 115 of a multi-modal service. For example, the UE 115-e and the UE 115-f may be a part of the same multi-modal service and the network entity 105-c may configure the UE 115-e with a first set of candidate cells for conditional handover evaluation and the UE 115-f with a second set of candidate cells for conditional handover evaluation. Moreover, the UE 115-e and the UE 115-f may determine a satisfaction of the handover criteria for a conditional handover for different target cells. For example, the UE 115-e may determine that a first target cell from the set of candidate cells satisfies the handover criteria, and the UE 115-f may determine that a second target cell from the set of candidate cells satisfies the handover criteria. Additionally, or alternatively, the UE 115-e and the UE 115-f may determine a satisfaction of the handover criteria at different times. Such examples may result in the UE 115-e and the UE 115-f performing handovers to different network entities 105 and different cells, performing handovers at different times, or a combination thereof. Therefore, the conditional handovers may result in an increase in latency and a decrease in effectiveness and reliability within a wireless communications system, thus impacting a user experience (e.g., a user experience related to a multi-modal service).

In accordance with the techniques of the present disclosure, the conditional handover techniques may be enhanced to include additional signaling to ensure that each UE 115 of a group of UEs 115 associated with a multi-modal service are configured with the same set of candidate cells and that the group of UEs 115 move between cells together. For example, at 905, the network entity 105-c may send (e.g., transmit), to the UE 115-e and the UE 115-f, data that is from the core network 130. In some examples, the data sent at 905 to the UE 115-e and the UE 115-f may include one or more downlink messages from the core network 130.

At 910, based on receiving conditional handover, the UE 115-e may send, to the network entity 105-c, a measurement report of a target cell (e.g., the cell associated with the network entity 105-d). In some cases, the measurement report may include one or more measurements of the target cell, an average measurement of the target cell, two or more different types of measurements, or any combination thereof. Moreover, the types of measurements included in the measurement report include reference signal measurements, interference measurements, channel measurements, or any combination thereof. In some examples, the network entity 105-c may receive multiple measurement reports from both the UE 115-c and the UE 115-f for multiple neighboring cells and corresponding neighboring network entities 105. Thus, it should be understood that while FIG. 9A illustrates a single measurement report for a single cell, the network entity 105-c may receive multiple measurement reports, measurement reports for multiple neighboring cells, or a combination thereof.

At 915, the network entity 105-c may send, to the network entity 105-d, one or more handover request messages associated with the UE 115-e and the UE 115-f to determine whether the network entity 105-d is capable of supporting the UE 115-e and the UE 115-f. In some cases, to determine the capabilities of the network entity 105-d, the network entity 105-c may send, to the network entity 105-d, a first handover request message associated with the UE 115-e and a second handover request message associated with the UE 115-f. In some other cases, the network entity 105-c may send, to the network entity 105-d, a common handover request message that is associated with both the UE 115-e and the UE 115-f.

At 920, based on receipt of the handover request messages, the network entity 105-c, the network entity 105-d, or both may determine a set of candidate cells that the UE 115-e and the UE 115-f may initiate handovers to. For example, based on receiving one or more measurement reports from the UE 115-e and the UE 115-f and the one or more handover request messages, the network may determine a set of candidate cells and corresponding network entities 105 that the can support the UE 115-e and the UE 115-f as both the UE 115-e and the UE 115-f should be in the same cell and supported by the same network entity 105 due to being within the same multi-modal service. Thus, the network may select a common set of candidate cells for the UE 115-e and the UE 115-f to evaluate for one or more conditional handover conditions. At 925, the network entity 105-c may receive, from the network entity 105-d, one or more handover request acknowledgments indicating that the network entity 105-d is capable of supporting the UE 115-e and the UE 115-f and the network entity 105-d can be included within the set of candidate cells to be evaluated for a conditional handover. In some cases, the network entity 105-c may receive, from the network entity 105-d, a first handover request acknowledgment message that is associated with the UE 115-e and a second handover request acknowledgment message that is associated with the UE 115-f. In some other cases, the network entity 105-c may receive, from the network entity 105-d, a common handover request acknowledgment message that is associated with both the UE 115-e and the UE 115-f.

Therefore, as described herein, the network entity 105-c may send, to the UE 115-e and to the UE 115-f, an indication of the set of candidate cells selected for condition handover. Moreover, the network entity 105-c may send, to a group of UEs 115 (e.g., a group including the UE 115-e and the UE 115-f) that are associated one or more data traffic flows of a multi-modal service, an indication of a set of candidate cells for handover evaluation. Additionally, or alternatively, the network entity 105-c may send, to the UE 115-e and the UE 115-f, an indication of the conditional handover evaluation criteria within the indication of the set of candidate cells for handover evaluation or within a separate message. For example, at 930, the network entity 105-c may transmit an RRC reconfiguration message to the UE 115-e and the UE 115-f to indicate the conditional handover evaluation criteria and the set of candidate cells to for handover evaluation. The UE 115-e and the UE 115-f may send an RRC reconfiguration complete message to network entity 105-c to indicate that the condition handover information has been successfully received.

At 935, the network entity 105-c may send, to the network entity 105-d, one or more early status transfer messages that are associated with the UE 115-e and the UE 115-f. For example, the network entity 105-c may send a first early status transfer message associated with the network entity 105-c and a second early status transfer message associated with the UE 115-f, or the network entity 105-c may send a common early status transfer message associated with UE 115-e and the UE 115-f. In some cases, the early status transfer messages may indicate that information associated with the UE 115-e and the UE 115-f to assist the network entity 105-d in performing a handover with the UE 115-e and the UE 115-f. While not illustrated, it should be understood that the network entity 105-c may send the early status transfer message(s) (e.g., a common early status transfer message or an early status transfer message per UE 115) to each network entity 105 corresponding to a respective candidate cell. Thus, each network entity 105 of a respective candidate cell may be able to more efficiently perform a handover procedure using the information associated with the UE 115-e and the UE 115-f. Further, when sending a common early status transfer message, the network entity 105-c may use the common early status transfer message for each UE 115 (e.g., multi-modal UE 115) associated with a multi-modal service. Moreover, when using separate early status transfer messages, the network entity 105-c may include one or more parameters within the early status transfer messages to indicate or list the other multi-modal UEs 115 associated with the same multi-modal service of a respective UE 115.

At 940, the UE 115-e and the UE 115-f may receive, from the core network 130 via the network entity 105-c, one or more data transmissions. At 945, while receiving the one or more data transmissions, the UE 115-e and the UE 115-f may evaluate the set of candidate cells in view of the conditional handover criteria. In some examples, the UE 115-e may determine that the conditional handover criteria to perform a handover to the target cell that corresponds to the network entity 105-d may be satisfied. In some cases, based on determining that the condition handover criteria for a target cell is satisfied, the UE 115-e may send, to the network entity 105-c, an indication that the UE 115-e is about to leave the cell of the network entity 105-c and initiate a handover to the network entity 105-d. At 948, in response from receiving such indication that the UE 115-e may handover to the network entity 105-d, the UE 115-e may begin to forward data to the network entity 105-d. In some cases, the UE 115-e may refrain from forwarding the downlink data for the UE 115-e and the UE 115-f to the network entity 105-d until after receiving an indication that the handover was successful in case the handover is terminated or fails. However, forwarding the downlink data early may ensure that a relatively low latency in communications from the handover procedure to ensure that the multi-modal service expectations of a respective multi-modal service associated with the UE 115-e and the UE 115-f are satisfied.

Therefore, when the UE 115-e fulfills the handover criteria, the UE 115-e may initiate the handover from the network entity 105-c (e.g., a source network entity 105) to the network entity 105-d (e.g., a target network entity 105). At 950, the network entity 105-c may receive, from the UE 115-e (e.g., a first UE 115 of a group of UEs 115), a message (e.g., a handover started message) indicating that the UE 115-e has initiated a handover from the network entity 105-c to the network entity 105-d that is associated with a candidate cell (e.g., a target candidate cell included in the set of candidate cells the network entity 105-c indicated as being for handover evaluation. In some cases, the UE 115-e may send such indication to the network entity 105-c via a MAC-control element (MAC-CE) message, an uplink control information (UCI) message, or a combination thereof. Moreover, in some examples, the UE 115-e may include an indication of the respective target cell that the UE 115-e has initiated a handover with via a target cell ID. For example, the UE 115-e may include an indication of a target cell ID that is associated with the cell ID of the network entity 105-d. Further, the UE 115-e may refrain from moving to the target cell of the network entity 105-d immediately after initiating the handover, rather, the UE 115-e may wait for a confirmation message from the network entity 105-c acknowledging the handover, accepting the handover, or both. Moreover, in some examples, the network entity 105-c may configure the UE 115-e to send the handover started message after initiating a handover to a target cell when the handover criteria has been fulfilled or satisfied. In some other examples, if the network entity 105-c refrains from configuring the UE 115-e to send the handover started message, the UE 115-e may refrain from sending the handover started message when initiating a handover.

At 955, the network entity 105-c may determine to order each UE 115 of each multi-modal service associated with the UE 115-e to move to the target cell corresponding to the network entity 105-d with the UE 115-e. For example, if the UE 115-e is associated with two multi-modal services, the network entity 105-c may determine to have each UE 115 associated with the two multi-modal services to move to the target cell with the UE 115-e. Moreover, the network entity 105-c may indicate for each UE 115 to initiate handover procedures to the network entity 105-d based on the UE 115-e determining that the handover criteria to handover the network entity 105-d has been fulfilled or satisfied. Further descriptions of the techniques of the present disclosure associated with a group of UEs 115 of a multi-modal service performing handovers to the network entity 105-d based on a first UE 115 (e.g., the UE 115-e) determining that the handover criteria for the network entity 105-d was fulfilled or satisfies may be described elsewhere herein, such as with reference to FIG. 9B.

FIG. 9B shows an example of a process flow 901 that supports RAN techniques for multi-modal services in accordance with one or more aspects of the present disclosure. In some examples, the process flow 901 may implement or be implemented by the wireless communications system 100, the network architecture 200, the wireless communications system 300, or any combination thereof. For example, the process flow 901 may include a UE 115-e, a UE 115-f, a network entity 105-c, a network entity 105-d, and a core network 130, which may be examples of devices described herein with reference to FIGS. 1 and 2.

In the following description of the process flow 901, the operations between the UE 115-e, the UE 115-f, the network entity 105-c, the network entity 105-d, and the core network 130 may be performed in different orders or at different times. Some operations may also be left out of the process flow 901, or other operations may be added. Although the UE 115-e, the UE 115-f, the network entity 105-c, the network entity 105-d, and the core network 130 are shown performing the operations of the process flow 901, some aspects of some operations may also be performed by one or more other wireless devices. Further, the operations between the UE 115-e, the UE 115-f, the network entity 105-c, the network entity 105-d, and the core network 130 described in the following description of the process flow 901 may be performed after the operations between the UE 115-e, the UE 115-f, the network entity 105-c, the network entity 105-d, and the core network 130 described and illustrated in the process flow 900 described herein with reference to FIG. 9A.

At 960, the network entity 105-c may send, to a group of UEs 115 associated with the same multi-modal service, a handover command message that corresponds to an indication of a message from a first UE 115 of the group of UEs 115 (e.g., the UE 115-e indicating an initiation of a handover from the network entity 105-c to the network entity 105-d based on handover criteria being satisfied or fulfilled). The handover command message may thus indicate for each UE 115 of the group of UEs 115 to handover from the network entity 105-c (e.g., a source network entity 105) to the network entity 105-d (e.g., the target network entity 105) that is associated with a target candidate cell. In some cases, the handover command messages may be indicated via a MAC-CE message, a downlink control information (DCI) message, or a combination thereof. Moreover, the network entity 105-c may include an indication of the target cell associated with the network entity 105-d via a target cell ID within the handover command message. Further, in order to handle race conditions (e.g., a situation where an outcome is determined based on a sequence of events), the network entity 105-c may send the first handover command message to the UE 115 that initiated the handover and determined that the handover criteria had been satisfied or fulfilled (e.g., the network entity 105-c may send the handover command message to the UE 115-e before the UE 115-f). Following sending the handover command message to the UE 115-e, the network entity 105-c may send a handover command message to each other UE 115 (e.g., the UE 115-f) in an order that is UE 115 specific or group-based with a common RNTI that is shared among the UEs 115 of a respective multi-modal service.

At 965, the UE 115-e and the UE 115-f may perform random access procedures with the network entity 105-c and the network entity 105-d to perform the handover from the network entity 105-c to the network entity 105-d. At 970, based on completion of the random access procedures, the UE 115-e and the UE 115-f may send RRC reconfiguration complete messages to the network entity 105-d to indicate that the handover from the network entity 105-c to the network entity 105-d is complete. At 975, the network entity 105-d may send (e.g., transmit) one or more path switch request messages to the core network 130. In some cases, the network entity 105-d may send a first path switch request that is associated with the UE 115-e and a second path switch request that is associated with the UE 115-f. In some other cases, the network entity 105-d may send the core network 130 a common path switch request that is associated with both the UE 115-e and the UE 115-f. Moreover, the network entity 105-d may send the path switch request(s) to indicate that for the core network 130 to reach the UE 115-e and the UE 115-f, the core network 130 should send the corresponding downlink data to the network entity 105-d opposed to the network entity 105-c based on the handover procedure.

At 980, the network entity 105-c may receive, from the network entity 105-d, one or more handover success messages indicating that the UE 115-e and the UE 115-f successfully performed a handover procedure to connect with the network entity 105-d. In some cases, the network entity 105-c may receive, from the network entity 105-d, a first handover success message associated with the UE 115-e and a second handover success message associated with the UE 115-f. In some other cases, the network entity 105-c may receive, from the network entity 105-d, a common handover success message that is associated with both the UE 115-e and the UE 115-f. Using the common handover success message, the network entity 105-d may be capable of indicating that each UE 115 associated with a multi-modal service successfully completed the handover procedure, thus resulting in a decrease in signaling overhead associated with the condition handover procedure. Additionally, or alternatively, when separate handover success messages, the network entity 105-d may include one or more additional parameters within the handover success messages to indicate or list the other multi-modal UEs 115 in the same multi-modal service as a respective UE 115 associated with a respective handover success message,

At 985, in response to receiving the one or more handover success messages, the network entity 105-c may send, to the network entity 105-d, one or more sequence number transfer messages to transfer the sequence numbers associated with the UE 115-e and the UE 115-f from the network entity 105-c to the network entity 105-d. In some cases, the network entity 105-c may send, to the network entity 105-d, a first sequence number status transfer message that is associated with the UE 115-e and a second sequence number status transfer message that is associated with the UE 115-f. In some other cases, the network entity 105-c may send, to the network entity 105-d, a common sequence number status transfer message that is associated with the UE 115-e and the UE 115-f. Moreover, at 990, the network entity 105-d may receive, from the core network 130, one or more path switch request acknowledgment (ACK) messages indicating that the core network 130 has received the path switch request(s) and accepted the path switch request(s) from the network entity 105-d. Further, in some cases, the network entity 105-d may refrain from transmitting any forwarded data from the network entity 105-c to the UE 115-e and the UE 115-f until the reception of all UE-specific sequence number status transfer messages for each UE 115 of a multi-modal service.

In some cases, the core network 130 may send, to the network entity 105-d, a first path switch request ACK message associated with a first path switch request, the UE 115-e, or both and a second path switch request ACK message associated with a second path switch request, the UE 115-f, or both. In some other cases, the core network 130 may send, to the network entity 105-d, a common path switch request ACK message that is associated with the UE 115-e and the UE 115-f, a common path switch request message, a first path switch request message and a second path switch request message, or any combination thereof. For example, in some examples, the network entity 105-d may send a first path switch request message and a second path switch request message and the core network 130 may respond with a common path switch request ACK message. In some other examples, the network entity 105-d may send the core network 130 a common path switch request message and the core network 130 may respond with a first path switch request ACK message and a second path switch request ACK message.

At 995, the network entity 105-d may send, to the UE 115-e and the UE 115-f one or more downlink data transmissions from the core network 130, one or more forwarded data transmissions from the network entity 105-c, or a combination thereof based on the UE 115-e and the UE 115-f being connected to the network entity 105-d after the handover procedure. Therefore, the techniques of the present disclosure, may enable conditional handovers for UEs 115 within a multi-modal service such that when any UE 115 associated with the multi-modal service indicates that handover criteria to a target cell is satisfied, each UE 115 of the multi-modal service may handover to the same cell and corresponding network entity at relatively the same time. Such techniques may ensure that the UEs 115 of a multi-modal service are synchronized and are served by a common network entity 105 to support low-latency and high-reliability communications. Further descriptions of ensuring that multi-modal UEs 115 of a multi-modal service perform a cell switch together for LTM scenarios may be described elsewhere herein, such as with reference to FIGS. 10A and 10B.

FIG. 10A shows an example of a process flow 1000 that supports RAN techniques for multi-modal services in accordance with one or more aspects of the present disclosure. In some examples, the process flow 1000 may implement or be implemented by the wireless communications system 100, the network architecture 200, the wireless communications system 300, or any combination thereof. For example, the process flow 1000 may include a UE 115-g, a UE 115-h, a source DU 1002, a target DU 1004, a CU 1006, and a core network 130, which may be examples of devices described herein with reference to FIGS. 1 and 2.

In the following description of the process flow 1000, the operations between the UE 115-g, the UE 115-h, the source DU 1002, the target DU 1004, the CU 1006, and the core network 130 may be performed in different orders or at different times. Some operations may also be left out of the process flow 1000, or other operations may be added. Although the UE 115-g, the UE 115-h, the source DU 1002, the target DU 1004, the CU 1006, and the core network 130 are shown performing the operations of the process flow 1000, some aspects of some operations may also be performed by one or more other wireless devices.

In some examples, UEs 115 (e.g., the UE 115-g and the UE 115-h) may be a part of the same multi-modal service as described elsewhere herein. Thus, to support inter-UE 115 multi-modal services, the UE 115-g and the UE 115-h which are involved in the same multi-modal service should be moved to the same target cell at the same time. In some cases, UEs 115 may perform LTM cell switching procedures that are triggered by the network via a MAC-CE message that is based on L1 measurements from the UEs 115. For example, at 1008, the UE 115-g and the UE 115-h may receive data signals from the core network 130 via a source DU 1002 of a source network entity 105. In response, at 1010, the DU 1002 may receive a measurement report from the UE 115-g indicating one or more measurements of a target cell. In some LTM cases, a network entity 105 may send the UE 115-g a cell switching command indicating a candidate cell that the network entity 105 has prepared. Moreover, the network entity 105 may send the cell switching command to the UEs 115 via RRC signaling. Additionally, or alternatively, in some cases, the network entity 105 may request that a UE 115 perform an early timing advance (TA) acquisition of a candidate cell before completing a cell switch as to reduce the latency in communications when performing the cell switch.

However, in some examples, the source DU 1002 and the target DU 1004 may allocate different candidate cells for the UE 115-g and the UE 115-g. In some other examples, the UE 115-g and the UE 115-h may send different measurement reports (e.g., L1 measurement reports) at different times. Additionally, or alternatively, the source DU 1002 may move the UE 115-g and the UE 115-h to different target cells at different times. Moreover, in some cases, based on the UE 115-g and the UE 115-h being supported by different cells, the CU 1006 may send downlink data for the UE 115-g and the UE 115-h to different DUs. Thus, in some examples, the UE 115-g and the UE 115-h may be within different cells, be within different cells at different times, move at different times, which may lead to one or more communication impacts. For example, due to being within different cells, the data paths from the core network 130 to the UE 115-g and the UE 115-h may be different which can result in one of the UEs 115 experiencing a relatively higher level of latency.

In accordance with the techniques of the present disclosure, the source DU 1002, the target DU 1004, and the CU 1006 may ensure that the UE 115-g and the UE 115-h perform cell switches together such that the UEs 115 are in the same cell at the same time. For example, at 1012, the source DU 1002 may send, to the CU 1006, an indication of a measurement report from the UE 115-g of a target cell. In some cases, the indication of the measurement report may be within an uplink RRC message transfer that includes the indication. Further, at 1014, the CU 1006 may send, to the target DU 1004, one or more UE 115 context setup request messages. In some examples, the CU 1006 may send, to the target DU 1004, a first UE 115 context setup request message that is associated with the UE 115-g and a second UE 115 context setup request message that is associated with the UE 115-h. In some cases, the individual UE 115 context setup request messages may also include one or more IEs or parameters to indicate the other UEs 115 in the same multi-modal service. In some other examples, the CU 1006 may send, to the target DU 1004, a common UE 115 context setup request message that is associated with both the UE 115-g and the UE 115-h based on the UE 115-g and the UE 115-h being a part of the same multi-modal service. Further, for the common UE 115 context setup request message and any other common messages, it should be understood that the common message may be associated with each UE 115 that is associated with the same multi-modal service.

At 1016, the target DU 1004 may allocate a set of resources within one or more candidate cells for the UE 115-g and the UE 115-h in preparation for a possible cell switch. Moreover, at 1018, the target DU 1004 may send, to the CU 1006, one or more UE 115 context setup response messages. In some examples, the target DU 1004 may send, to the CU 1006, a first UE 115 context setup response message associated with the UE 115-g and a second UE 115 context setup response message associated with the UE 115-h. In some other examples, the target DU 1004 may send, to the CU 1006, a common UE 115 context setup response message that is associated with both the UE 115-g and the UE 115-h based on the UE 115-g and the UE 115-h being a part of the same multi-modal service.

At 1020, the CU 1006 may send, to the source DU 1002, information associated with the candidate cells. Further, at 1022, the CU 1006 may send, to the source DU 1002, one or more UE 115 context modification request messages. For example, in some cases, the CU 1006 may send, to the source DU 1002, a first UE 115 context modification request message that is associated with the UE 115-g and a second UE 115 context modification request message that is associated with the UE 115-h. In some other cases, the CU 1006 may send, to the source DU 1002, a common UE context modification request message that is associated with both the UE 115-g and the UE 115-g based on the UE 115-g and the UE 115-h being a part of the same multi-modal service. At 1024, based on receiving of the common UE 115 context modification request message, the source DU 1002 may select the same set of candidate cells for each UE ID indicated within the common UE 115 context modification request message. Moreover, in cases where the source DU 1002 receives individual common UE 115 context modification request messages for the UE 115-g and the UE 115-h, the source DU 1002 may wait for the reception of all the UE 115 context modification request messages to select the same set of candidate cells for all the UE IDs indicated in the various received UE 115 context modification request messages. Thus, at 1026, the source DU 1002 may send, to the CU 1006, one or more UE 115 context modification response messages. In some examples, the source DU 1002 may send, to the CU 1006, a first UE 115 context modification response message that is associated with the UE 115-g and a second UE 115 context modification response message that is associated with the UE 115-h. In some other examples, the source DU 1002 may send, to the CU 1006, a common UE 115 context modification response message that is associated with both the UE 115-g and the UE 115-h. Moreover, in some cases, the source DU 1002 may send a common UE 115 context modification response message in response to receiving a common UE 115 context modification request message or in response to receiving individual UE 115 context modification request messages. In some other cases, the source DU 1002 may send individual UE 115 context modification response messages in response to receiving a common UE 115 context modification request message or in response to receiving individual UE 115 context modification request messages. At 1028, after sending the one or more UE 115 context modification request response messages, the source DU 1002 may perform, with the UE 115-g and the UE 115-h, an RRC reconfiguration procedure. In some examples, the RRC reconfiguration procedure may include the source DU 1002 receiving, from the CU 1006, a first downlink RRC message indicating an RRC reconfiguration for the UE 115-g and a second downlink RRC message indicating an RRC reconfiguration for the UE 115-h. The source DU 1002 may send an RRC reconfiguration message to the UE 115-g and an RRC reconfiguration message to the UE 115-h. In response, the UE 115-g and the UE 115-h may send, to the source DU 1002, RRC reconfiguration complete messages indicating successful RRC reconfigurations. Moreover, the source DU 1002 may send, to the CU 1006, uplink RRC messages indicating the RRC reconfiguration competition indications from the UE 115-g and the UE 115-h.

Further descriptions of the source DU 1002 utilizing the set of common candidate cells selected for the UE 115-g and the UE 115-h in accordance with the techniques of the present disclosure may be described elsewhere herein. For example, FIG. 10B may be an expansion of the process flow 1000 and may describe an LTM cell switching procedure such that the UE 115-g and the UE 115-h that are a part of the same multi-modal service switch to the same target cell at the same time.

FIG. 10B shows an example of a process flow 1001 that supports RAN techniques for multi-modal services in accordance with one or more aspects of the present disclosure. In some examples, the process flow 1001 may implement or be implemented by the wireless communications system 100, the network architecture 200, the wireless communications system 300, or any combination thereof. For example, the process flow 1001 may include a UE 115-g, a UE 115-h, a source DU 1002, a target DU 1004, a CU 1006, and the core network 130, which may be examples of devices described herein with reference to FIGS. 1 and 2.

In the following description of the process flow 1001, the operations between the UE 115-g, the UE 115-h, the source DU 1002, the target DU 1004, the CU 1006, and the core network 130 may be performed in different orders or at different times. Some operations may also be left out of the process flow 1001, or other operations may be added. Although the UE 115-g, the UE 115-h, the source DU 1002, the target DU 1004, the CU 1006, and the core network 130 are shown performing the operations of the process flow 1001, some aspects of some operations may also be performed by one or more other wireless devices. Further, the UE 115-g, the UE 115-h, the source DU 1002, the target DU 1004, the CU 1006, and the core network 130 described in the following description of the process flow 1001 may be performed after the operations between the UE 115-g, the UE 115-h, the source DU 1002, the target DU 1004, the CU 1006, and the core network 130 described and illustrated in the process flow 1000 described herein with reference to FIG. 10A.

At 1030, the UE 115-g and the target DU 1004 may perform an early TA acquisition. In some cases, the TA acquisition may be used to determine a distance between the UE 115-g and the target DU 1004 such that a correct TA can be used to ensure that messages are received in the correct order and at the right times. Thus, at 1032, the target DU 1004 may send (e.g., transmit, transfer) the TA info to the CU 1006 which may share the TA info for communications between the UE 115-g and the target DU 1004 with the source DU 1002. At 1034, the UE 115-h and the target DU 1004 may perform an early TA acquisition such that at 1036, the TA info may be shared or transferred between the target DU 1004 and the CU 1006 and between the CU 1006 and the source DU 1002. At 1038, the UE 115-g may send (e.g., transmit), to the source DU 1002, a L1 measurement report. Therefore, at 1040, based on receiving of the L1 measurement report from the UE 115-g that belongs to a multi-modal service, the source DU 1002 may determine to move each UE 115 of the same multi-modal service to the same target cell.

At 1042, the source DU 1002 may send, to the UE 115-g and the UE 115-h, a cell switch or LTM command message to indicate for both the UE 115-g and the UE 115-h to perform a cell switch to the same target candidate cell based on the L1 measurement report. For example, the L1 measurement report may indicate that one or more measurements of the target candidate cell satisfy one or more measurement thresholds to trigger a LTM cell switch. At 1044, the source DU 1002 may send, to the CU 1006, one or more cell switch notification messages (e.g., one or more F1-AP cell switch notification messages) to indicate that the UE 115-g and the UE 115-h are switching from a source cell to a target candidate cell associated with the target DU 1004. The CU 1006 may send, to the target DU 1004, the one or more cell switch notification messages from the source DU 1002. In some examples, the source DU 1002 and the CU 1006 may send the one or more cell switch notification messages via a first cell switch notification message associated with the UE 115-g and a second cell switch notification message associated with the UE 115-h. Moreover, the first cell switch notification message and the second cell switch notification message may include one or more additional parameters that include a list of the other multi-modal UEs 115 that are tied together via the same multi-modal service. In some other examples, the source DU 1002 and the CU 1006 may send a common cell switch notification message that is associated with both the UE 115-g and the UE 115-h based on the UE 115-g and the UE 115-h being within the same multi-modal service. Thus, the common cell switch notification message (e.g., the F1-AP common cell switch notification message) may be capable of supporting multiple multi-modal UEs 115 associated with the same multi-modal service.

At 1046, the CU 1006 may receive, from the core network 130, one or more downlink data transmissions for the UE 115-g and the UE 115-h. Moreover, at 1048, the source DU 1002 may send, to the CU 1006, one or more data delivery status messages to indicate whether the source DU 1002 can send data to the UE 115-g and the UE 115-h. In some examples, the source DU 1002 may send a first data delivery status message that is associated with the UE 115-g and a second data delivery status message that is associated with the UE 115-h. In some other examples, the source DU 1002 may send a common data delivery status message that is associated with both the UE 115-g and the UE 115-h. In such examples, the source DU 1002 may indicate, to the CU 1006 via the one or more data delivery status messages, that the source DU 1002 is unable to deliver downlink data to the UE 115-g and the UE 115-h due to an upcoming cell switch procedure.

At 1050, the CU 1006 may refrain from sending, to the source DU 1002, downlink data associated with the UE 115-g and the UE 115-h. For example, based on receiving the common cell switch notification message or the common data delivery status message from the source DU 1002, the CU 1006 may stop sending downlink data for all multi-modal UEs 115 associated with a respective multi-modal service to the source DU 1002. In another example, after receiving a first cell switch notification message or a first data delivery status message from the source DU 1002, the CU 1006 may stop sending, to the source DU 1002, downlink data for all multi-modal UEs 115 associated with a respective multi-modal service of the UE 115 indicated via the first cell switch notification message or the first data delivery status message. Therefore, if the source DU 1002 is unable to support even one UE 115 of a multi-modal service due to a cell switch, the CU 1006 may determine that each other UE 115 of the multi-modal service will also be performing a cell switch and may refrain from sending the downlink data for other UEs 115 associated with the same multi-modal service to ensure that the downlink data is accurately received by the respective UEs 115

At 1052 and 1054, the UE 115-g and the UE 115-h, respectively, may access the target cell and complete the cell switch from a source cell to a target candidate cell. At 1056, the target DU 1004 may send, to the CU 1006, one or more data delivery status messages to indicate that the target DU 1004 is capable of supporting sending downlink data to the UE 115-g and the UE 115-h. In some examples, the target DU 1004 may send, to the CU 1006, a first data delivery status message that is associated with the UE 115-g and a second data delivery status message that is associated with the UE 115-h, where the first data delivery status message and the second data delivery status message both include one or more additional parameters indicating a list of one or more other UEs 115 of the same multi-modal service. In some other examples, the target DU 1004 may send, to the CU 1006, a common data delivery status message that is associated with both the UE 115-g and the UE 115-h, where the common data delivery status message indicates multiple UEs 115 associated with the same multi-modal service.

At 1058, the target DU 1004 may also send, to the CU 1006, one or more access success messages (e.g., one or more F1-AP access success messages) to indicate that the UE 115-g and the UE 115-g successfully accessed the target candidate cell. In some examples, the target DU 1004 may send, to the CU 1006, a first access success message that is associated with the UE 115-g and a second access success message that is associated with the UE 115-h. Moreover, the first access success message and the second access success message may include one or more additional parameters that list one or more other UEs 115 that are a part of the same multi-modal service (e.g., a list of the UEs 115 tied together via the same multi-modal service). Additionally, or alternatively, the target DU 1004 may send, to the CU 1006, the first access success message subsequent to the first data delivery status message and the second access success message subsequent to the second data delivery status message. In some other examples, the target DU 1004 may send, to the CU 1006, a common access success message that is associated with both the UE 115-g and the UE 115-h, where the common access success message can be used to support multiple UEs 115 associated with the same multi-modal service.

At 1060, based on receiving the one or more access success messages or data delivery status messages from the target DU 1004, the CU 1006 may determine to begin sending the downlink data for the UE 115-g and the UE 115-h to the target DU 1004. In some examples, the CU 1006 may determine to begin sending the downlink data to the target DU 1004 after receiving the common access success message, the common delivery status message, or both from the target DU 1004. In some other examples, the CU 1006 may wait to receive each access success message, each delivery status message, or both for each UE 115 of a respective multi-modal service before beginning to send the downlink data for the UEs 115 of the respective multi-modal service to the target DU 1004. Therefore, at 1062, the UE 115-g and the UE 115-h may receive one or more data transmissions from the core network 130 via the target DU 1004 while in the target candidate cell. Moreover, at 1064, the UE 115-g and the UE 115-h may send RRC reconfiguration complete messages to the target DU 1004 and the target DU 1004 may send, to the CU 1006, uplink RRC messages indicating the RRC reconfiguration complete messages from the UE 115-g and the UE 115-h. Additionally, or alternatively, based on the RRC reconfiguration being complete and the UE 115-g and the UE 115-h completing the cell switch, at 1066, the CU 1006 may send, to the source DU 1002, a UE 115 context release command for each UE 115 (e.g., for the UE 115-g and the UE 115-h) to free up resources at the source DU 1002. The source DU 1002 may send, to the CU 1006, a UE 115 context release complete message for each respective UE 115 to indicate the UE 115 context release has been completed.

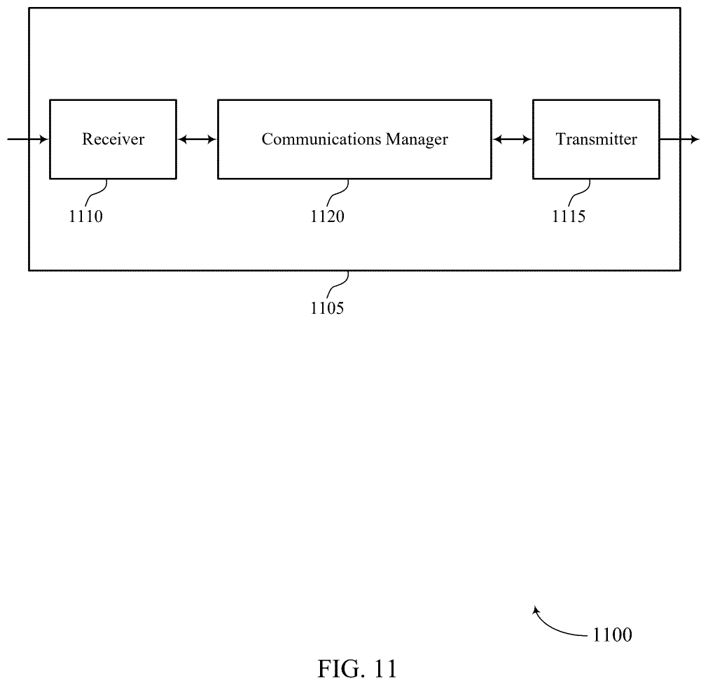

Therefore, in accordance with the techniques of the present disclosure, the source DU 1002, the target DU 1004, the CU 1006, or any combination thereof may ensure that UEs 115 that are a part of the same multi-modal service switch to the same target cell at the same time. Such cell switching enhancements may ensure that each UE 115 of a multi-modal service receives data via the same data path which may result in relatively more accurate synchronization between the multiple data traffic flows of the multi-modal service. Moreover, the techniques of the present disclosure may enable more efficient and reliable support for multi-modal services within a wireless communications system. Further descriptions of the techniques of the present disclosure may be described elsewhere herein, such as with reference to FIGS. 11 through 21.

FIG. 11 shows a block diagram 1100 of a device 1105 that supports RAN techniques for multi-modal services in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of RAN techniques for multi-modal services as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for sending, via a first interface between the first network entity and a second network entity, a first message indicating a capability of the first network entity to support one or more multi-modal services associated with two or more data traffic flows, the one or more multi-modal services being associated with one or more UEs, where the one or more multi-modal services support applications enabling input from a set of multiple sources. The communications manager 1120 is capable of, configured to, or operable to support a means for receiving, via the first interface, a second message indicating a configuration of at least one multi-modal service of the one or more multi-modal services that is associated with at least one data traffic flow of the one or more data traffic flows, the configuration of the at least one multi-modal service including a multi-modal service identifier associated with the at least one multi-modal service. The communications manager 1120 is capable of, configured to, or operable to support a means for communicating, with the one or more UEs, in accordance with the one or more multi-modal services.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for a network entity to indicate support for multi-modal services and receive multi-modal service configurates to support reduced processing, reduced power consumption, and more efficient utilization of communication resources.

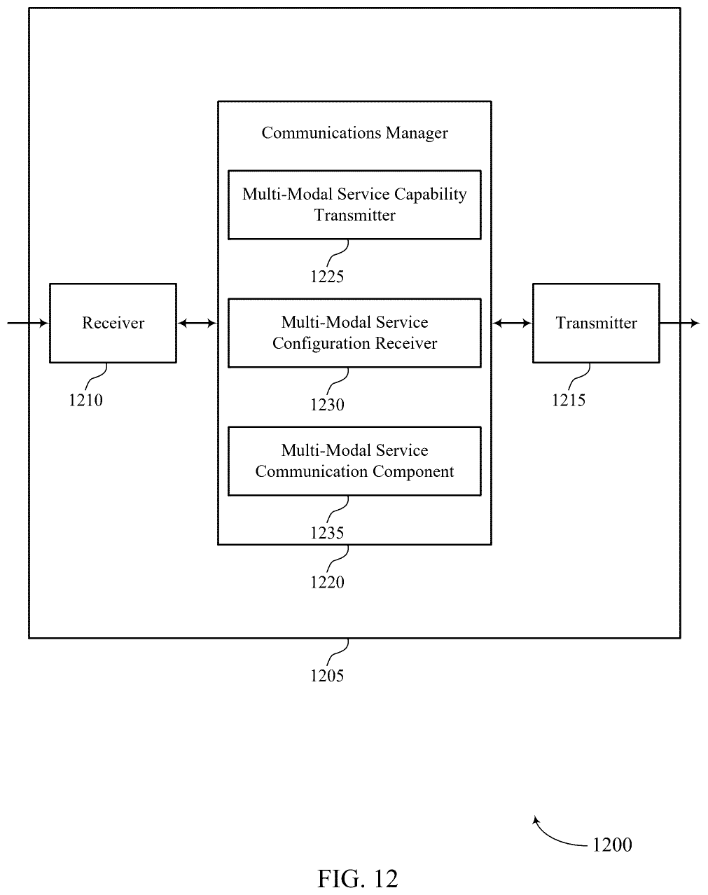

FIG. 12 shows a block diagram 1200 of a device 1205 that supports RAN techniques for multi-modal services in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of RAN techniques for multi-modal services as described herein. For example, the communications manager 1220 may include a multi-modal service capability transmitter 1225, a multi-modal service configuration receiver 1230, a multi-modal service communication component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The multi-modal service capability transmitter 1225 is capable of, configured to, or operable to support a means for sending, via a first interface between the first network entity and a second network entity, a first message indicating a capability of the first network entity to support one or more multi-modal services associated with two or more data traffic flows, the one or more multi-modal services being associated with one or more UEs, where the one or more multi-modal services support applications enabling input from a set of multiple sources. The multi-modal service configuration receiver 1230 is capable of, configured to, or operable to support a means for receiving, via the first interface, a second message indicating a configuration of at least one multi-modal service of the one or more multi-modal services that is associated with at least one data traffic flow of the one or more data traffic flows, the configuration of the at least one multi-modal service including a multi-modal service identifier associated with the at least one multi-modal service. The multi-modal service communication component 1235 is capable of, configured to, or operable to support a means for communicating, with the one or more UEs, in accordance with the one or more multi-modal services.

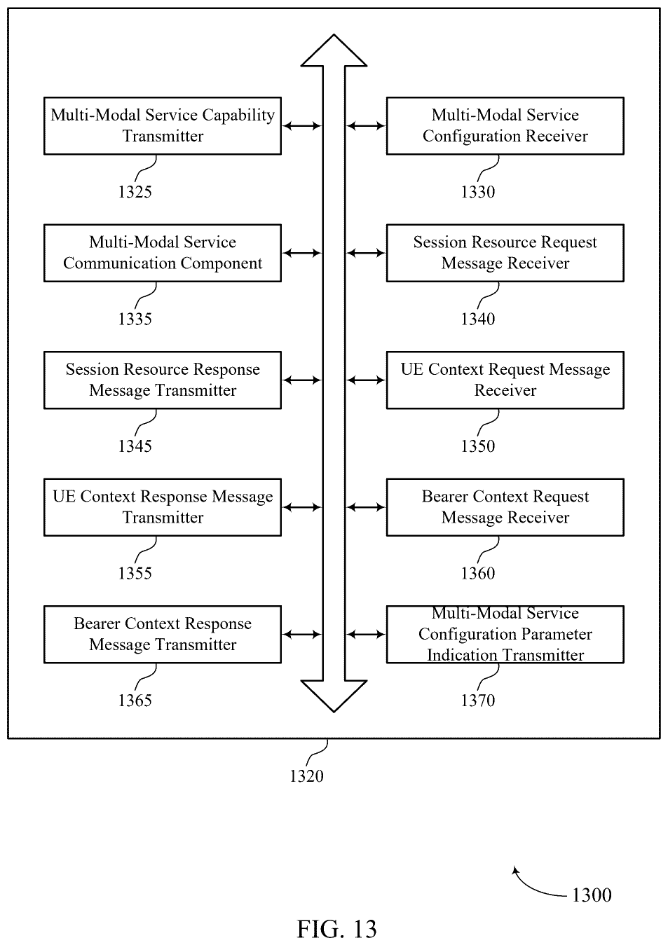

FIG. 13 shows a block diagram 1300 of a communications manager 1320 that supports RAN techniques for multi-modal services in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of RAN techniques for multi-modal services as described herein. For example, the communications manager 1320 may include a multi-modal service capability transmitter 1325, a multi-modal service configuration receiver 1330, a multi-modal service communication component 1335, a session resource request message receiver 1340, a session resource response message transmitter 1345, a UE context request message receiver 1350, a UE context response message transmitter 1355, a bearer context request message receiver 1360, a bearer context response message transmitter 1365, a multi-modal service configuration parameter indication transmitter 1370, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The multi-modal service capability transmitter 1325 is capable of, configured to, or operable to support a means for sending, via a first interface between the first network entity and a second network entity, a first message indicating a capability of the first network entity to support one or more multi-modal services associated with two or more data traffic flows, the one or more multi-modal services being associated with one or more UEs, where the one or more multi-modal services support applications enabling input from a set of multiple sources. The multi-modal service configuration receiver 1330 is capable of, configured to, or operable to support a means for receiving, via the first interface, a second message indicating a configuration of at least one multi-modal service of the one or more multi-modal services that is associated with at least one data traffic flow of the one or more data traffic flows, the configuration of the at least one multi-modal service including a multi-modal service identifier associated with the at least one multi-modal service. The multi-modal service communication component 1335 is capable of, configured to, or operable to support a means for communicating, with the one or more UEs, in accordance with the one or more multi-modal services.

In some examples, to support sending the first message, the multi-modal service capability transmitter 1325 is capable of, configured to, or operable to support a means for sending a setup request message via the first interface between the first network entity and the second network entity, the setup request message including an indication of the capability of the first network entity to support the one or more multi-modal services, where the setup request message includes the first message.

In some examples, to support sending the first message, the multi-modal service capability transmitter 1325 is capable of, configured to, or operable to support a means for outputting a configuration update message via the first interface between the first network entity and the second network entity, the configuration update message including an indication of the capability of the first network entity to support the one or more multi-modal services, where the configuration update message includes the first message.

In some examples, to support sending the first message, the multi-modal service capability transmitter 1325 is capable of, configured to, or operable to support a means for sending, via the first interface between the first network entity and the second network entity, a path switch request message that includes an indication of the capability of the first network entity to support the one or more multi-modal services, where the path switch request message includes the first message.

In some examples, the session resource request message receiver 1340 is capable of, configured to, or operable to support a means for receiving, from the second network entity via the first interface, a first session resource request message, where sending the first message includes sending, to the second network entity via the first interface, a first session resource response message in response to the first session resource request message, the first session resource response message including an indication of the capability of the first network entity to support the one or more multi-modal services, where the first session resource response message includes the first message. In some examples, the session resource response message transmitter 1345 is capable of, configured to, or operable to support a means for sending, to the second network entity via the first interface, a first session resource response message in response to the first session resource request message, the first session resource response message including an indication of the capability of the first network entity to support the one or more multi-modal services, where the first session resource response message includes the first message.

In some examples, the first session resource request message is a session resource setup request message or a session resource modification request message, and the first session resource response message is a session resource setup response message or a session resource modification response message.

In some examples, the UE context request message receiver 1350 is capable of, configured to, or operable to support a means for receiving, from the second network entity via the first interface, a first UE context request message, where sending the first message includes sending, to the second network entity via the first interface, a first UE context response message in response to the first UE context request message, the first UE context response message including an indication of the capability of the first network entity to support the one or more multi-modal services, where the first UE context response message includes the first message. In some examples, the UE context response message transmitter 1355 is capable of, configured to, or operable to support a means for sending, to the second network entity via the first interface, a first UE context response message in response to the first UE context request message, the first UE context response message including an indication of the capability of the first network entity to support the one or more multi-modal services, where the first UE context response message includes the first message.

In some examples, the first UE context request message is a UE context setup request message or a UE context modification request message, and the first UE context response message is a UE context setup response message or a UE context modification response message.

In some examples, the bearer context request message receiver 1360 is capable of, configured to, or operable to support a means for receiving, from the second network entity via the first interface, a first bearer context request message, where sending the first message includes sending, to the second network entity via the first interface, a first bearer context response message in response to the first bearer context request message, the first bearer context response message including an indication of the capability of the first network entity to support the one or more multi-modal services, where the first bearer context response message includes the first message. In some examples, the bearer context response message transmitter 1365 is capable of, configured to, or operable to support a means for sending, to the second network entity via the first interface, a first bearer context response message in response to the first bearer context request message, the first bearer context response message including an indication of the capability of the first network entity to support the one or more multi-modal services, where the first bearer context response message includes the first message.

In some examples, the first bearer context request message is a bearer context setup request message or a bearer context modification request message, and the first bearer context response message is a bearer context setup response message or a bearer context modification response message.

In some examples, to support sending the first message, the multi-modal service capability transmitter 1325 is capable of, configured to, or operable to support a means for sending, via the first message, a first indication of a maximum quantity of intra-UE multi-modal services that the first network entity is capable of supporting, a second indication of a maximum quantity of inter-UE multi-modal services that the first network entity is capable of supporting, a third indication of a maximum quantity of data traffic flows that the first network entity is capable of supporting for a respective multi-modal service, a fourth indication of a maximum quantity of data traffic flows that the first network entity is capable of supporting for the one or more multi-modal services, or a combination thereof.

In some examples, to support receiving the second message, the multi-modal service configuration receiver 1330 is capable of, configured to, or operable to support a means for receiving, via the first interface, two or more data traffic flow configuration messages indicating information associated with a respective data traffic flow of the two or more data traffic flows, the configuration of the at least one multi-modal service being associated with the two or more data traffic flow configuration messages, where the two or more data traffic flow configuration messages and the configuration of the at least one multi-modal service are outputted separately.

In some examples, to support receiving the second message, the multi-modal service configuration receiver 1330 is capable of, configured to, or operable to support a means for receiving, via the first interface, two or more traffic flow configuration messages indicating information associated with a respective traffic flow of the two or more data traffic flows, the two or more traffic flow configuration messages including the configuration of the at least one multi-modal service, where the two or more traffic flow configuration messages are associated with the multi-modal service identifier that is associated with the at least one multi-modal service.

In some examples, the second message includes a PDU session resource setup request message, a PDU session resource modify request message, a handover request message, a path switch request acknowledgment message, a retrieve UE context response message, a secondary node additional request message a secondary node modification request message, a secondary node modification required message, a bearer context setup request message, a bearer context modification request message, or any combination thereof.

In some examples, the multi-modal service configuration parameter indication transmitter 1370 is capable of, configured to, or operable to support a means for sending a third message including an indication that one or more parameters associated with the configuration of the at least one multi-modal service are not applied for the one or more multi-modal services, where the indication is based on the one or more parameters being incompatible with the capability of the first network entity.

In some examples, the indication that one or more parameters associated with the configuration are not applied includes a criticality diagnostics information element.

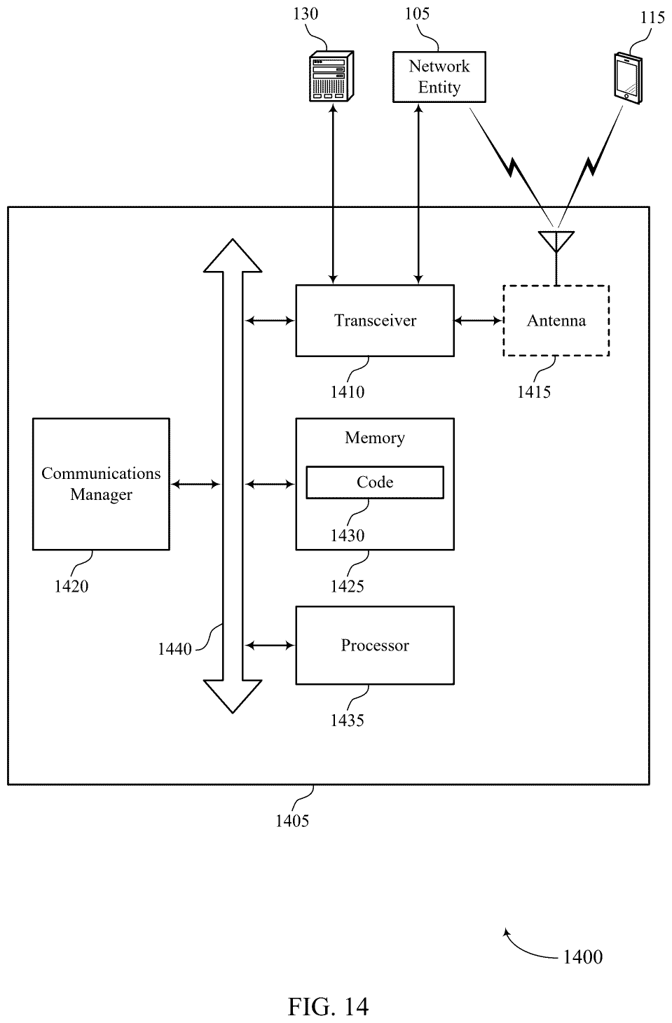

FIG. 14 shows a diagram of a system 1400 including a device 1405 that supports RAN techniques for multi-modal services in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting RAN techniques for multi-modal services). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for sending, via a first interface between the first network entity and a second network entity, a first message indicating a capability of the first network entity to support one or more multi-modal services associated with two or more data traffic flows, the one or more multi-modal services being associated with one or more UEs, where the one or more multi-modal services support applications enabling input from a set of multiple sources. The communications manager 1420 is capable of, configured to, or operable to support a means for receiving, via the first interface, a second message indicating a configuration of at least one multi-modal service of the one or more multi-modal services that is associated with at least one data traffic flow of the one or more data traffic flows, the configuration of the at least one multi-modal service including a multi-modal service identifier associated with the at least one multi-modal service. The communications manager 1420 is capable of, configured to, or operable to support a means for communicating, with the one or more UEs, in accordance with the one or more multi-modal services.

By including or configuring the communications manager 1420 in accordance with examples as described herein, the device 1405 may support techniques for a network entity to indicate support for multi-modal services and receive multi-modal service configurates to support improved communication reliability, reduced latency, improved user experience related to reduced processing, reduced power consumption, more efficient utilization of communication resources, improved coordination between devices, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of RAN techniques for multi-modal services as described herein, or the at least one processor 1435 and the at least one memory 1425 may be otherwise configured to, individually or collectively, perform or support such operations.

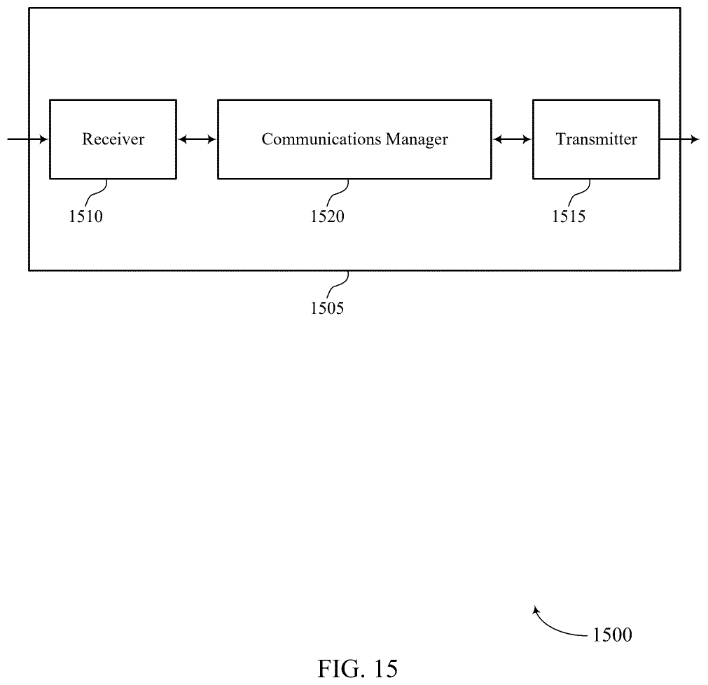

FIG. 15 shows a block diagram 1500 of a device 1505 that supports RAN techniques for multi-modal services in accordance with one or more aspects of the present disclosure. The device 1505 may be an example of aspects of a source network entity as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The communications manager 1520, the receiver 1510, the transmitter 1515, or various combinations or components thereof may be examples of means for performing various aspects of RAN techniques for multi-modal services as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. For example, the communications manager 1520 is capable of, configured to, or operable to support a means for sending, to a group of UEs that are associated with one or more data traffic flows of a multi-modal service, an indication of a set of candidate cells for handover evaluation. The communications manager 1520 is capable of, configured to, or operable to support a means for receiving, from a first UE of the group of UEs, a message indicating that the first UE has initiated a handover from the source network entity to a target network entity associated with a target candidate cell, where the set of candidate cells includes the target candidate cell. The communications manager 1520 is capable of, configured to, or operable to support a means for sending, to the group of UEs, a handover command message corresponding to the indication of the message from the first UE, the handover command message indicating for one or more UEs of the group of UEs to initiate a handover from the source network entity to the target network entity associated with the target candidate cell.

Additionally, or alternatively, the communications manager 1520 may support wireless communications in accordance with examples as disclosed herein. For example, the communications manager 1520 is capable of, configured to, or operable to support a means for sending, to a group of UEs that are associated with two or more data traffic flows of a multi-modal service, an indication of a set of candidate cells for cell switching. The communications manager 1520 is capable of, configured to, or operable to support a means for receiving, from a first UE of the group of UEs, a measurement report of a target candidate cell from the set of candidate cells. The communications manager 1520 is capable of, configured to, or operable to support a means for sending, to one or more UEs of the group of UEs, a cell switch command indicating that the one or more UEs switch from a source cell associated with the source network entity to the target candidate cell associated with a target network entity, the cell switch command being based on the measurement report of the target candidate cell. The communications manager 1520 is capable of, configured to, or operable to support a means for sending, to the target network entity, a cell switch notification message, the cell switch notification message including one or more UE identifiers associated with the group of UEs that received the cell switch command, where the cell switch notification message is outputted based on obtaining the measurement report of the target candidate cell.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for a network entity to ensure UEs are supported by a common network entity, are within a common cell, or both, to support reduced processing, reduced power consumption, and more efficient utilization of communication resources.

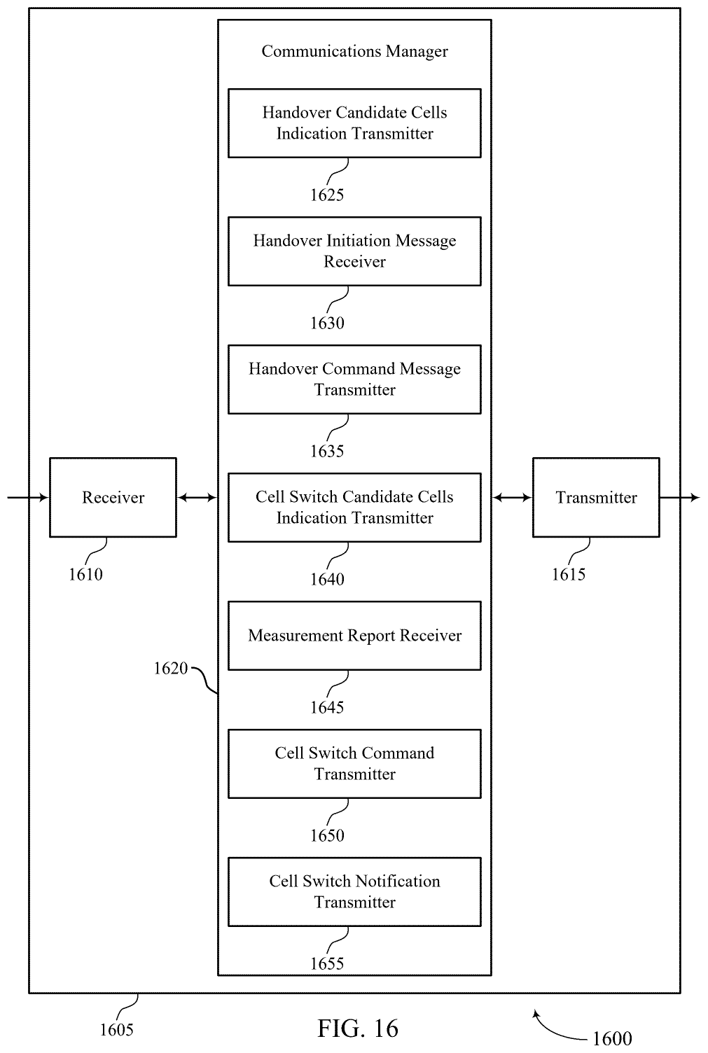

FIG. 16 shows a block diagram 1600 of a device 1605 that supports RAN techniques for multi-modal services in accordance with one or more aspects of the present disclosure. The device 1605 may be an example of aspects of a device 1505 or a source network entity 105 as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The device 1605, or various components thereof, may be an example of means for performing various aspects of RAN techniques for multi-modal services as described herein. For example, the communications manager 1620 may include a handover candidate cells indication transmitter 1625, a handover initiation message receiver 1630, a handover command message transmitter 1635, a cell switch candidate cells indication transmitter 1640, a measurement report receiver 1645, a cell switch command transmitter 1650, a cell switch notification transmitter 1655, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. The handover candidate cells indication transmitter 1625 is capable of, configured to, or operable to support a means for sending, to a group of UEs that are associated with one or more data traffic flows of a multi-modal service, an indication of a set of candidate cells for handover evaluation. The handover initiation message receiver 1630 is capable of, configured to, or operable to support a means for receiving, from a first UE of the group of UEs, a message indicating that the first UE has initiated a handover from the source network entity to a target network entity associated with a target candidate cell, where the set of candidate cells includes the target candidate cell. The handover command message transmitter 1635 is capable of, configured to, or operable to support a means for sending, to the group of UEs, a handover command message corresponding to the indication of the message from the first UE, the handover command message indicating for one or more UEs of the group of UEs to initiate a handover from the source network entity to the target network entity associated with the target candidate cell.

Additionally, or alternatively, the communications manager 1620 may support wireless communications in accordance with examples as disclosed herein. The cell switch candidate cells indication transmitter 1640 is capable of, configured to, or operable to support a means for sending, to a group of UEs that are associated with two or more data traffic flows of a multi-modal service, an indication of a set of candidate cells for cell switching. The measurement report receiver 1645 is capable of, configured to, or operable to support a means for receiving, from a first UE of the group of UEs, a measurement report of a target candidate cell from the set of candidate cells. The cell switch command transmitter 1650 is capable of, configured to, or operable to support a means for sending, to one or more UEs of the group of UEs, a cell switch command indicating that the one or more UEs switch from a source cell associated with the source network entity to the target candidate cell associated with a target network entity, the cell switch command being based on the measurement report of the target candidate cell. The cell switch notification transmitter 1655 is capable of, configured to, or operable to support a means for sending, to the target network entity, a cell switch notification message, the cell switch notification message including one or more UE identifiers associated with the group of UEs that received the cell switch command, where the cell switch notification message is outputted based on obtaining the measurement report of the target candidate cell.

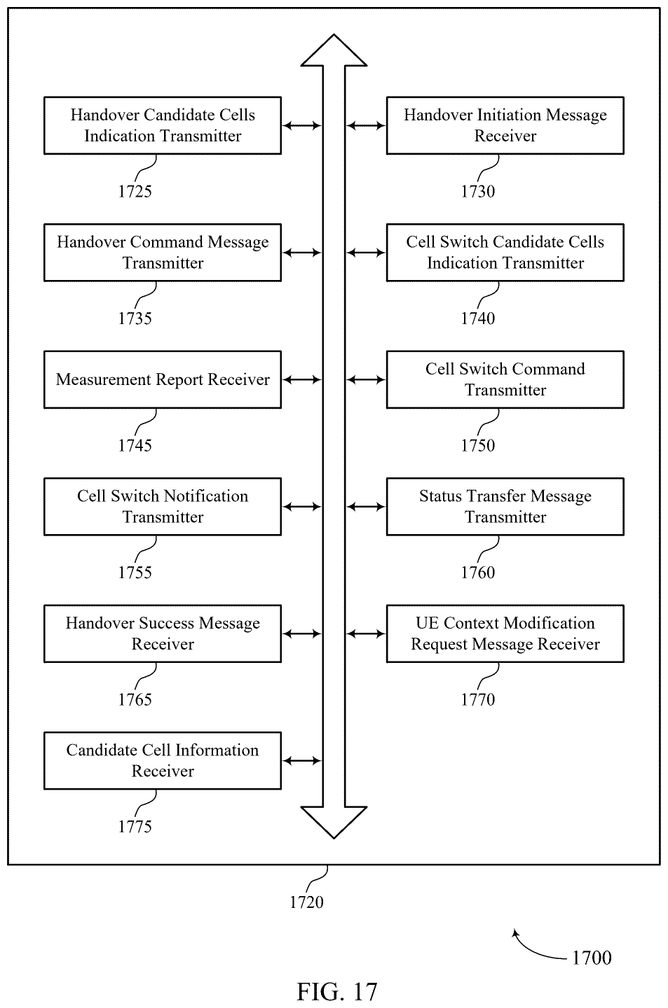

FIG. 17 shows a block diagram 1700 of a communications manager 1720 that supports RAN techniques for multi-modal services in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of RAN techniques for multi-modal services as described herein. For example, the communications manager 1720 may include a handover candidate cells indication transmitter 1725, a handover initiation message receiver 1730, a handover command message transmitter 1735, a cell switch candidate cells indication transmitter 1740, a measurement report receiver 1745, a cell switch command transmitter 1750, a cell switch notification transmitter 1755, a status transfer message transmitter 1760, a handover success message receiver 1765, a UE context modification request message receiver 1770, a candidate cell information receiver 1775, or any combination thereof. Each of these components, or components or subcomponents thereof (e.g., one or more processors, one or more memories), may communicate, directly or indirectly, with one another (e.g., via one or more buses).

The communications manager 1720 may support wireless communications in accordance with examples as disclosed herein. The handover candidate cells indication transmitter 1725 is capable of, configured to, or operable to support a means for sending, to a group of UEs that are associated with one or more data traffic flows of a multi-modal service, an indication of a set of candidate cells for handover evaluation. The handover initiation message receiver 1730 is capable of, configured to, or operable to support a means for receiving, from a first UE of the group of UEs, a message indicating that the first UE has initiated a handover from the source network entity to a target network entity associated with a target candidate cell, where the set of candidate cells includes the target candidate cell. The handover command message transmitter 1735 is capable of, configured to, or operable to support a means for sending, to the group of UEs, a handover command message corresponding to the indication of the message from the first UE, the handover command message indicating for one or more UEs of the group of UEs to initiate a handover from the source network entity to the target network entity associated with the target candidate cell.

In some examples, the measurement report receiver 1745 is capable of, configured to, or operable to support a means for receiving, from the first UE of the group of UEs, a measurement report associated with the target candidate cell, where the message indicating that the first UE has initiated the handover from the source network entity to the target network entity associated with the target candidate cell is based on the measurement report.

In some examples, the status transfer message transmitter 1760 is capable of, configured to, or operable to support a means for sending, to the target network entity associated with the target candidate cell, one or more early status transfer messages associated with the group of UEs, where the one or more early status transfer messages are outputted prior to receiving the message indicating that the first UE has initiated the handover.

In some examples, at least one of the one or more early status transfer messages is a common early status transfer message that is common to at least two or more UEs of the group of UEs.

In some examples, the handover success message receiver 1765 is capable of, configured to, or operable to support a means for receiving, from the target network entity associated with the target candidate cell, one or more handover success messages indicating that the one or more UEs of the group of UEs have successfully performed the handover from the source network entity to the target network entity associated with the target candidate cell, where the one or more handover success messages are associated with the one or more UEs indicated to handover to the target network entity via the handover command message.

In some examples, at least one of the one or more handover success messages is a common handover success transfer message that is common to at least two or more UEs of the group of UEs.

In some examples, the message indicating that the first UE has initiated the handover from the source network entity to the target network entity, the handover command message, or both include a cell identifier associated with the target candidate cell.

Additionally, or alternatively, the communications manager 1720 may support wireless communications in accordance with examples as disclosed herein. The cell switch candidate cells indication transmitter 1740 is capable of, configured to, or operable to support a means for sending, to a group of UEs that are associated with two or more data traffic flows of a multi-modal service, an indication of a set of candidate cells for cell switching. The measurement report receiver 1745 is capable of, configured to, or operable to support a means for receiving, from a first UE of the group of UEs, a measurement report of a target candidate cell from the set of candidate cells. The cell switch command transmitter 1750 is capable of, configured to, or operable to support a means for sending, to one or more UEs of the group of UEs, a cell switch command indicating that the one or more UEs switch from a source cell associated with the source network entity to the target candidate cell associated with a target network entity, the cell switch command being based on the measurement report of the target candidate cell. The cell switch notification transmitter 1755 is capable of, configured to, or operable to support a means for sending, to the target network entity, a cell switch notification message, the cell switch notification message including one or more UE identifiers associated with the group of UEs that received the cell switch command, where the cell switch notification message is outputted based on obtaining the measurement report of the target candidate cell.

In some examples, the UE context modification request message receiver 1770 is capable of, configured to, or operable to support a means for receiving one or more UE context modification request messages that are associated with the group of UEs, where the indication of the set of candidate cells for the cell switching is sent to the group of UEs based on receiving the one or more UE context modification request messages.

In some examples, to support receiving the one or more UE context modification request messages, the UE context modification request message receiver 1770 is capable of, configured to, or operable to support a means for receiving a common UE context modification request message that is associated with at least two or more UEs of the group of UEs, where the indication of the set of candidate cells for the cell switching is sent to the group of UEs based on receiving the common UE context modification request message.

In some examples, to support sending the cell switch notification message, the cell switch notification transmitter 1755 is capable of, configured to, or operable to support a means for sending, to the target network entity, a common cell switch notification message that is associated with two or more UEs of the group of UEs.

In some examples, to support sending the cell switch notification message, the cell switch notification transmitter 1755 is capable of, configured to, or operable to support a means for sending, to the target network entity, one or more cell switch notification messages that each include a first parameter that indicates the one or more UE identifiers associated with the one or more UEs of the group of UEs that received the cell switch command based on the one or more UEs being associated with the multi-modal service.

In some examples, the candidate cell information receiver 1775 is capable of, configured to, or operable to support a means for receiving one or more messages that indicates information associated with the set of candidate cells, where the indication of the set of candidate cells for the cell switching is sent to the group of UEs based on receiving the information associated with the set of candidate cells.

In some examples, a completion of a cell switch for the group of UEs from the source cell to the target candidate cell is based on one or more access success messages.

In some examples, at least one of the one or more access success messages includes a common access success message that is common to at least two or more UEs of the group of UEs.

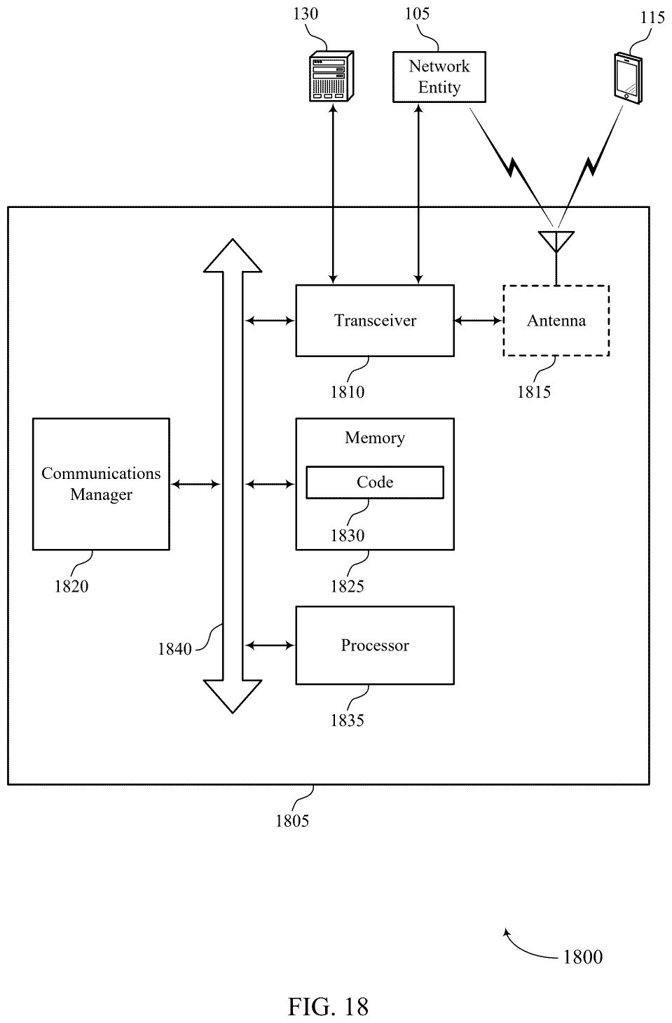

FIG. 18 shows a diagram of a system 1800 including a device 1805 that supports RAN techniques for multi-modal services in accordance with one or more aspects of the present disclosure. The device 1805 may be an example of or include components of a device 1505, a device 1605, or a source network entity as described herein. The device 1805 may include components for bi-directional voice and data communications including components for transmitting and receiving communications, such as a communications manager 1820, a transceiver 1810, one or more antennas 1815, at least one memory 1825, code 1830, and at least one processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or one or more memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or one or more memory components (e.g., the at least one processor 1835, the at least one memory 1825, or both), may be included in a chip or chip assembly that is installed in the device 1805. In some examples, the transceiver 1810 may be operable to support communications via one or more communications links (e.g., communication link(s) 125, backhaul communication link(s) 120, a midhaul communication link 162, a fronthaul communication link 168).

The at least one memory 1825 may include RAM, ROM, or any combination thereof. The at least one memory 1825 may store computer-readable, computer-executable, or processor-executable code, such as the code 1830. The code 1830 may include instructions that, when executed by one or more of the at least one processor 1835, cause the device 1805 to perform various functions described herein. The code 1830 may be stored in a non-transitory computer-readable medium such as system memory or another type of memory. In some cases, the code 1830 may not be directly executable by a processor of the at least one processor 1835 but may cause a computer (e.g., when compiled and executed) to perform functions described herein. In some cases, the at least one memory 1825 may include, among other things, a BIOS which may control basic hardware or software operation such as the interaction with peripheral components or devices. In some examples, the at least one processor 1835 may include multiple processors and the at least one memory 1825 may include multiple memories. One or more of the multiple processors may be coupled with one or more of the multiple memories which may, individually or collectively, be configured to perform various functions herein (for example, as part of a processing system).

The at least one processor 1835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1835 may be configured to operate a memory array using a memory controller. In some other cases, a memory controller may be integrated into one or more of the at least one processor 1835. The at least one processor 1835 may be configured to execute computer-readable instructions stored in a memory (e.g., one or more of the at least one memory 1825) to cause the device 1805 to perform various functions (e.g., functions or tasks supporting RAN techniques for multi-modal services). For example, the device 1805 or a component of the device 1805 may include at least one processor 1835 and at least one memory 1825 coupled with one or more of the at least one processor 1835, the at least one processor 1835 and the at least one memory 1825 configured to perform various functions described herein. The at least one processor 1835 may be an example of a cloud-computing platform (e.g., one or more physical nodes and supporting software such as operating systems, virtual machines, or container instances) that may host the functions (e.g., by executing code 1830) to perform the functions of the device 1805. The at least one processor 1835 may be any one or more suitable processors capable of executing scripts or instructions of one or more software programs stored in the device 1805 (such as within one or more of the at least one memory 1825).

In some examples, the at least one processor 1835 may include multiple processors and the at least one memory 1825 may include multiple memories. One or more of the multiple processors may be coupled with one or more of the multiple memories, which may, individually or collectively, be configured to perform various functions herein. In some examples, the at least one processor 1835 may be a component of a processing system, which may refer to a system (such as a series) of machines, circuitry (including, for example, one or both of processor circuitry (which may include the at least one processor 1835) and memory circuitry (which may include the at least one memory 1825)), or components, that receives or obtains inputs and processes the inputs to produce, generate, or obtain a set of outputs. The processing system may be configured to perform one or more of the functions described herein. For example, the at least one processor 1835 or a processing system including the at least one processor 1835 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code stored in the at least one memory 1825 or otherwise, to perform one or more of the functions described herein.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the at least one memory 1825, the code 1830, and the at least one processor 1835 may be located in one of the different components or divided between different components).

In some examples, the communications manager 1820 may manage aspects of communications with a core network 130 (e.g., via one or more wired or wireless backhaul links). For example, the communications manager 1820 may manage the transfer of data communications for client devices, such as one or more UEs 115. In some examples, the communications manager 1820 may manage communications with one or more other network entities 105, and may include a controller or scheduler for controlling communications with UEs 115 (e.g., in cooperation with the one or more other network devices). In some examples, the communications manager 1820 may support an X2 interface within an LTE/LTE-A wireless communications network technology to provide communication between network entities 105.

The communications manager 1820 may support wireless communications in accordance with examples as disclosed herein. For example, the communications manager 1820 is capable of, configured to, or operable to support a means for sending, to a group of UEs that are associated with one or more data traffic flows of a multi-modal service, an indication of a set of candidate cells for handover evaluation. The communications manager 1820 is capable of, configured to, or operable to support a means for receiving, from a first UE of the group of UEs, a message indicating that the first UE has initiated a handover from the source network entity to a target network entity associated with a target candidate cell, where the set of candidate cells includes the target candidate cell. The communications manager 1820 is capable of, configured to, or operable to support a means for sending, to the group of UEs, a handover command message corresponding to the indication of the message from the first UE, the handover command message indicating for one or more UEs of the group of UEs to initiate a handover from the source network entity to the target network entity associated with the target candidate cell.

Additionally, or alternatively, the communications manager 1820 may support wireless communications in accordance with examples as disclosed herein. For example, the communications manager 1820 is capable of, configured to, or operable to support a means for sending, to a group of UEs that are associated with two or more data traffic flows of a multi-modal service, an indication of a set of candidate cells for cell switching. The communications manager 1820 is capable of, configured to, or operable to support a means for receiving, from a first UE of the group of UEs, a measurement report of a target candidate cell from the set of candidate cells. The communications manager 1820 is capable of, configured to, or operable to support a means for sending, to one or more UEs of the group of UEs, a cell switch command indicating that the one or more UEs switch from a source cell associated with the source network entity to the target candidate cell associated with a target network entity, the cell switch command being based on the measurement report of the target candidate cell. The communications manager 1820 is capable of, configured to, or operable to support a means for sending, to the target network entity, a cell switch notification message, the cell switch notification message including one or more UE identifiers associated with the group of UEs that received the cell switch command, where the cell switch notification message is outputted based on obtaining the measurement report of the target candidate cell.

By including or configuring the communications manager 1820 in accordance with examples as described herein, the device 1805 may support techniques for a network entity to ensure UEs are supported by a common network entity, are within a common cell, or both, to support improved communication reliability, reduced latency, improved user experience related to reduced processing, reduced power consumption, more efficient utilization of communication resources, improved coordination between devices, and improved utilization of processing capability.

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the transceiver 1810, one or more of the at least one processor 1835, one or more of the at least one memory 1825, the code 1830, or any combination thereof (for example, by a processing system including at least a portion of the at least one processor 1835, the at least one memory 1825, the code 1830, or any combination thereof). For example, the code 1830 may include instructions executable by one or more of the at least one processor 1835 to cause the device 1805 to perform various aspects of RAN techniques for multi-modal services as described herein, or the at least one processor 1835 and the at least one memory 1825 may be otherwise configured to, individually or collectively, perform or support such operations.

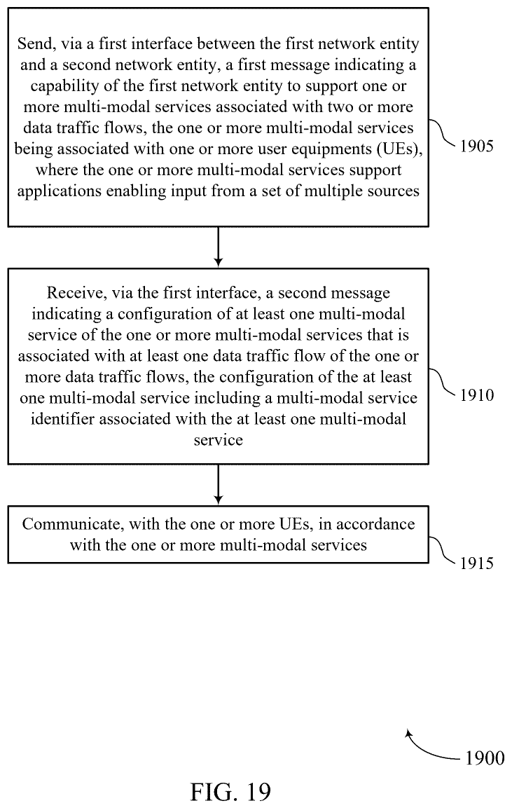

FIG. 19 shows a flowchart illustrating a method 1900 that supports RAN techniques for multi-modal services in accordance with one or more aspects of the present disclosure. The operations of the method 1900 may be implemented by a network entity or its components as described herein. For example, the operations of the method 1900 may be performed by a network entity as described with reference to FIGS. 1 through 14. In some examples, a network entity may execute a set of instructions to control the functional elements of the network entity to perform the described functions. Additionally, or alternatively, the network entity may perform aspects of the described functions using special-purpose hardware.

At 1905, the method may include sending, via a first interface between the first network entity and a second network entity, a first message indicating a capability of the first network entity to support one or more multi-modal services associated with two or more data traffic flows, the one or more multi-modal services being associated with one or more UEs, where the one or more multi-modal services support applications enabling input from a set of multiple sources. The operations of 1905 may be performed in accordance with examples as disclosed herein. In some examples, aspects of the operations of 1905 may be performed by a multi-modal service capability transmitter 1325 as described with reference to FIG. 13.

At 1910, the method may include receiving, via the first interface, a second message indicating a configuration of at least one multi-modal service of the one or more multi-modal services that is associated with at least one data traffic flow of the one or more data traffic flows, the configuration of the at least one multi-modal service including a multi-modal service identifier associated with the at least one multi-modal service. The operations of 1910 may be performed in accordance with examples as disclosed herein. In some examples, aspects of the operations of 1910 may be performed by a multi-modal service configuration receiver 1330 as described with reference to FIG. 13.

At 1915, the method may include communicating, with the one or more UEs, in accordance with the one or more multi-modal services. The operations of 1915 may be performed in accordance with examples as disclosed herein. In some examples, aspects of the operations of 1915 may be performed by a multi-modal service communication component 1335 as described with reference to FIG. 13.

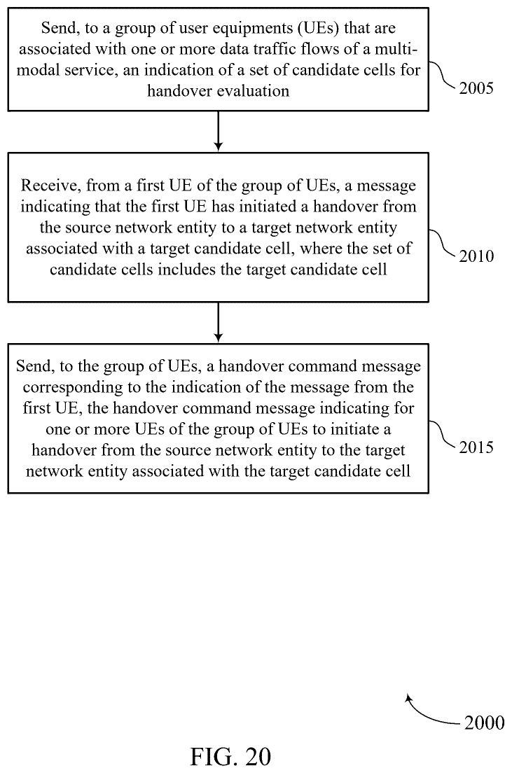

FIG. 20 shows a flowchart illustrating a method 2000 that supports RAN techniques for multi-modal services in accordance with one or more aspects of the present disclosure. The operations of the method 2000 may be implemented by a source network entity or its components as described herein. For example, the operations of the method 2000 may be performed by a source network entity as described with reference to FIGS. 1 through 10 and 15 through 18. In some examples, a source network entity may execute a set of instructions to control the functional elements of the source network entity to perform the described functions. Additionally, or alternatively, the source network entity may perform aspects of the described functions using special-purpose hardware.

At 2005, the method may include sending, to a group of UEs that are associated with one or more data traffic flows of a multi-modal service, an indication of a set of candidate cells for handover evaluation. The operations of 2005 may be performed in accordance with examples as disclosed herein. In some examples, aspects of the operations of 2005 may be performed by a handover candidate cells indication transmitter 1725 as described with reference to FIG. 17.

At 2010, the method may include receiving, from a first UE of the group of UEs, a message indicating that the first UE has initiated a handover from the source network entity to a target network entity associated with a target candidate cell, where the set of candidate cells includes the target candidate cell. The operations of 2010 may be performed in accordance with examples as disclosed herein. In some examples, aspects of the operations of 2010 may be performed by a handover initiation message receiver 1730 as described with reference to FIG. 17.

At 2015, the method may include sending, to the group of UEs, a handover command message corresponding to the indication of the message from the first UE, the handover command message indicating for one or more UEs of the group of UEs to initiate a handover from the source network entity to the target network entity associated with the target candidate cell. The operations of 2015 may be performed in accordance with examples as disclosed herein. In some examples, aspects of the operations of 2015 may be performed by a handover command message transmitter 1735 as described with reference to FIG. 17.

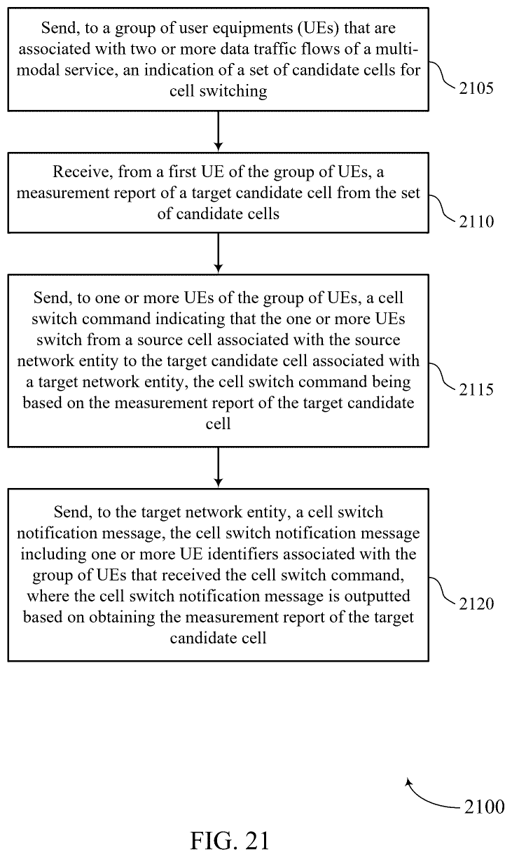

FIG. 21 shows a flowchart illustrating a method 2100 that supports RAN techniques for multi-modal services in accordance with one or more aspects of the present disclosure. The operations of the method 2100 may be implemented by a source network entity or its components as described herein. For example, the operations of the method 2100 may be performed by a source network entity as described with reference to FIGS. 1 through 10 and 15 through 18. In some examples, a source network entity may execute a set of instructions to control the functional elements of the source network entity to perform the described functions. Additionally, or alternatively, the source network entity may perform aspects of the described functions using special-purpose hardware.

At 2105, the method may include sending, to a group of UEs that are associated with two or more data traffic flows of a multi-modal service, an indication of a set of candidate cells for cell switching. The operations of 2105 may be performed in accordance with examples as disclosed herein. In some examples, aspects of the operations of 2105 may be performed by a cell switch candidate cells indication transmitter 1740 as described with reference to FIG. 17.

At 2110, the method may include receiving, from a first UE of the group of UEs, a measurement report of a target candidate cell from the set of candidate cells. The operations of 2110 may be performed in accordance with examples as disclosed herein. In some examples, aspects of the operations of 2110 may be performed by a measurement report receiver 1745 as described with reference to FIG. 17.

At 2115, the method may include sending, to one or more UEs of the group of UEs, a cell switch command indicating that the one or more UEs switch from a source cell associated with the source network entity to the target candidate cell associated with a target network entity, the cell switch command being based on the measurement report of the target candidate cell. The operations of 2115 may be performed in accordance with examples as disclosed herein. In some examples, aspects of the operations of 2115 may be performed by a cell switch command transmitter 1750 as described with reference to FIG. 17.

At 2120, the method may include sending, to the target network entity, a cell switch notification message, the cell switch notification message including one or more UE identifiers associated with the group of UEs that received the cell switch command, where the cell switch notification message is outputted based on obtaining the measurement report of the target candidate cell. The operations of 2120 may be performed in accordance with examples as disclosed herein. In some examples, aspects of the operations of 2120 may be performed by a cell switch notification transmitter 1755 as described with reference to FIG. 17.

The following provides an overview of aspects of the present disclosure:

Aspect 1: A method for wireless communications by a first network entity, comprising: sending, via a first interface between the first network entity and a second network entity, a first message indicating a capability of the first network entity to support one or more multi-modal services associated with two or more data traffic flows, the one or more multi-modal services being associated with one or more UEs, wherein the one or more multi-modal services support applications enabling input from a plurality of sources; receiving, via the first interface, a second message indicating a configuration of at least one multi-modal service of the one or more multi-modal services that is associated with at least one data traffic flow of the one or more data traffic flows, the configuration of the at least one multi-modal service comprising a multi-modal service identifier associated with the at least one multi-modal service; and communicating, with the one or more UEs, in accordance with the one or more multi-modal services.

Aspect 2: The method of aspect 1, wherein sending the first message comprises: sending a setup request message via the first interface between the first network entity and the second network entity, the setup request message comprising an indication of the capability of the first network entity to support the one or more multi-modal services, wherein the setup request message comprises the first message.

Aspect 3: The method of aspect 1, wherein sending the first message comprises: outputting a configuration update message via the first interface between the first network entity and the second network entity, the configuration update message comprising an indication of the capability of the first network entity to support the one or more multi-modal services, wherein the configuration update message comprises the first message.

Aspect 4: The method of aspect 1, wherein sending the first message comprises: sending, via the first interface between the first network entity and the second network entity, a path switch request message that comprises an indication of the capability of the first network entity to support the one or more multi-modal services, wherein the path switch request message comprises the first message.

Aspect 5: The method of aspect 1, further comprising: receiving, from the second network entity via the first interface, a first session resource request message, wherein sending the first message comprises: sending, to the second network entity via the first interface, a first session resource response message in response to the first session resource request message, the first session resource response message comprising an indication of the capability of the first network entity to support the one or more multi-modal services, wherein the first session resource response message comprises the first message.

Aspect 6: The method of aspect 5, wherein the first session resource request message is a session resource setup request message or a session resource modification request message, and the first session resource response message is a session resource setup response message or a session resource modification response message.

Aspect 7: The method of aspect 1, further comprising: receiving, from the second network entity via the first interface, a first UE context request message, wherein sending the first message comprises: sending, to the second network entity via the first interface, a first UE context response message in response to the first UE context request message, the first UE context response message comprising an indication of the capability of the first network entity to support the one or more multi-modal services, wherein the first UE context response message comprises the first message.

Aspect 8: The method of aspect 7, wherein the first UE context request message is a UE context setup request message or a UE context modification request message, and the first UE context response message is a UE context setup response message or a UE context modification response message.

Aspect 9: The method of aspect 1, further comprising: receiving, from the second network entity via the first interface, a first bearer context request message, wherein sending the first message comprises: sending, to the second network entity via the first interface, a first bearer context response message in response to the first bearer context request message, the first bearer context response message comprising an indication of the capability of the first network entity to support the one or more multi-modal services, wherein the first bearer context response message comprises the first message.

Aspect 10: The method of aspect 9, wherein the first bearer context request message is a bearer context setup request message or a bearer context modification request message, and the first bearer context response message is a bearer context setup response message or a bearer context modification response message.

Aspect 11: The method of any of aspects 1 through 10, wherein sending the first message comprises: sending, via the first message, a first indication of a maximum quantity of intra-UE multi-modal services that the first network entity is capable of supporting, a second indication of a maximum quantity of inter-UE multi-modal services that the first network entity is capable of supporting, a third indication of a maximum quantity of data traffic flows that the first network entity is capable of supporting for a respective multi-modal service, a fourth indication of a maximum quantity of data traffic flows that the first network entity is capable of supporting for the one or more multi-modal services, or a combination thereof.

Aspect 12: The method of any of aspects 1 through 11, wherein receiving the second message comprises: receiving, via the first interface, two or more data traffic flow configuration messages indicating information associated with a respective data traffic flow of the two or more data traffic flows, the configuration of the at least one multi-modal service being associated with the two or more data traffic flow configuration messages, wherein the two or more data traffic flow configuration messages and the configuration of the at least one multi-modal service are outputted separately.

Aspect 13: The method of any of aspects 1 through 11, wherein receiving the second message comprises: receiving, via the first interface, two or more traffic flow configuration messages indicating information associated with a respective traffic flow of the two or more data traffic flows, the two or more traffic flow configuration messages comprising the configuration of the at least one multi-modal service, wherein the two or more traffic flow configuration messages are associated with the multi-modal service identifier that is associated with the at least one multi-modal service.

Aspect 14: The method of any of aspects 1 through 13, wherein the second message comprises a PDU session resource setup request message, a PDU session resource modify request message, a handover request message, a path switch request acknowledgment message, a retrieve UE context response message, a secondary node additional request message a secondary node modification request message, a secondary node modification required message, a bearer context setup request message, a bearer context modification request message, or any combination thereof.

Aspect 15: The method of any of aspects 1 through 13, further comprising: sending a third message comprising an indication that one or more parameters associated with the configuration of the at least one multi-modal service are not applied for the one or more multi-modal services, wherein the indication is based at least in part on the one or more parameters being incompatible with the capability of the first network entity.

Aspect 16: The method of aspect 15, wherein the indication that one or more parameters associated with the configuration are not applied comprises a criticality diagnostics information element.

Aspect 17: A method for wireless communications by a source network entity, comprising: sending, to a group of UEs that are associated with one or more data traffic flows of a multi-modal service, an indication of a set of candidate cells for handover evaluation; receiving, from a first UE of the group of UEs, a message indicating that the first UE has initiated a handover from the source network entity to a target network entity associated with a target candidate cell, wherein the set of candidate cells comprises the target candidate cell; and sending, to the group of UEs, a handover command message corresponding to the indication of the message from the first UE, the handover command message indicating for one or more UEs of the group of UEs to initiate a handover from the source network entity to the target network entity associated with the target candidate cell.

Aspect 18: The method of aspect 17, further comprising: receiving, from the first UE of the group of UEs, a measurement report associated with the target candidate cell, wherein the message indicating that the first UE has initiated the handover from the source network entity to the target network entity associated with the target candidate cell is based at least in part on the measurement report.

Aspect 19: The method of any of aspects 17 through 18, further comprising: sending, to the target network entity associated with the target candidate cell, one or more early status transfer messages associated with the group of UEs, wherein the one or more early status transfer messages are outputted prior to receiving the message indicating that the first UE has initiated the handover.

Aspect 20: The method of aspect 19, wherein at least one of the one or more early status transfer messages is a common early status transfer message that is common to at least two or more UEs of the group of UEs.

Aspect 21: The method of any of aspects 17 through 20, further comprising: receiving, from the target network entity associated with the target candidate cell, one or more handover success messages indicating that the one or more UEs of the group of UEs have successfully performed the handover from the source network entity to the target network entity associated with the target candidate cell, wherein the one or more handover success messages are associated with the one or more UEs indicated to handover to the target network entity via the handover command message.

Aspect 22: The method of aspect 21, wherein at least one of the one or more handover success messages is a common handover success transfer message that is common to at least two or more UEs of the group of UEs.

Aspect 23: The method of any of aspects 17 through 22, wherein the message indicating that the first UE has initiated the handover from the source network entity to the target network entity, the handover command message, or both comprise a cell identifier associated with the target candidate cell.

Aspect 24: A method for wireless communications by a source network entity, comprising: sending, to a group of UEs that are associated with two or more data traffic flows of a multi-modal service, an indication of a set of candidate cells for cell switching; receiving, from a first UE of the group of UEs, a measurement report of a target candidate cell from the set of candidate cells; sending, to one or more UEs of the group of UEs, a cell switch command indicating that the one or more UEs switch from a source cell associated with the source network entity to the target candidate cell associated with a target network entity, the cell switch command being based at least in part on the measurement report of the target candidate cell; and sending, to the target network entity, a cell switch notification message, the cell switch notification message comprising one or more UE identifiers associated with the group of UEs that received the cell switch command, wherein the cell switch notification message is outputted based at least in part on obtaining the measurement report of the target candidate cell.

Aspect 25: The method of aspect 24, further comprising: receiving one or more UE context modification request messages that are associated with the group of UEs, wherein the indication of the set of candidate cells for the cell switching is sent to the group of UEs based at least in part on receiving the one or more UE context modification request messages.

Aspect 26: The method of aspect 25, wherein receiving the one or more UE context modification request messages comprises: receiving a common UE context modification request message that is associated with at least two or more UEs of the group of UEs, wherein the indication of the set of candidate cells for the cell switching is sent to the group of UEs based at least in part on receiving the common UE context modification request message.

Aspect 27: The method of any of aspects 24 through 26, wherein sending the cell switch notification message comprises: sending, to the target network entity, a common cell switch notification message that is associated with two or more UEs of the group of UEs.

Aspect 28: The method of any of aspects 24 through 27, wherein sending the cell switch notification message comprises: sending, to the target network entity, one or more cell switch notification messages that each include a first parameter that indicates the one or more UE identifiers associated with the one or more UEs of the group of UEs that received the cell switch command based at least in part on the one or more UEs being associated with the multi-modal service.

Aspect 29: The method of any of aspects 24 through 28, further comprising: receiving one or more messages that indicates information associated with the set of candidate cells, wherein the indication of the set of candidate cells for the cell switching is sent to the group of UEs based at least in part on receiving the information associated with the set of candidate cells.

Aspect 30: The method of any of aspects 24 through 29, wherein a completion of a cell switch for the group of UEs from the source cell to the target candidate cell is based at least in part on one or more access success messages.

Aspect 31: The method of aspect 30, wherein at least one of the one or more access success messages comprises a common access success message that is common to at least two or more UEs of the group of UEs.

Aspect 32: A first network entity for wireless communications, comprising one or more memories storing processor-executable code, and one or more processors coupled with the one or more memories and individually or collectively operable to execute the code to cause the first network entity to perform a method of any of aspects 1 through 16.

Aspect 33: A first network entity for wireless communications, comprising at least one means for performing a method of any of aspects 1 through 16.

Aspect 34: A non-transitory computer-readable medium storing code for wireless communications, the code comprising instructions executable by one or more processors to perform a method of any of aspects 1 through 16.

Aspect 35: A source network entity for wireless communications, comprising one or more memories storing processor-executable code, and one or more processors coupled with the one or more memories and individually or collectively operable to execute the code to cause the source network entity to perform a method of any of aspects 17 through 23.

Aspect 36: A source network entity for wireless communications, comprising at least one means for performing a method of any of aspects 17 through 23.

Aspect 37: A non-transitory computer-readable medium storing code for wireless communications, the code comprising instructions executable by one or more processors to perform a method of any of aspects 17 through 23.

Aspect 38: A source network entity for wireless communications, comprising one or more memories storing processor-executable code, and one or more processors coupled with the one or more memories and individually or collectively operable to execute the code to cause the source network entity to perform a method of any of aspects 24 through 31.

Aspect 39: A source network entity for wireless communications, comprising at least one means for performing a method of any of aspects 24 through 31.

Aspect 40: A non-transitory computer-readable medium storing code for wireless communications, the code comprising instructions executable by one or more processors to perform a method of any of aspects 24 through 31.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
one or more memories storing processor-executable code; and
one or more processors coupled with the one or more memories and individually or collectively operable to execute the code to cause the first network entity to:
send, via a first interface between the first network entity and a second network entity, a first message indicating a capability of the first network entity to support one or more multi-modal services associated with two or more data traffic flows, the one or more multi-modal services being associated with one or more user equipments (UEs), wherein the one or more multi-modal services support applications enabling input from a plurality of sources;
receive, via the first interface, a second message indicating a configuration of at least one multi-modal service of the one or more multi-modal services that is associated with at least one data traffic flow of the one or more data traffic flows, the configuration of the at least one multi-modal service comprising a multi-modal service identifier associated with the at least one multi-modal service; and
communicate, with the one or more UEs, in accordance with the one or more multi-modal services.

2. The first network entity of claim 1, wherein, to send the first message, the one or more processors are individually or collectively operable to execute the code to cause the first network entity to:
send a setup request message via the first interface between the first network entity and the second network entity, the setup request message comprising an indication of the capability of the first network entity to support the one or more multi-modal services, wherein the setup request message comprises the first message.

3. The first network entity of claim 1, wherein, to send the first message, the one or more processors are individually or collectively operable to execute the code to cause the first network entity to:
output a configuration update message via the first interface between the first network entity and the second network entity, the configuration update message comprising an indication of the capability of the first network entity to support the one or more multi-modal services, wherein the configuration update message comprises the first message.

4. The first network entity of claim 1, wherein, to send the first message, the one or more processors are individually or collectively operable to execute the code to cause the first network entity to:
send, via the first interface between the first network entity and the second network entity, a path switch request message that comprises an indication of the capability of the first network entity to support the one or more multi-modal services, wherein the path switch request message comprises the first message.

5. The first network entity of claim 1, wherein the one or more processors are individually or collectively further operable to execute the code to cause the first network entity to:
receive, from the second network entity via the first interface, a first session resource request message, wherein sending the first message comprises:
send, to the second network entity via the first interface, a first session resource response message in response to the first session resource request message, the first session resource response message comprising an indication of the capability of the first network entity to support the one or more multi-modal services, wherein the first session resource response message comprises the first message.

6. The first network entity of claim 1, wherein the one or more processors are individually or collectively further operable to execute the code to cause the first network entity to:
receive, from the second network entity via the first interface, a first UE context request message, wherein sending the first message comprises:
send, to the second network entity via the first interface, a first UE context response message in response to the first UE context request message, the first UE context response message comprising an indication of the capability of the first network entity to support the one or more multi-modal services, wherein the first UE context response message comprises the first message.

7. The first network entity of claim 1, wherein the one or more processors are individually or collectively further operable to execute the code to cause the first network entity to:
receive, from the second network entity via the first interface, a first bearer context request message, wherein sending the first message comprises:
send, to the second network entity via the first interface, a first bearer context response message in response to the first bearer context request message, the first bearer context response message comprising an indication of the capability of the first network entity to support the one or more multi-modal services, wherein the first bearer context response message comprises the first message.

8. The first network entity of claim 1, wherein, to send the first message, the one or more processors are individually or collectively operable to execute the code to cause the first network entity to:
send, via the first message, a first indication of a maximum quantity of intra-UE multi-modal services that the first network entity is capable of supporting, a second indication of a maximum quantity of inter-UE multi-modal services that the first network entity is capable of supporting, a third indication of a maximum quantity of data traffic flows that the first network entity is capable of supporting for a respective multi-modal service, a fourth indication of a maximum quantity of data traffic flows that the first network entity is capable of supporting for the one or more multi-modal services, or a combination thereof.

9. The first network entity of claim 1, wherein, to receive the second message, the one or more processors are individually or collectively operable to execute the code to cause the first network entity to:
receive, via the first interface, two or more data traffic flow configuration messages indicating information associated with a respective data traffic flow of the two or more data traffic flows, the configuration of the at least one multi-modal service being associated with the two or more data traffic flow configuration messages, wherein the two or more data traffic flow configuration messages and the configuration of the at least one multi-modal service are outputted separately.

10. The first network entity of claim 1, wherein, to receive the second message, the one or more processors are individually or collectively operable to execute the code to cause the first network entity to:
receive, via the first interface, two or more traffic flow configuration messages indicating information associated with a respective traffic flow of the two or more data traffic flows, the two or more traffic flow configuration messages comprising the configuration of the at least one multi-modal service, wherein the two or more traffic flow configuration messages are associated with the multi-modal service identifier that is associated with the at least one multi-modal service.

11. The first network entity of claim 1, wherein the second message comprises a packet data unit (PDU) session resource setup request message, a PDU session resource modify request message, a handover request message, a path switch request acknowledgment message, a retrieve UE context response message, a secondary node additional request message a secondary node modification request message, a secondary node modification required message, a bearer context setup request message, a bearer context modification request message, or any combination thereof.

12. The first network entity of claim 1, wherein the one or more processors are individually or collectively further operable to execute the code to cause the first network entity to:
send a third message comprising an indication that one or more parameters associated with the configuration of the at least one multi-modal service are not applied for the one or more multi-modal services, wherein the indication is based at least in part on the one or more parameters being incompatible with the capability of the first network entity.

13. A source network entity, comprising:
one or more memories storing processor-executable code; and
one or more processors coupled with the one or more memories and individually or collectively operable to execute the code to cause the source network entity to:
send, to a group of user equipments (UEs) that are associated with one or more data traffic flows of a multi-modal service, an indication of a set of candidate cells for handover evaluation;
receive, from a first UE of the group of UEs, a message indicating that the first UE has initiated a handover from the source network entity to a target network entity associated with a target candidate cell, wherein the set of candidate cells comprises the target candidate cell; and
send, to the group of UEs, a handover command message corresponding to the indication of the message from the first UE, the handover command message indicating for one or more UEs of the group of UEs to initiate a handover from the source network entity to the target network entity associated with the target candidate cell.

14. The source network entity of claim 13, wherein the one or more processors are individually or collectively further operable to execute the code to cause the source network entity to:
receive, from the first UE of the group of UEs, a measurement report associated with the target candidate cell, wherein the message indicating that the first UE has initiated the handover from the source network entity to the target network entity associated with the target candidate cell is based at least in part on the measurement report.

15. The source network entity of claim 13, wherein the one or more processors are individually or collectively further operable to execute the code to cause the source network entity to:
send, to the target network entity associated with the target candidate cell, one or more early status transfer messages associated with the group of UEs, wherein the one or more early status transfer messages are outputted prior to receiving the message indicating that the first UE has initiated the handover.

16. The source network entity of claim 13, wherein the one or more processors are individually or collectively further operable to execute the code to cause the source network entity to:
receive, from the target network entity associated with the target candidate cell, one or more handover success messages indicating that the one or more UEs of the group of UEs have successfully performed the handover from the source network entity to the target network entity associated with the target candidate cell, wherein the one or more handover success messages are associated with the one or more UEs indicated to handover to the target network entity via the handover command message.

17. A source network entity, comprising:
one or more memories storing processor-executable code; and
one or more processors coupled with the one or more memories and individually or collectively operable to execute the code to cause the source network entity to:
send, to a group of user equipments (UEs) that are associated with two or more data traffic flows of a multi-modal service, an indication of a set of candidate cells for cell switching;
receive, from a first UE of the group of UEs, a measurement report of a target candidate cell from the set of candidate cells;
send, to one or more UEs of the group of UEs, a cell switch command indicating that the one or more UEs switch from a source cell associated with the source network entity to the target candidate cell associated with a target network entity, the cell switch command being based at least in part on the measurement report of the target candidate cell; and
send, to the target network entity, a cell switch notification message, the cell switch notification message comprising one or more UE identifiers associated with the group of UEs that received the cell switch command, wherein the cell switch notification message is outputted based at least in part on obtaining the measurement report of the target candidate cell.

18. The source network entity of claim 17, wherein the one or more processors are individually or collectively further operable to execute the code to cause the source network entity to:
receive one or more UE context modification request messages that are associated with the group of UEs, wherein the indication of the set of candidate cells for the cell switching is sent to the group of UEs based at least in part on receiving the one or more UE context modification request messages.

19. The source network entity of claim 17, wherein, to send the cell switch notification message, the one or more processors are individually or collectively operable to execute the code to cause the source network entity to:
send, to the target network entity, one or more cell switch notification messages that each include a first parameter that indicates the one or more UE identifiers associated with the one or more UEs of the group of UEs that received the cell switch command based at least in part on the one or more UEs being associated with the multi-modal service.

20. The source network entity of claim 17, wherein the one or more processors are individually or collectively further operable to execute the code to cause the source network entity to:
receive one or more messages that indicates information associated with the set of candidate cells, wherein the indication of the set of candidate cells for the cell switching is sent to the group of UEs based at least in part on receiving the information associated with the set of candidate cells.
